(19) United States
(12) Patent Application Publication
(10) Pub. No.: US 2024/0422725 A1
(43) Pub. Date: Dec. 19, 2024

(54) SIDELINK POSITIONING

(71) Applicant: InterDigital Patent Holdings, Inc., Wilmington, DE (US)

(72) Inventors: Jerome Vogedes, Milwaukee, WI (US); Pascal Adjakple, Great Neck, NY (US); Yifan Li, Conshohocken, PA (US); Kyle Pan, Saint James, NY (US); Patrick Svedman, Stockholm (SE); Allan Tsai, Boonton, NJ (US)

(73) Assignee: InterDigital Patent Holdings, Inc., Wilmington, DE (US)

(21) Appl. No.: 18/703,531

(22) PCT Filed: Oct. 25, 2022
(86) PCT No.: PCT/US2022/078649

§ 371 Date: Apr. 22, 2024

Related U.S. Application Data
(60) Provisional application No. 63/271,435, filed on Oct. 25, 2021.

(51) Int. Cl. H04W 64/00; H04W 4/02

(52) U.S. Cl. CPC H04W 64/003; H04W 4/025

(57) ABSTRACT

Methods, systems, or devices may assist in NR SL positioning, such as performing sidelink discovery and selection of a positioning assist user equipment or entity transmitting positioning reference signals.

### CROSS-REFERENCE TO RELATED APPLICATIONS

This application claims the benefit of U.S. Provisional Patent Application No. 63/271,435, filed on Oct. 25, 2021, entitled “Methods and Systems For NR SL Positioning,” the contents of which are hereby incorporated by reference herein.

### BACKGROUND

Positioning protocols and RAN-based positioning signals have been specified in 3GPP since Release 9 LTE for enabling emergency services and location-based services. In Rel-17, 3GPP NR positioning protocols are supported by the Control Plane (CP) positioning architecture over the Uu interface (NG-RAN node to UE). The NR positioning architecture may also be supported by a Secure User Plane Location (SUPL) server, also known as a SUPL Location platform (SLP) or location server, that may leverage any IP bearer. Interworking for CP and UP positioning solutions are defined in TS 38.305, where SUPL can also be used as a tunnel for CP positioning protocols (e.g., LPP). This is shown in the FIG. 1. The associated positioning nodes and interfaces are shown in FIG. 2, which also may include NR (New Radio) and legacy LTE interfaces.

This background information is provided to reveal information believed by the applicant to be of possible relevance. No admission is necessarily intended, nor should be construed, that any of the preceding information constitutes prior art.

### SUMMARY

Disclosed herein are method, systems, or apparatus associated with SL positioning of a target UE (e.g., UE to be located), and related issues of discovery, selection, or configuration of the target UE, positioning assist UE (PA-UE), controlling entity, or other functions or devices.

For example, methods, systems, and apparatuses, among other things, as described herein may be configured to receive, from a sidelink (SL) positioning controlling entity or another device, sidelink positioning configuration; based on the received configuration, being triggered (e.g., detecting criteria) to perform a positioning task, and perform the positioning task. The performing of the positioning task may include at least one of the tasks disclosed herein. A task may be associated with sending indication of a use of relative positioning between the UE and a positioning assist (PA) UE or the UE and a controlling entity (CE), positioning mode (UE-based, UE-assisted), SL positioning algorithm, positioning security parameters, or the following tasks. In addition, or alternative to, the tasks may include: discovery of CE, discovery of PA-UE, selection of CE; selection of PA-UE; reception of the position of a PA-UE, a CE or a reference UE; measurement of SL PRS, Uu PRS; calculation of the UE absolute position; calculation of the UE relative position; or report of SL PRS measurements or Uu PRS measurement to a PA UE or a CE. Other tasks may include positioning capability negotiation between the UE and the PA-UE, between the UE and the CE or between the UE and a reference UE. The capability may include one or more of supported positioning type (e.g., absolute position, relative position), positioning algorithms, SL PRS types, or positioning mode (e.g., UE-based, UE-assisted)

Disclosed herein are methods, systems, and devices that may execute new radio (NR) positioning procedures over Sidelink (SL). Particularly, disclosed herein are methods and system to perform SL discovery and selection of a positioning assist (PA) user equipment (UE) transmitting positioning reference signals; methods related to network assisting and configuring a target UE (e.g., remote UE) and PA UEs with positioning reference signal (PRS) resources; methods and system for an NR UE to utilize both Uu and SL PRS; and methods to enable Uu and SL positioning and ranging for UEs equipped with distributed antenna systems.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates an exemplary CP/UP architecture;

FIG. 2 illustrates exemplary NR positioning interfaces and nodes;

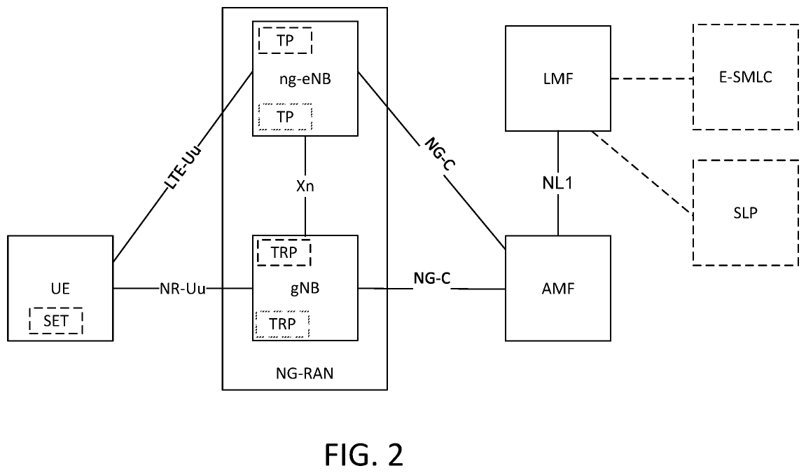

FIG. 3 illustrates exemplary general LCS procedure flow;

FIG. 4 illustrates exemplary LPP messaging for a single Position/Measurement Request;

FIG. 5 illustrates exemplary L2 SL direct communications link establishment (unicast mode);

FIG. 6 illustrates exemplary SL direct connection establishment;

FIG. 7 illustrates exemplary UE SL positioning architecture;

FIG. 8 illustrates exemplary CP/UP architecture with the addition of Sidelink;

FIG. 9 illustrates exemplary Multi-lateration, RSTD, and RTT techniques leveraging SL-PRS;

FIG. 10 illustrates exemplary high level SL positioning procedures;

FIG. 11 illustrates an exemplary method flow for NR SL positioning configuration and discovery without Uu interaction;

FIG. 12 illustrates an exemplary method flow for PA selection and PC5 establishment without Uu interaction;

FIG. 13 illustrates an exemplary method flow for NR SL Positioning specific procedures without Uu interaction;

FIG. 14 illustrates an exemplary method flow for on-demand SL-PRS request without Uu involvement;

FIG. 15 illustrates an exemplary method flow for SL-SRS positioning procedure flow;

FIG. 16 illustrates an exemplary method flow for NR SL Positioning Config and Discovery with Uu interaction;

FIG. 17 illustrates an exemplary method flow for NR SL Positioning Configuration and Discovery with Uu involvement;

FIG. 18 illustrates an exemplary method flow for NR SL Positioning specific procedures with Uu involvement;

FIG. 19 illustrates an exemplary method flow for SL In-coverage and partial coverage scenarios for SL-PRS transmission requests;

FIG. 20 illustrates an exemplary method flow for LCS Procedures to support DAS;

FIG. 21 illustrates an exemplary display that may be generated based on the methods, systems, and devices of NR SL positioning;

FIG. 22A illustrates an example communications system;

FIG. 22B illustrates an exemplary system that may include RANs and core networks;

FIG. 22C illustrates an exemplary system that may include RANs and core networks;

FIG. 22D illustrates an exemplary system that may include RANs and core networks;

FIG. 22E illustrates another example communications system;

FIG. 22F is a block diagram of an example apparatus or device, such as a WTRU; and

FIG. 22G is a block diagram of an exemplary computing system.

### DETAILED DESCRIPTION

3GPP has defined various protocols to enable several positioning technologies and methods (GNSS, sensors, positioning signals, etc.). The primary protocol, LPP (LTE Positioning protocol), is terminated between the UE and LMF (Location Management Function). LPP is a Point-to-Point LCS and NAS messaging protocol that is defined in TS 37.355 [2]. LPP has been agreed to be re-used for NR since Rel-15 and will continue to be leveraged for the foreseeable future.

RRC (Radio Resource Control) is another protocol used to provide transport for LPP messages and other positioning procedures over the NR-Uu interface, which is terminated between the gNB and the UE [TS 38.331].

On the network side, NGAP (NG Application Protocol) is terminated between the AMF and the NG-RAN Node(s) (i.e., gNB/TRP) and is used as a transport for LPP and NRPPa messages over the NG-C interface [TS 38.413].

Finally, NRPPa (NR Positioning Protocol A) carries information between the NG-RAN Node(s) and the LMF [TS 38.445].

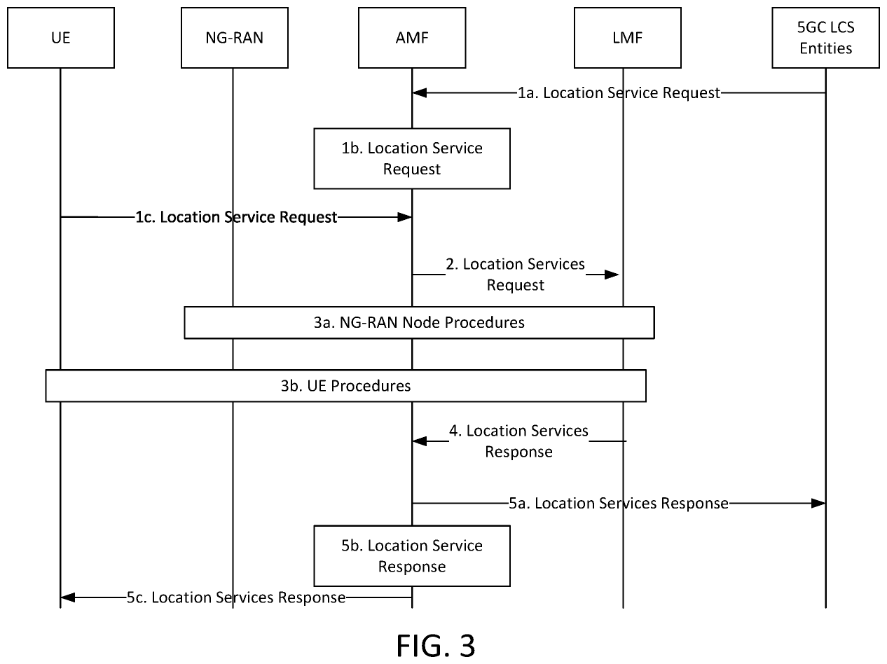

From a protocol perspective for Rel-17, FIG. 3 illustrates a general LCS flow, adopted from TS 38.305.

Further details for this process flow are as follows:
At step 1a. Either: some entity in the 5GC (e.g., GMLC-Gateway Mobile Location Center) requests location service (e.g., positioning) for a target UE to the serving AMF.
At step 1b. Or: the serving AMF for a target UE determines the need for some location service (e.g., to locate the UE for an emergency call).
At step 1c. Or: the UE may request some location service (e.g., positioning or delivery of assistance data) to the serving AMF at the NAS level.
At step 2. The AMF transfers the location service request to an LMF.
At step 3a. The LMF instigates location procedures with the serving and possibly neighboring ng-eNB or gNB in the NG-RAN—e.g., to obtain positioning measurements or assistance data.
At step 3b. In addition to step 3a or instead of step 3a, the LMF instigates location procedures with the UE—e.g., to obtain a location estimate or positioning measurements or to transfer location assistance data to the UE.
At step 4. The LMF provides a location service response to the AMF and may include any needed results—e.g., success or failure indication and, if requested and obtained, a location estimate for the UE.
At step 5a. If step 1a was performed, the AMF returns a location service response to the 5GC entity in step 1a and may include any needed results—e.g., a location estimate for the UE.
At step 5b. If step 1b occurred, the AMF may use the location service response received in step 4 to assist the service that triggered this in step 1b (e.g., may provide a location estimate associated with an emergency call to a GMLC).
At step 5c. If step 1c was performed, the AMF returns a location service response to the UE and may include any needed results—e.g., a location estimate for the UE.

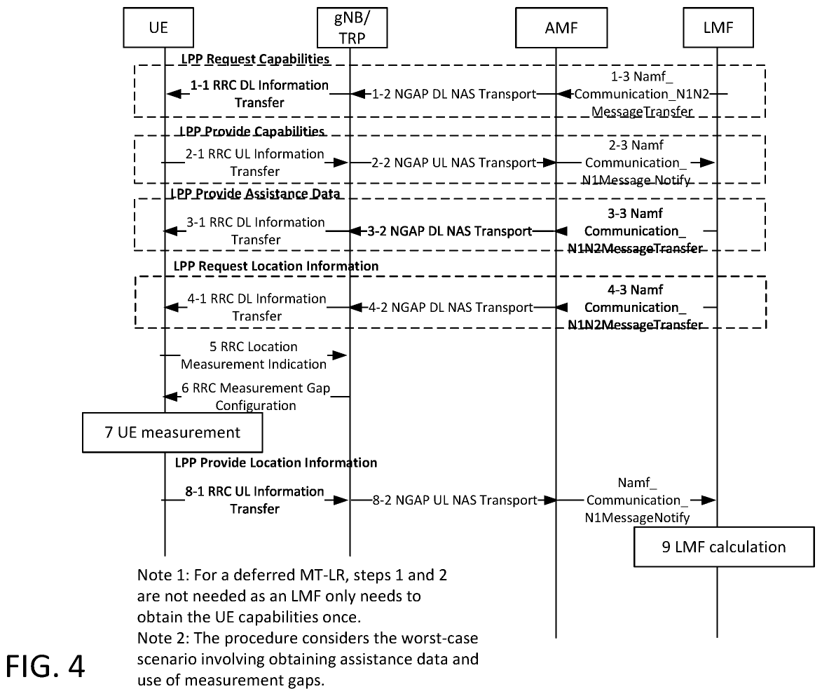

Looking at the positioning procedures related to UE procedures in step 3b of FIG. 3 a bit closer, the LPP messages related to UE-assisted location request(s) are shown in FIG. 4 [TS 37.355] [TR 38.845]. FIG. 4 steps may include events, such as Request Capabilities; LMF request to UE; Provide Capabilities; UE response to LMF; Request Assistance Data; and UE request to LMF for positioning assistance data/information; Provide Assistance Data; LMF to UE positioning assistance data information/configuration (additionally, broadcast of positioning Assistance Data (AD) is supported via Positioning System Information Blocks (posSIBs) and carried in SI messages [TS 38.331] [TS 38.413]); Request Location Information; LMF request to UE for position/measurements; Provide Location Information; UE to LMF, position or measurements; Abort; Abort LPP session; or Error; Errors associated with positioning procedure(s).

Positioning can be done as standalone, UE-Based, or UE-Assisted modes. In Standalone positioning, the UE handles the aspects of the positioning, scans for accessible sources of positioning, measures, and processes positioning signals/sources. Finally, the UE computes its own position in 2 or 3 dimensions. In Standalone positioning, the Uu interface impacts include UE capability exchange and reporting of the UE position.

In UE-Based Positioning (UE-B), the network provides acquisition assistance data, and the UE scans for accessible sources of positioning, measures, and processes positioning signals/sources (based on assistance information from the network). Finally, the UE computes its own position in 2 or 3 dimensions and may report its position to the network.

In UE-Assisted Positioning (UE-A), the network provides acquisition assistance, and the UE scans for accessible sources of positioning, measures positioning signals/sources (based on assistance information from NW). Finally, the UE returns measurements to the network, and the network computes the device position (at the location server/LMF) [TS 38.305].

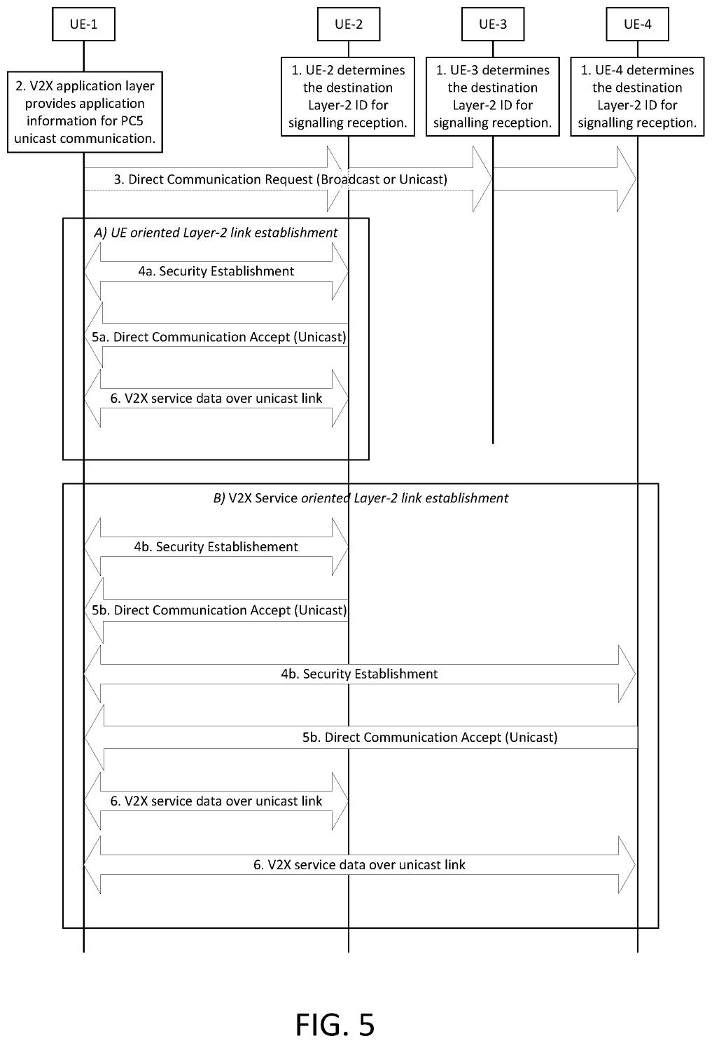

NR positioning modes, mechanisms, and protocols may be extended from leveraging only Uu-based (interface between the 5G UE and NG-RAN) signals to also include Sidelink (SL) mechanisms either to supplement Uu-based approaches or on a standalone SL-only basis. SL communications are direct communications between two or more 5G UEs without the participation of the NG-RAN in the communication. For direct UE-to-UE SL communications establishment, the existing high level L2 procedures are outlined in FIG. 5 for one or more UEs.
At step 1 of FIG. 5, the UE(s) determine the destination Layer-2 ID for signalling reception for PC5 unicast link establishment as specified in TS 23.287. The destination Layer-2 ID is configured with the UE(s) as specified in TS 23.287 clause 5.1.2.1.
At step 2 of FIG. 5, the V2X application layer in UE-1 provides application information for PC5 unicast communication. The application information may include the V2X service type(s) and the initiating UE's Application Layer ID. The target UE's Application Layer ID may be included in the application information. The V2X application layer in UE-1 may provide V2X Application Requirements for this unicast communication. UE-1 determines the PC5 QOS parameters and PFI as specified in TS 23.287 clause 5.4.1.4. If UE-1 decides to reuse the existing PC5 unicast link as specified in TS 23.287 clause 5.2.1.4, the UE triggers Layer-2 link modification procedure as specified in TS 23.287 clause 6.3.3.4.
At step 3 of FIG. 5, UE-1 may send a Direct Communication Request message to initiate the unicast layer-2 link establishment procedure. The Direct Communication Request message may include source user info, such as the initiating UE's Application Layer ID (e.g., UE-1's Application Layer ID). The Direct Communication Request message may include V2X Service Info, such as the information about V2X service type(s) requesting Layer-2 link establishment. The Direct Communication Request message may include security Information, such as the information for the establishment of security. If the V2X application layer provided the target UE's Application Layer ID in step 2 of FIG. 5, the following information is included in target user info: the target UE's Application Layer ID (i.e. UE-2's Application Layer ID).

The source Layer-2 ID and destination Layer-2 ID used to send the Direct Communication Request message are determined as specified in TS 23.287 may use 5.6.1.1 and 5.6.1.4. The destination Layer-2 ID may be broadcast or unicast Layer-2 ID. When unicast Layer-2 ID is used, the Target User Info shall be included in the Direct Communication Request message.

UE-1 may send the Direct Communication Request message via PC5 broadcast or unicast using the source Layer-2 ID and the destination Layer-2 ID.
At step 4 of FIG. 5, security with UE-1 is established as below. At step 4a of FIG. 5, if the Target User Info is included in the Direct Communication Request message, the target UE, i.e., UE-2, responds by establishing the security with UE-1. At step 4b of FIG. 5, if the Target User Info is not included in the Direct Communication Request message, the UEs that are interested in using the announced V2X service type(s) over a PC5 unicast link with UE-1 responds by establishing the security with UE-1.

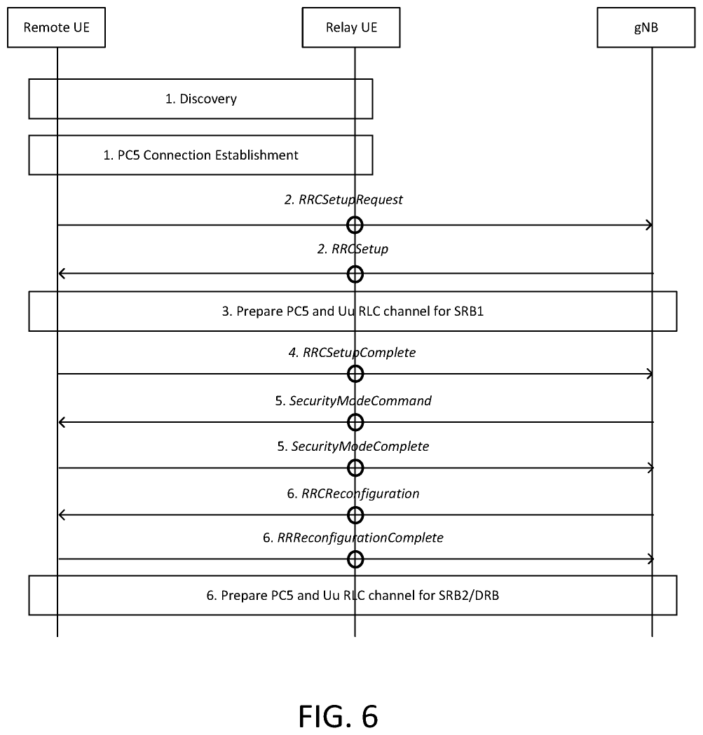

The source Layer-2 ID used for the security establishment procedure is determined as specified in TS 23.287 clause use 5.6.1.1 and 5.6.1.4. The destination Layer-2 ID is set to the source Layer-2 ID of the received Direct Communication Request message. Upon receiving the security establishment procedure messages, UE-1 obtains the peer UE's Layer-2 ID for future communication, for signalling and data traffic for this unicast link.
At step 5 of FIG. 5, a direct Communication Accept message is sent to UE-1 by the target UE(s) that has successfully established security with UE-1.
At step 5a of FIG. 5, (UE oriented Layer-2 link establishment) if the Target User Info is included in the Direct Communication Request message, the target UE, i.e., UE-2 responds with a Direct Communication Accept message if the Application Layer ID for UE-2 matches.
At step 5b of FIG. 5, (V2X Service oriented Layer-2 link establishment) if the Target User Info is not included in the Direct Communication Request message, the UEs that are interested in using the announced V2X Service(s) respond to the request by sending a Direct Communication Accept message (UE-2 and UE-4 in TS 23.287 FIG. 6.3.3.1-1).

The V2X layer of the UE that established PC5 unicast link passes the PC5 Link Identifier assigned for the unicast link and the PC5 unicast link related information down to the AS layer. The PC5 unicast link related information may include Layer-2 ID information (e.g., source Layer-2 ID and destination Layer-2 ID) and the corresponding PC5 QoS parameters. This enables the AS layer to maintain the PC5 Link Identifier together with the PC5 unicast link related information.
At step 6 of FIG. 5, V2X service data is transmitted over the established unicast link as below: The PC5 Link Identifier, and PFI are provided to the AS layer, together with the V2X service data. In addition, the Layer-2 ID information (e.g., source Layer-2 ID and destination Layer-2 ID) may be provided to the AS layer.

For SL Direct Communications for a remote UE (not in coverage of the NG-RAN) via relay UE, including RRC Connected mode (SRB2) establishment, FIG. 6 shows the procedures as per TS 38.836.

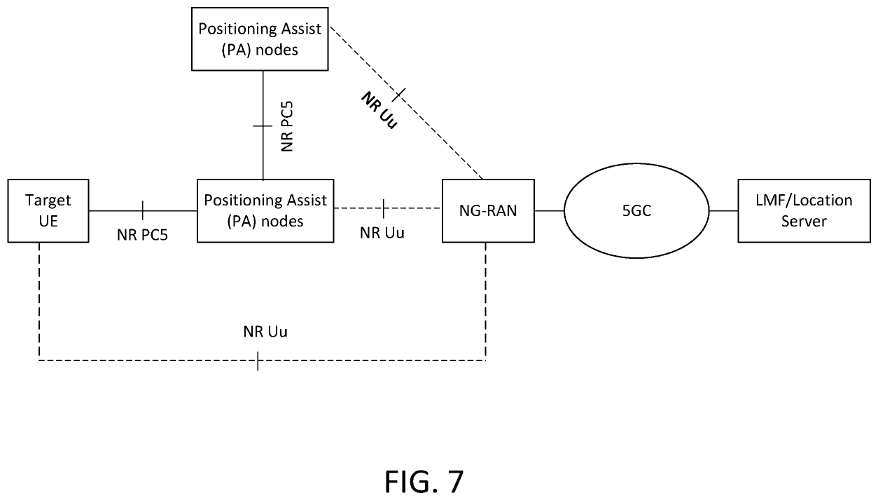

It is envisioned that SL positioning reference signals (SL-PRS) may also be communicated between two or more UEs for LCS determination with and without the network directly involved. To illustrate these scenarios, can look at a potential SL positioning connectivity architecture as shown in FIG. 7.

There are several possible network coverage scenarios for the radio link possibilities as shown in FIG. 7 when two or more UEs are involved. In-coverage scenario refers to the case where both UEs are inside the network. Partial coverage means that one UE remains inside the network coverage, but the other UE is outside the network coverage. Out-of-coverage scenario refers to the case where both UEs are outside the network coverage.

For these coverage scenarios, the radio link may include the Uu interface (uplink and downlink, applicable for in-coverage/partial), PC5 interface (sidelink, applicable for in/out/partial coverage), and their combinations. To expand on this terminology, for “Uu-based” solutions, the target UE may use only measurements on Uu interface. For “PC5-based” solutions, the target UE may use only measurements on PC5 interface. Finally, hybrid solutions are also envisioned, whereby UE may use measurements on both Uu and PC5 interfaces [TR 38.845].

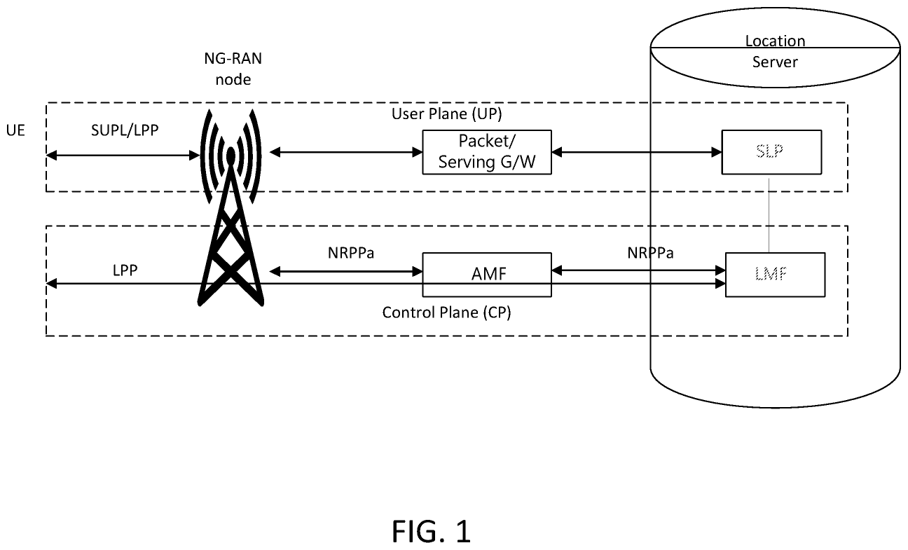

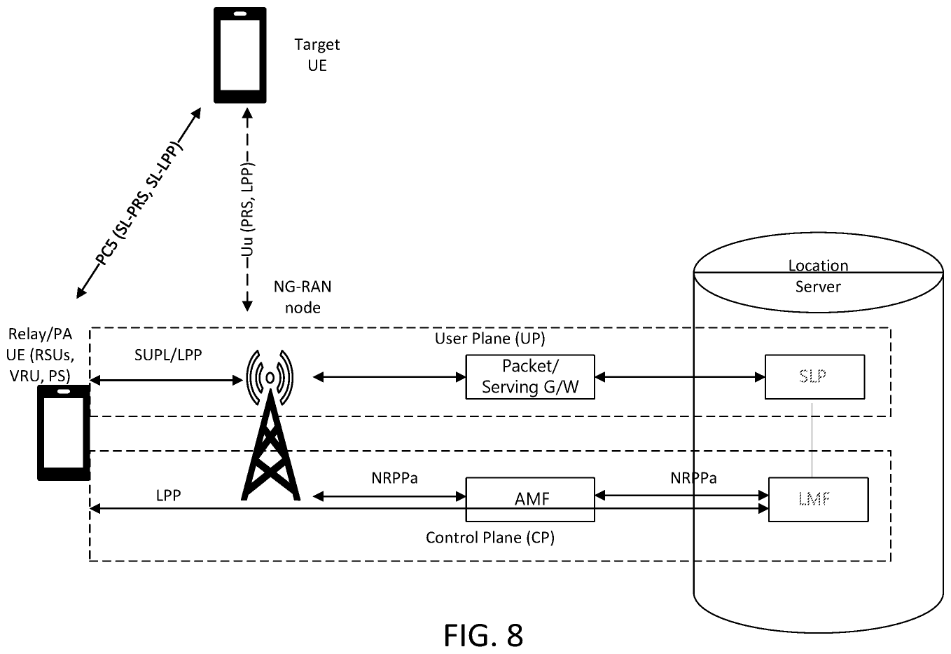

Furthermore, specifically for positioning procedures, Uu based solutions may leverage assistance information over the PC5 interface, and PC5 based solutions may leverage assistance information over the Uu interface. If the PC5 (Sidelink) interface is added to FIG. 1, then the architecture of FIG. 8.

3GPP has defined enhanced positioning protocols, new positioning techniques, and New Radio (NR)-based Positioning Reference Signals (PRS) in Rel-16. The NR PRS is based on the LTE pseudo-random sequences and is specified in TS 38.211. The updated NR PRS further improves hear-ability of the PRS from neighbor cells. This yields an improved positioning accuracy, but it is dependent on network deployment (e.g., density of gNBs/TRPs), RF conditions, and PRS configuration parameters, such as bandwidth, periodicity, or muting patterns as discussed further. Although the existing PRS definition is a robust signal and enables excellent timing (aka ranging) measurements, other PRS signals also may exist that can be leveraged for positioning, such as, SSBs, CSI-RS, PT-RS, DMRS, SRS, or the like for both Uu and SL interfaces, or combination thereof. In fact, some of these types of PRSs may be sufficient for SL-based positioning given generally shorter distances for positioning/ranging.

PRSs enable various positioning techniques. DL-TDOA (DL Time Difference of Arrival) is one such method that leverages a PRS transmission broadcast from an NG-RAN node. UE performs downlink reference signal time difference (DL-RSTD) measurements for each gNB/TRP PRS(s), and optionally DL-PRS-RSRP. These measurements are reported to the LMF (Location Management Function/Location Server) in the case of UE-A. For UE-B, the UE calculates and reports its position to the network.

Another DL technique that leverages broadcast PRS is the AoD (Angle-of-Departure) method. The UE measures the PRS reference signal receive power (DL RSRP) per beam/gNB. Measurement reports are used to determine the AoD based on UE beam location for each gNB. For UE-A, the LMF then may use the AoDs to estimate the UE position or for UE-B, the UE calculates and reports its position to the network.

These multi-lateration techniques are well known and established methods for locating UEs. Geometrically, UE location is derived from each time/range difference (RSTD). Typically, a minimum of 3 gNB (geo-dispersed) measurements are required for reliable position relative to UE internal timing. This also requires a serving (reference) cell as well as timing/RSRP measurements from neighbor cells. It is envisioned that these techniques can be extended to include SL techniques. SL PRS may be advantageous as it would typically be shorter (closer) ranges to the target UE.

Location of TRPs and assistance data (configuration/resource information) can be delivered over the Uu interface either broadcast in positioning System Information Blocks (posSIBs) or in NAS signaling via LPP messages in RRC_CONNECTED.

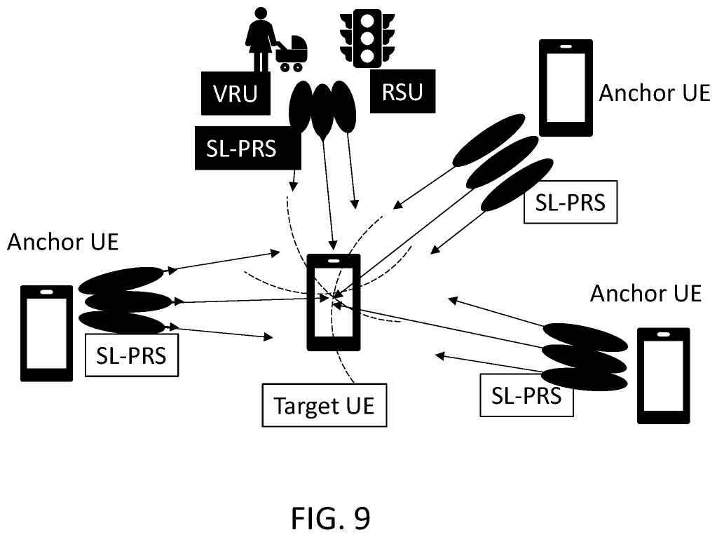

To expand on these concepts from a SL positioning perspective, SL UEs (anchor UE, relay UE, Road Side Units (RSUs) or the like) can provide positioning reference signals with or without wide area network coverage. Additionally, SL UEs typically benefit from shorter distances between devices, resulting in more accurate location. The requirement for the need for multiple geometrically spaced Positioning Assistance (PA) nodes, as is the case for gNB PRSs, may also be eliminated or reduced while maintaining accurate position by RSTD and RTT techniques (see FIG. 9).

For reference and baseline procedures, the IE NR-DL-PRS-Info defines downlink PRS configuration, which is sent from the network (e.g., LMF) to the UE as defined in TS 37.355 (LPP). This assists the UE in reception of PRS transmissions from serving and neighbor cells [TS 37.355]. See Table 1 and Table 2.

TABLE 1
-- ASN1START
NR-DL-PRS-Info-r16 ::= SEQUENCE {

| | |
|---|---|
| nr-DL-PRS-ResourceSetList-r16 | SEQUENCE (SIZE (1..nrMaxSetsPerTrp- |

r16)) OF

NR-DL-PRS-

ResourceSet-r16,
...
}
NR-DL-PRS-ResourceSet-r16 ::= SEQUENCE {

| | |
|---|---|
| nr-DL-PRS-ResourceSetID-r16 | NR-DL-PRS-ResourceSetID-r16, |

dl-PRS-Periodicity-and-ResourceSetSlotOffset-r16

NR-DL-PRS-Periodicity-and-

ResourceSetSlotOffset-r16,

| | |
|---|---|
| dl-PRS-ResourceRepetitionFactor-r16 | ENUMERATED {n2, n4, n6, n8, n16, n32, |

...}
OPTIONAL, -- Need OP

| | |
|---|---|
| dl-PRS-ResourceTimeGap-r16 | ENUMERATED {s1, s2, s4, s8, s16, s32, |

...}
OPTIONAL, -- Cond Rep

| | |
|---|---|
| dl-PRS-NumSymbols-r16 | ENUMERATED {n2, n4, n6, n12, ...}, |
| dl-PRS-MutingOption1-r16 | DL-PRS-MutingOption1-r16 |

OPTIONAL, -- Need OP

| | |
|---|---|
| dl-PRS-MutingOption2-r16 | DL-PRS-MutingOption2-r16 |

OPTIONAL, -- Need OP

| | |
|---|---|
| dl-PRS-ResourcePower-r16 | INTEGER (−60..50), |
| dl-PRS-ResourceList-r16 | SEQUENCE (SIZE |

(1..nrMaxResourcesPerSet-r16)) OF

NR-DL-PRS-

```
Resource-r16,
  ...
}
DL-PRS-MutingOption1-r16 ::= SEQUENCE {
  dl-prs-MutingBitRepetitionFactor-r16
```

ENUMERATED { n1, n2, n4, n8, ... }

OPTIONAL, -- Need OP

| | |
|---|---|
| nr-option1-muting-r16 | NR-MutingPattern-r16, |

...
}
DL-PRS-MutingOption2-r16 ::= SEQUENCE {

| | |
|---|---|
| nr-option2-muting-r16 | NR-MutingPattern-r16, |

...
}
NR-MutingPattern-r16 ::= CHOICE {

| | |
|---|---|
| po2-r16 | BIT STRING (SIZE(2)), |
| po4-r16 | BIT STRING (SIZE(4)), |
| po6-r16 | BIT STRING (SIZE(6)), |
| po8-r16 | BIT STRING (SIZE(8)), |
| po16-r16 | BIT STRING (SIZE(16)), |
| po32-r16 | BIT STRING (SIZE(32)), |

...
}
NR-DL-PRS-Resource-r16 ::= SEQUENCE {

| | |
|---|---|
| nr-DL-PRS-ResourceID-r16 | NR-DL-PRS-ResourceID-r16, |
| dl-PRS-SequenceID-r16 | INTEGER (0..4095), |
| dl-PRS-CombSizeN-AndReOffset-r16 | CHOICE { |
| n2-r16 | INTEGER (0..1), |
| n4-r16 | INTEGER (0..3), |
| n6-r16 | INTEGER (0..5), |
| n12-r16 | INTEGER (0..11), |

```
    ...
  },
```

| | |
|---|---|
| dl-PRS-ResourceSlotOffset-r16 | INTEGER (0..nrMaxResourceOffsetValue−1- |

r16),

| | |
|---|---|
| dl-PRS-ResourceSymbolOffset-r16 | INTEGER (0..12), |
| dl-PRS-QCL-Info-r16 | DL-PRS-QCL-Info-r16 |

```
  OPTIONAL,
  ...
```

TABLE 2
NR-DL-PRS-Info field descriptions

dl-PRS-Periodicity-and-ResourceSetSlotOffset
This field specifies the periodicity of DL-PRS allocation in slots configured per DL-PRS
Resource Set and the slot offset with respect to SFN #0 slot #0 for a TRP where the DL-PRS
Resource Set is configured (i.e. slot where the first DL-PRS Resource of DL-PRS Resource Set
occurs).
dl-PRS-ResourceRepetitionFactor
This field specifies how many times each DL-PRS Resource is repeated for a single instance of
the DL-PRS Resource Set. It is applied to all resources of the DL-PRS Resource Set. Enumerated
values n2, n4, n6, n8, n16, n32 correspond to 2, 4, 6, 8, 16, 32 resource repetitions, respectively.
If this field is absent, the value for dl-PRS-ResourceRepetitionFactor is 1 (i.e., no resource
repetition).
dl-PRS-ResourceTimeGap
This field specifies the offset in units of slots between two repeated instances of a DL-PRS
Resource corresponding to the same DL-PRS Resource ID within a single instance of the DL-
PRS Resource Set. The time duration spanned by one DL-PRS Resource Set containing repeated
DL-PRS Resources should not exceed DL-PRS-Periodicity.
dl-PRS-NumSymbols
This field specifies the number of symbols per DL-PRS Resource within a slot.
dl-PRS-MutingOption1
This field specifies the DL-PRS muting configuration of the TRP for the Option-1 muting, as
specified in TS 38.214 [45], and comprises the following sub-fields:

| - | dl-prs-MutingBitRepetitionFactor indicates the number of consecutive instances of the |
|---|---|
| | DL-PRS Resource Set corresponding to a single bit of the nr-option1-muting bit map. |
| | Enumerated values n1, n2, n4, n8 correspond to 1, 2, 4, 8 consecutive instances, |
| | respectively. If this sub-field is absent, the value for dl-prs-MutingBitRepetitionFactor is |
| | n1. |
| - | nr-option1-muting defines a bitmap of the time locations where the DL-PRS Resource is |
| | transmitted (value ‘1’) or not (value ‘0’) for a DL-PRS Resource Set, as specified in TS |
| | 38.214 [45]. |

If this field is absent, Option-1 muting is not in use for the TRP.
dl-PRS-MutingOption2
This field specifies the DL-PRS muting configuration of the TRP for the Option-2 muting, as
specified in TS 38.214 [45], and comprises the following sub-fields:

| | |
|---|---|
| - | nr-option2-muting defines a bitmap of the time locations where the DL-PRS Resource is |
| | transmitted (value ‘1’) or not (value ‘0’). Each bit of the bitmap corresponds to a single |
| | repetition of the DL-PRS Resource within an instance of a DL-PRS Resource Set, as |
| | specified in TS 38.214 [45]. The size of this bitmap should be the same as the value for dl- |
| | PRS-ResourceRepetitionFactor. |

If this field is absent, Option-2 muting is not in use for the TRP.
dl-PRS-ResourcePower
This field specifies the average EPRE of the resources elements that carry the PRS in dBm that is
used for PRS transmission. The UE assumes constant EPRE is used for all REs of a given DL-
PRS resource.
dl-PRS-SequenceID
This field specifies the sequence Id used to initialize Cinit value used in pseudo random generator
TS 38.211 [41], clause 5.2.1 for generation of DL-PRS sequence for transmission on a given DL-
PRS Resource.
dl-PRS-CombSizeN-AndReOffset
This field specifies the Resource Element spacing in each symbol of the DL-PRS Resource and
the Resource Element (RE) offset in the frequency domain for the first symbol in a DL-PRS
Resource. All DL-PRS Resource Sets belonging to the same Positioning Frequency Layer have
the same value of comb size. The relative RE offsets of following symbols are defined relative to
the RE Offset in the frequency domain of the first symbol in the DL-PRS Resource according to
TS 38.211 [41]. The comb size configuration should be aligned with the comb size configuration
for the frequency layer.
dl-PRS-ResourceSlotOffset
This field specifies the starting slot of the DL-PRS Resource with respect to the corresponding
DL-PRS-Resource Set Slot Offset.
dl-PRS-ResourceSymbolOffset
This field specifies the starting symbol of the DL-PRS Resource within a slot determined by dl-
PRS-ResourceSlotOffset.
dl-PRS-QCL-Info
This field specifies the QCL indication with other DL reference signals for serving and
neighboring cells and comprises the following subfields:

| - | ssb indicates the SSB information for QCL source and comprises the following sub-fields: | |
|---|---|---|
| | - | pci specifies the physical cell ID of the cell with the SSB that is configured as the source |
| | | reference signal for the DL-PRS. The UE obtains the SSB configuration for the SSB |
| | | configured as source reference signal for the DL-PRS by indexing to the field nr-SSB- |
| | | Config with this physical cell identity. |
| | - | ssb-Index indicates the index for the SSB configured as the source reference signal for |
| | | the DL-PRS. |
| | - | rs-Type indicates the QCL type. |
| - | dl-PRS indicates the PRS information for QCL source and comprises the followings sub- | |
| | fields: | |
| | - | qcl-DL-PRS-ResourceID specifies DL-PRS Resource ID as the source reference signal |
| | | for the DL-PRS. |
| | - | qcl-DL-PRS-ResourceSetID specifies the DL-PRS Resource Set ID. |

The PRS transmission configuration information and assistance data (e.g., NR-DL-PRS-Info) enable a UE to detect and measure positioning reference signals and either calculate UE position or send measurements to the network for calculation. Typically, this information is delivered to the UE in a P2P (Point-to-Point) manner in RRC connected mode via NAS (LPP) signaling.

Another alternative for a UE to receive PRS-related IEs is via positioning System Information Blocks (posSIBs). The posSIBs contain positioning assistance data associated with a number of positioning technologies including, PRS-related methods such as DL TDOA, DL-AOD and multi-RTT.

The procedures for posSIB acquisition leverage the same procedures as other SIBs (e.g., SIB2, SIB, etc.), For example, SIB1 contains scheduling information (PosSchedulingInfo-r16) associated with the posSIBs. These SIBs are mapped to the BCCH and is either broadcast periodically on DL-SCH or broadcast on-demand on DL-SCH (upon request from UEs in RRC_IDLE or RRC_INACTIVE) or sent in a dedicated manner on DL-SCH to UEs in RRC_CONNECTED.

The IEs that are broadcast in the posSIBs are the same as those defined in LPP. Within 38.331, RRC, PosSystemInformation-r16-IEs maps to positioning SIB type (posSibType) where detailed AD IEs are defined in LPP.

Some of the Relevant IEs for PRS related positioning methods are defined in 37.355 clause 6.4.3, 7.4.2 and then mapped to the following posSIBTypes in RRC as in Table 3.

TABLE 3

| | |
|---|---|
| posSibType6-1 | NR-DL-PRS-AssistanceData |
| posSibType6-2 | NR-UEB-TRP-LocationData |
| posSibType6-3 | NR-UEB-TRP-RTD-Info |

The Study on scenarios and requirements of in-coverage, partial coverage, and out-of-coverage NR positioning use cases (Release 17) concluded a number of use cases and requirement enhancements over the existing Rel-16/17 NR positioning methods. Positioning can refer to both absolute and relative positioning (ranging). Absolute position refers to an estimate of the UE position in 2D/3D geographic coordinates (e.g., latitude, longitude, elevation) within a coordinate system (e.g., WGS-84). Relative position also known as ranging refers to an estimate of the UE position relative to network elements, positioning assistance/reference nodes, or relative to other UEs. Namely, the following two general use cases were identified, but other commercial or Industrial IoT use cases can be envisioned [TR 38.845]: V2X or public safety.

V2X (Vehicle-to-everything). This use case involves traffic safety, traffic efficiency and information services. These sets of use cases carry the following requirements: Indoor (e.g., tunnel) and outdoor scenarios as well as in-coverage, out-of-coverage and partial network coverage scenarios. Some of the requirements and performance metrics are defined in a range depending on the positioning service level: 2-3 m (absolute) or 0.2 m (relative) vertical accuracy; Absolute (Lat/Long/Height Above Ellipsoid (HAE) coordinates of UE) and Relative (distance/angle between 2 UEs/nodes); 95-99.9% positioning service availability; 10 ms-1 s positioning service latency; or including GNSS-based positioning is not available or not accurate enough.

Public Safety. This use case involves “First responders” tracking and guidance. These sets of use cases carry the following requirements: Indoor and outdoor scenarios as well as in-coverage, out-of-coverage and partial network coverage scenarios. Some of the requirements and performance metrics are defined in a range depending on the positioning service level: 1 m horizontal accuracy; 2 m (absolute) or 0.3 m (relative) vertical accuracy. Absolute (Lat/Long/Height Above Ellipsoid (HAE) coordinates of UE) and Relative (distance/angle between 2 UEs/nodes); 95-98% positioning service availability; 1-5 s positioning service latency; or including scenarios where GNSS-based positioning is not available or not accurate enough.

As a point of clarity, the term user equipment (UE) defined herein, is broadly defined as a device with a communications module that may be used in positioning operations. For V2X use cases, a UE that may be involved in positioning can be installed in a vehicle, a roadside unit (RSU), or a device of a vulnerable road user (VRU). For these use cases, the UEs are collectively referred to as a Positioning Assist (PA) UE. Additionally, a UE in a vehicle or an RSU can be equipped with a distributed antenna system (DAS)-multiple antennas installed at different locations to improve positioning sensitivity and geometrical/angular calculation enhancements. DAS is particularly helpful in environments where only one TRP/RSU/VRU is available to a target UE. In these cases, measurements can be made by leveraging each antenna and measurement differences, and the target UE is able to determine, more accurately, the position (relative or absolute position).

The term target UE is the device for which the position/location is to be determined. The term relay UE/function in the context of SL positioning refers to a UE to Network relay or UE-to-UE relay that essentially extends network coverage by relaying positioning reference signals, connectivity, or associated configurations between the network and target UEs for partial network coverage scenarios. Terms anchor, or master (controlling) entity (e.g., function or UE) may refer to positioning assist (PA) devices to aid a target UE in position determination. Similarly for various SL positioning scenarios, anchor UEs (RSUs, etc.) will serve as positioning nodes to aid a target UE for positioning and ranging procedures.

A first issue addressed herein is related to discovery, selection, and configuration of target UEs for SL positioning and ranging without Uu involvement.

To support both absolute and relative positioning that leverages SL positioning reference signals, the following issues may be addressed for a target UE, master (controlling) entity (e.g., function or device), PA UE, or Relay UE without Uu involvement. In these scenarios, the master (controlling) entity may be a non-network node. Determining SL positioning procedures when direct communications over SL is not established may also be particularly beneficial for latency and signaling overhead reduction.

An overall procedure and architecture to support a target UE to discover, select, or receive assistance for SL UE(s) to aid in the positioning determination function is needed. The procedures may include support for the following considerations.

A first consideration is for (pre) configuration of a target UE, master (controlling) entity, PA UE, or relay UE/function to support in the SL positioning discovery or selection. For example, SL-PRS parameter configuration(s) from existing DL-PRS configurations, resource allocation, and SL-PRS muting functions as well as other reference signals that may be leveraged. In another example, SL-SRS parameter configuration(s) optimizations from existing UL SRS configurations or resource allocation methods. In another example, subsequent update of initial configurations or associated triggers. Subsequent update of initial configurations and associated triggers.

A second consideration may be how to perform identification or authentication of target UE, master (controlling) entity, PA UE, or Relay UE/function. A third consideration may define procedures for capabilities exchange for SL positioning entities/UEs. A fourth consideration may define triggers to instigate positioning procedures for target UE, master (controlling) entity, PA UE, or Relay UE/function.

A fifth consideration may define target UE selection criteria or priorities for master (controlling) entity, PA UE, or Relay UE/functions that are dependent on use case, environment, or key performance indicators (KPIs). Existing SL UE selection criteria leverages, e.g., RSRP measurements, which may not always be necessary for positioning. Priorities or selection criteria may consider, e.g., relative or absolute proximity, absolute velocity, LOS/NLOS determination, known/unknown absolute locations, or capabilities, among other things.

A sixth consideration may be how to support the SL positioning procedures scenarios within the existing positioning protocols or framework without Uu involvement. A seventh consideration may be how to enable, define, or implement security, access restrictions, or authorization for positioning information and SL-PRS, especially in public safety use cases. Examples include temporary access and configurations to SL-PRS or request and update SL-PRS transmission(s) “on-demand.” An eighth consideration may define how and what entity is the positioning calculation/determination function, measurements, or measurement configuration are carried out, e.g., target UE, master (controlling) entity, PA UE. Or account for target UE internal Tx/Rx delays in measurements, among other things.

This first issue may be addressed by the following first approach associated with discovery, selection, assistance of SL Positioning UEs, or SL ranging/positioning configuration without Uu involvement. In the first approach, methods or systems for a target UE may perform positioning measurements or receive associated configuration for SL positioning reference signals that are transmitted from one or more positioning assist (PA) UEs, without Uu involvement in the positioning procedures, comprising one or more of the following steps. The target UE may receive pre-configuration from the network, master (controlling) entity, or pre-provisioned with: SL positioning service, SL discovery authorization, SL discovery identifiers, measurement configuration, or SL-PRS reception resource and configuration set. The target UE or one or more positioning assist (PA) UEs (which may include a master (controlling) entity) may be configured to carry out positioning procedures autonomously from the network. The target UE, upon trigger of an LCS request, may perform tasks, which may include sending or receiving one or more of the following (which may be associated with direct discovery of one or more PA UEs): an announcement positioning discovery message, a solicitation positioning discovery message, a response positioning discovery message, PA UE sensing involving the PA UE transmitting broadcast posSIBs, or other system information.

With continued reference to the first approach, the target UE may select one or more of the authorized PA UEs that meet the configured criteria or capabilities to initiate positioning procedures. SL direct communication link may be established between the target UE and the relay UE/function. SL direct communication link may be used to exchange LCS messages or configure LCS messages. For SL direct communication, security may be established between the target UE and PA UE(s). Security may be established for SL positioning without SL direction communication. LCS procedures may be initiated between the target UE and PA UEs to determine the absolute or relative position of the target UE. LCS procedures may include requesting capabilities, providing capabilities, requesting assistance data, providing assistance data, requesting location information, or providing location information. The target UE may provide additional SL-PRS requests to modify the initial SL-PRS transmissions, existing SL-PRS transmissions, or positioning configurations from the PA UE(s).

The second issue is associated with supporting absolute and relative positioning that leverages SL positioning reference signals, in which the issue may be addressed for a target UE, master (controlling) entity, PA UE, or relay UE/function with Uu involvement. In these scenarios, the master (controlling) entity may be a network node (e.g., LMF), or designated by the network node.

There is a need for a procedure or architecture to support a target UE to discover, select, or receive assistance for SL UE(s) to aid in the positioning determination function. The procedures may include support for the following considerations. A first consideration may be with regard to (pre) configuration of a target UE, Master (controlling) entity, PA UE, and Relay UE/function to support in the SL positioning discovery and selection. For example, SL-PRS parameter configuration(s) from existing DL-PRS configurations, resource allocation and SL-PRS muting functions as well as other reference signals that may be leveraged. In an example, SL-SRS parameter configuration(s) optimizations from existing UL SRS configurations or resource allocation methods. In another example, subsequent update of initial configurations and associated triggers. A second consideration may be how to perform identification and authentication of target UE, master (controlling) entity, PA UE, or relay UE/function. A third consideration may be for defining procedures for capabilities exchange for SL positioning entities/UEs. A fourth consideration may define triggers to instigate positioning procedures for target UE, master (controlling) entity, PA UE, or relay UE/function.

With reference to a second issue, a fifth consideration may by with regard to defining target UE selection criteria and priorities for master (controlling) entity, PA UE, or relay UE/functions that may be dependent on use case, environment, or KPIs. Existing SL UE selection criteria may leverage RSRP measurements, which may not be necessary for positioning. Priorities or selection criteria may consider relative or absolute proximity, absolute velocity, LOS determination, NLOS determination, unknown absolute locations, known absolute locations, or capabilities, or the like. A sixth consideration may be for how to support the SL positioning procedures scenarios within the existing positioning protocols and framework without Uu involvement. A seventh consideration may be for how to enable, defining security, implementing security, access restrictions or authorization for positioning information and SL-PRS, especially in public safety use cases. Examples may include temporary access or configurations to SL-PRS, request SL-PRS transmission(s) on-demand, or update SL-PRS transmission(s) on-demand. An eighth consideration may be for defining how or what entity is the positioning calculation/determination function, measurements and measurement configuration are carried out by target UE, master (controlling) entity, or PA UE. Account for target UE internal Tx/Rx delays in measurements.

This second issue may be addressed by the following second approach associated with discovery, selection, and assistance of SL positioning UEs and SL ranging/positioning configuration with Uu involvement.

In the second approach, method or system for a target UE may be operatively coupled to a location server (e.g., LMF) via one or more of PA UE, to perform SL positioning function and for SL direct connectivity, to perform positioning configuration for SL-PRS transmissions comprising one or more of the following steps. The target UE may receive pre-configuration from the network, master (controlling) entity, or pre-provisioned with: SL positioning service, SL discovery authorization and identifiers, measurement configuration, or SL-PRS reception resource and configuration set. The target UE upon trigger of an LCS request, may perform direct discovery of one or more PA UEs 202, which may include one or more of the following: an announcement positioning discovery message, a solicitation positioning discovery message, a response positioning discovery message, PA UE sensing involving the PA UE transmitting broadcast posSIBs, or other system information.

With continued reference to the second approach, target UE may select one or more of the authorized PA UEs that meet the configured criteria or capabilities to initiate positioning procedures. For SL direct communication link including security may be established between the target UE and PA UE(s). SL direct communication link may be established and used to tunnel LCS messages to the network upon PC5-RRC connected mode. SL LCS procedures may be initiated between the target UE and PA UEs to determine the absolute or relative position of the target UE. LCS procedures may include requesting capabilities, providing capabilities, requesting assistance data, providing assistance data, requesting location information, or providing location information. The target UE may provide additional SL-PRS requests to modify the initial SL-PRS transmissions, existing SL-PRS transmissions, or positioning configurations from the PA UE(s).

A third issue addressed herein is related to enhanced Uu and SL procedures, to support ranging and positioning for UEs equipped with a distributed antenna system (DAS).

The third issue is associated with supporting absolute or relative positioning that leverages SL-PRS (or combination of SL-PRS and DL-PRS) or SL-SRS. UEs equipped with a DAS may require enhancements to the existing positioning protocols or procedures. The following is addressed. Measurement configuration and measurement reporting procedures may need to be address scenarios with DAS including target UE as well as PA UE, e.g., additional positioning nodes (VRU, RSU, etc.). The identification of a single antenna versus distributed antenna system (e.g., type) or associated capability exchange is addressed.

In the third approach, methods, or systems to configure or enable DAS measurements at a target UE or PA entity may comprise location protocol messages that support the following steps for a procedure. A procedure may include initial positioning configuration of a target UE via Uu or SL interfaces. A procedure may include capabilities exchange between the target UE and network or SL PA UEs that may include DAS support or type(s) of DAS. A procedure may include target UE request antenna configuration assistance data of PA UEs to the network or PA UE. A procedure may include target UE reception of antenna configuration assistance data of PA UEs from the network or PA UE. A procedure may include target UE Measurement reports that may encompass separate measurements for two or more antennae sent to the network or master (controlling) entity.

The detailed approaches described herein may be used on their own or in combination with each other to perform SL positioning functions from SL positioning reference signals or associated SL configuration. In an example, the approaches may help achieve relative (ranging) or absolute positioning via SL signals or configuration, among other things.

To improve accuracy and efficiency for absolute and relative positioning, it is proposed to enhance the existing NR positioning procedures and architecture to support positioning of a target UE via SL positioning reference signals (SL-PRS) and associated configurations.

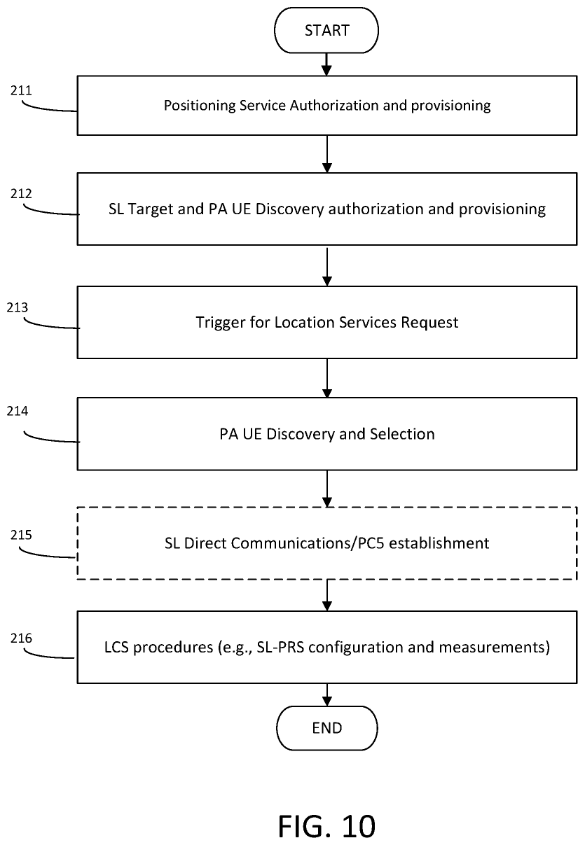

To illustrate the procedures necessary to achieve positioning over SL, the following high-level steps are illustrated in the general process flow as shown in FIG. 10. At step 211, target UE 201 (e.g., UE to be located) and PA UE(s) 202 may require positioning service authorization and provisioning. This may include some initial SL positioning pre-configuration and authorization for the UE(s). At step 212, SL positioning UE discovery authorization may be required to facilitate discovery of target UEs 201 and PA UEs 202 inclusive of some identification for each UE (or group), specific to positioning operations. At step 213, a trigger may occur for a location services (LCS) request (e.g., a request for a position determination or positioning measurements function). The LCS request may be a singular position determination request or a tracking (e.g., series) positioning request and may be specific to a particular positioning method or type (absolute vs relative), two or three dimensions, or the like. At step 214, target UE 201 or a master (e.g., controlling) entity (e.g., function) may search for and discover potential PA UEs 202. A PA (which may be a controlling entity) may perform the role of an LMF 206 (e.g., location server) and may be used to, for example, calculate target UE position, disseminate positioning assistance data, configure the target UE 201, etc. Once the potential PA UE(s) 202 is identified, the target UE 201 may select one or more PA UEs 202 for positioning operations. At step 215, the configured threshold(s) for selection of a SL PA UE (e.g., master (controlling) entity (e.g., function) or PA UE) may be a separate threshold than the configured threshold of a SL UE for direct communication establishment/selection (e.g., relay UE or function) and may be based on RSRP/RSRQ. Additionally, SL direct communication may be established between the target UE 201 and the PA UE 202, inclusive of security and PC5 establishment to aid in exchange of, for example, positioning capabilities, configuration, assistance data, requests, etc. At step 216, LCS procedures may commence resulting in position or positioning measurements for the target UE 201 with subsequent reconfiguration requests as necessary.

The details of these enhanced procedures and architectures are further described herein. The entities involved in the SL positioning procedures include the legacy LCS entities as previously described, e.g., LCS client, LMF, or location server. However, the target UE 201 may discover and communicate with one or more SL Positioning Assist (PA) UE(s) 202 without the involvement of the network (including NG-RAN 207, AMF, LMF 206) for the positioning operations. It is envisioned that a PA UE 202 (or other entity) may include a plurality of logical functions, which may reside on a single device or a plurality of devices. These logical functions may include a positioning assist (PA) function to perform SL positioning and ranging procedures and transmit SL-PRS, a master (e.g., controlling) entity that serves as the controlling entity for SL positioning or ranging procedures to locate a target UE 201, and a SL Relay UE/Function (UE-to-UE relay) that provides the direct communication (e.g., PC5-RRC link) operations.

To further illustrate the procedures associated with the SL positioning operations without network involvement over Uu interface, the following sections detail steps that may apply.

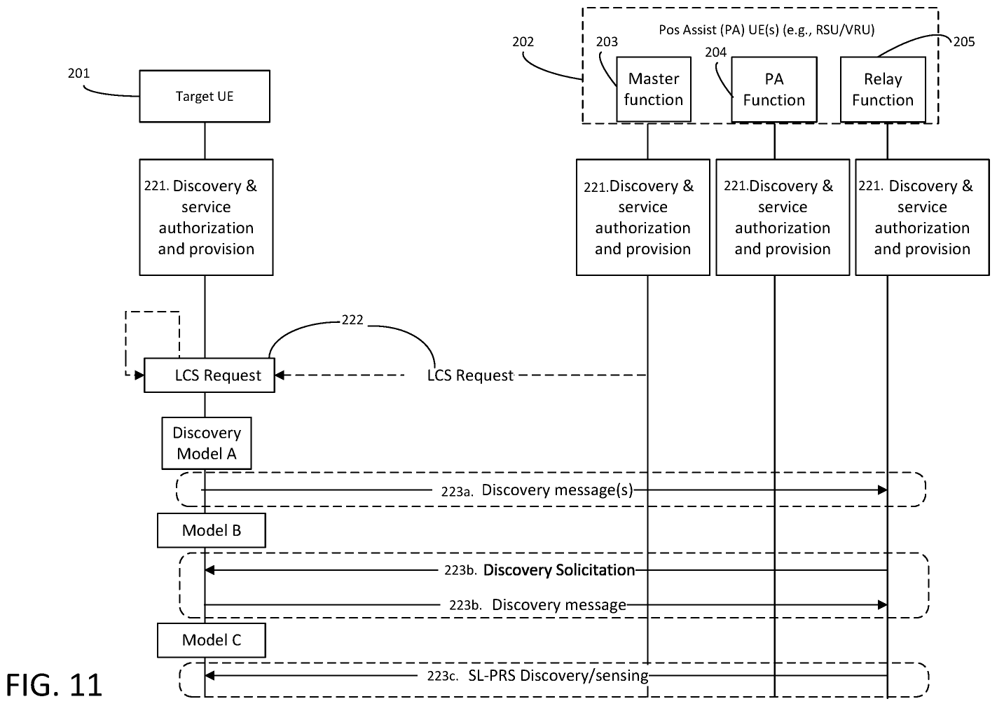

FIG. 11 illustrates an exemplary method associated with (pre) provisioning of SL positioning configuration information, including discovery authorization, service authorization for a target UE 201, master (e.g., controlling) entity (e.g., master function 203), and relay UE or relay function (e.g., relay function 205). Various SL discovery models are also addressed.

At step 221, NR SL positioning discovery authorization, service authorization, or (pre) configuration may be performed by the target UE 201 and one or more PA UEs 202. The target UE 201 or PA UE(s) 202 may obtain initial positioning configuration information via e.g., broadcast system information, (pre) provisioning, or dedicated signaling whilst the UE(s) are in network coverage. This may allow for SL UE configuration or resource allocation to occur autonomously from the NG-RAN/network over the Uu interface. For some scenarios, the SL positioning (pre) configuration may be accompanied by a validity time or validity timer. Additionally, the SL positioning (pre) configuration may be associated with a validity area, which may be a geographic area or area associated with network coverage.

With continued reference to step 221, the configuration information may include provisioning or registration of positioning service, positioning service type (e.g., emergency, (a) periodic, relative, absolute position, etc.), positioning QOS (e.g., KPI) requirements, PA UE selection criteria or priority (separate PA UE/master entity e.g., (PRS) threshold for SL Positioning signal and threshold for SL Direct Communication for Relay UE/function), UE group identifiers (e.g., Layer-2 Group ID), initial SL-PRS parameters/resources (e.g., PRS type, PRS muting patterns, initial B/W, periodicities, or associated measurement configuration), discovery mechanism configurations, or the like. As part of the initial service authorization or (pre) configuration, some PA UEs 202 may be configured or designated as a master PA UE (master entity) in which the PA UE 202 has authorization to instigate (e.g., send or trigger) LCS requests, perform target UE positioning calculation, or other positioning operations for one or more target UEs 201 and a plurality of PA UEs 202. The SL Relay UE/function may also obtain SL direct communication service authorization and (pre) configuration via provisioning, dedicated signaling, or broadcast from the network while in-coverage.

The SL positioning discovery authorization or provisioning may be initiated by target UE 201 or PA UE(s) 202. This may include UE capabilities or type exchange or other information that may be required to facilitate positioning procedures for target UEs 201 or PA UE(s) 202. Note, this step may occur prior to or after positioning triggers (e.g., LCS requests).

With reference to step 222, for out-of-coverage scenarios and scenarios without Uu involvement, the target UE 201 may instigate SL positioning or PA UE discovery procedures. In some scenarios, target UE 201 or PA UE 202 may be equipped with an LCS client that may be configured for higher layer (e.g., application layer) triggers to instigate the LCS request of step 222. The LCS client or application may trigger the SL-PRS LCS request to determine position, periodic position, or due to other positioning methods that are not available (e.g., GNSS not available or degradation).

In other scenarios, a master (controlling) entity 203 (e.g., PA UE 202) may instigate the LCS request to the target UE 201, via, for example, LCS client/higher layers/application, if it is configured or designated as such in step 221. In these cases, the master entity or PA UE 202 may also broadcast or multicast its own position information via, for example, SL MIB/SIB (posSIB).

With continued reference to step 222, for these scenarios, there may be an indication of the positioning service type requested. For example, there may be a request for relative position or absolute position. Position requests may also target a particular QoS or KPIs associated with the LCS request. These may include one or more factors, such as Lat/Long/altitude for three dimensions, speed relative to another UE, or trajectory relative to another UE. For example, the LCS request may include a requirement (e.g., criteria) for a threshold speed relative to another UE.

At step 223, there may be multiple types of positioning or SL direct communications discovery message models, such as disclosed with step 223a, step 223b, or step 223c.

At step 223a, there may be a Model A type direct discovery that may use a single PA UE discovery protocol message, e.g., an announcement. The target UE 201 or PA UEs 202 may use pre-configured or provisioned configuration information from step 221 or another step. For example, the SL-PRS positioning techniques, scenarios supported, absolute or relative position support, selection criteria, or selection security, among other things. Information used for discovery may include positioning mode (e.g., UE-based or UE-assisted) or positioning type (e.g., absolute or relative/ranging) supported or requested.

At step 223b, there may be a Model B type direct discovery that may use two PA UE discovery protocol messages (e.g., solicitation and response). The PA UE 202 may send a solicitation message to the target UE 201, which in turn responds to PA UE 202. The target UE 201 or PA UEs 202 may use pre-configured information or provisioned configuration information from step 221 or other steps. For example, the SL-PRS positioning technique(s) or SL-PRS signal(s) supported, scenarios supported, absolute or relative position support, selection criteria and security to aid in target UE discovery. Information used for discovery may include positioning mode (e.g., UE-based or UE-assisted) or positioning type (e.g., absolute or relative/ranging) supported or requested.

At step 223c, there may be SL-PRS Discovery/sensing, in which discovery and PA UE “sensing” may involve the PA UE 202 transmitting broadcast posSIBs or System Information that may be leveraged by the target UE 201. Moreover, the PA UE 202 may transmit SL-SSB that may be inclusive of identification, discovery data that may also be used as part of the SL-PRS. The target UE 201 or PA UE 202 may leverage (pre) configuration to assist in discovery (e.g., sensing). In some cases, the target UE 201 may only need to receive SL-SSB from the PA UE 202 and perform measurements based on synchronization signals. In other scenarios, the SL-SSB from the PA UE 202 may enable acquisition of PSBCH to receive SL positioning configuration information or SL DMRS, which may also be leveraged by the target UE 201 for positioning measurements.

In one exemplary method, the existing Sidelink MIB (based on TS 38.331 section 6.2.2) may be modified to include assistance information for the target UE 201 to extract SL-PRS configuration or SL-PRS measurements (as previously described SL-PRS may involve signals, such as SSBs, CSI-RS, PT-RS, DMRS, or the like).

### The Master Information Block Sidelink

(MasterInformationBlockSidelink) may include the system information transmitted by a UE via SL-BCH, including configuration information for SL positioning and ranging. See Table 4 and Table 5. Configuration information may include RLC-SAP: TM; Logical channel: SBCCH; or Direction: UE to UE.

TABLE 4
MasterInformationBlockSidelink

-- ASN1START
-- TAG-MASTERINFORMATIONBLOCKSIDELINK-START

| | |
|---|---|
| MasterInformationBlockSidelink ::= | SEQUENCE { |
| sl-TDD-Config-r16 | BIT STRING (SIZE (12)), |
| inCoverage-r16 | BOOLEAN, |
| directFrameNumber-r16 | BIT STRING (SIZE (10)), |
| slotIndex-r16 | BIT STRING (SIZE (7)), |
| reservedBits-r16 | BIT STRING (SIZE (2)), |

```
    ...,
    [[
```

| | |
|---|---|
| sl-PRS-configuration-r18 | SL-PRS-configuration-R18 |

]]
}
-- TAG-MASTERINFORMATIONBLOCKSIDELINK-STOP
-- ASN1STOP

TABLE 5
MasterInformationBlockSidelink field descriptions

directFrameNumber
Indicates the frame number in which S-SSB transmitted.
inCoverage
Value true indicates that the UE transmitting the MasterInformationBlockSidelink is in
network coverage, or UE may select GNSS timing as the synchronization reference source.
slotIndex
Indicates the slot index in which S-SSB transmitted.
sl-PRS-configuration
Indicates the Sidelink PRS configuration(s) for a particular PA UE. This IE (and
corresponding sub-elements) may also be incorporated into the reserved bits. For example,
an indication for SL Positioning Support, or SL Pos Type Support (e.g., Absolute or
Relative Position flag) may be included, among other SL positioning configuration IEs as
part of the MIB-Sidelink. Additional embodiments may include broadcast e.g., geographic
coordinates for a particular PA UE.
The SL-PRS configuration may be partially contained in the SL-MIB whereby the SL
configuration is indexed in the SL-MIB or some of the configuration is carried through
other SI or dedicated signalling, e.g., RRC message.

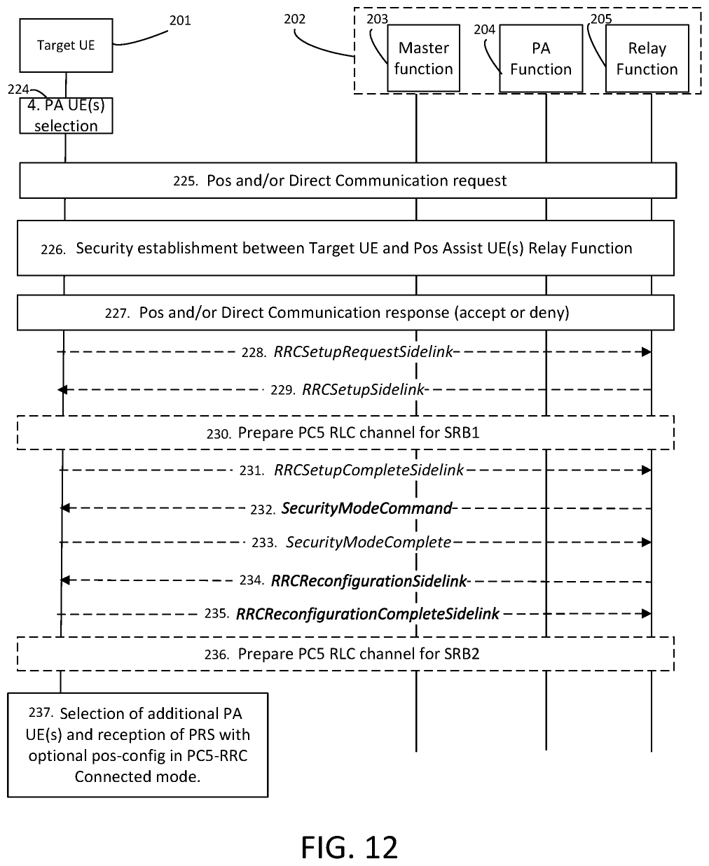

FIG. 12 illustrates an exemplary method flow for PA selection and PC5 establishment without Uu interaction. This may include PA Selection (master entity, PA UE) and PC5 connection establishment (Relay UE or relay function) without Uu Interaction. Step 224-step 237 may occur afterwards or in addition to step 221-step 223.

At step 224, target UE 201 may select one or more of the authorized PA UE 202 that meet the configured criteria to initiate positioning procedures, including measurements performed on SL-PRS(s). For this step 224, it may not be necessary to have established SL direct communication and the logical Relay Function 205 may or may not be present at the PA UE 202 (e.g., a separate PA UE may offer the SL PA UE or master entity and another PA UE may offer the Relay UE/function to aid in configuration). For simplicity, these functions are shown in FIG. 12 and throughout herein as a single device, but may require additional signaling over SL as discussed further to enable PA UE 202 as a relay function for a “remote” PA UE 202.

At step 225, SL positioning request or SL direct communication request may be sent from the target UE 201 to the PA UE(s) 202. The target UE 201 identifying information (e.g., layer-2 group ID) may include one of the following: SL positioning request or SL direct communication request. SL positioning request may include a request for SL-PRS transmission, request for SL-PRS configuration to assist in reception of PRS signals, request for capabilities, or the like. SL direct communications request may include request for unicast, broadcast/multicast. A request may include a SL positioning request and SL direct communications request. No request may be necessary if PA UE SL-PRS is detected with pre-configuration or sufficient QoS (e.g., KPIs) criteria are met as determined by the target UE 201.

At step 226, security establishment between target UE 201 and PA UE(s) relay function 205. The discovery procedures may enable the positioning authorization and SL direct communication security establishment between the target UE 201 and the PA UE(s) 202.

At step 227, SL positioning response or SL direct communication response may be executed. The SL response message(s) may be sent from one or more the PA UE(s) 202. The response message may include specific aspects of the request and approve, deny, or partially approve. In some methods, the SL positioning or SL direct communications responses may have a relationship or dependencies on one another. For example, depending on configuration and UE capabilities or requirements, the response message may categorically approve or deny the request.

Note that step 228-step 236 may be required if the SL request also includes a SL direct communication request. A direct communication request may be required if the target UE 201 requests SL-PRS reconfiguration or requires additional information (e.g., capabilities, resources, or configuration) from PA UE 202.

At step 228, if SL direct communication establishment is requested, the target UE 201 may send the first RRC message (e.g., RRCSetupRequestsidelink) for its connection establishment with the relay function 205, using a default Layer-2 configuration on SL (e.g., PC5).

At step 229, there may be a message (e.g., RRCSetupSidelink) delivery to the target UE 201, which may use the default configuration on SL (PC5). The target UE 201 may initiate its own connection establishment upon reception of the message on the default L2 configuration on PC5.

At step 230, PC5 RLC channel for SRB1 may be prepared. The relay function 205 and target UE 201 may perform channel setup procedure over Sidelink. The target UEs 201 may receive configuration from PA UE (if necessary), and the relay function 205 or target UE 201 may establish an RLC channel for SRB1 over PC5.

At step 231, target UE SRB1 message (e.g., an RRCSetupComplete message) may be sent to the PA UE Relay function 205 using SRB1 relaying channel over PC5. Then the target UE 201 may be connected to PA UE 202 over PC5-RRC.

At step 232, target UE 201 and PA UE relay function 205 may establish security mode (e.g., sending or receiving SecurityModeCommand.message), if not (pre) configured.

At step 233, target UE 201 may send security mode complete message (e.g., SecurityModeComplete message) to the PA UE relay function 205.

At step 234, PA UE relay function 205 may setup up additional RLC channels between the target UE 201 and PA UE 202. According to the (pre) configuration from step 221, the PA UE 202 or target UE 201 may set up additional RLC channels between the target UE 201 and PA UE 202 to modify the PC5-RRC connection, e.g., to modify/release SL RBs, to (re-)configure NR sidelink measurement and reporting, to (re-)configure SL-PRS, or sidelink CSI reference signal (CSI-RS) resources. The RRCReconfigurationSidelink may be sent to the target UE 201 from the PA UE, which may setup the relaying SRB2/DRBs that is similar to procedures outlined in TR38.836.

At step 235, target UE 201 may send a message (e.g., RR (ReconfigurationSidelinkComplete) from the target UE 201 to the PA UE relay function 205 as a response.

At step 236, prepare PC5 RLC channel for SRB2 via PA UE 202. The target UE 201 or PA UE relay function 205 may perform channel setup procedure over SL. The PA UEs 202 or target UEs 201 may use (pre) configuration, and the PA UE 202 or target UE 201 establish an RLC channel for SRB2 over PC5. This step prepares the RLC channel for SRB2 to enable SL (bi-directional, e.g., pseudo-DL/UL) information transfer.

At step 237, selection of additional PA UE(s) 202 or reception of PRS with associated configuration in PC5-RRC Connected mode may occur.

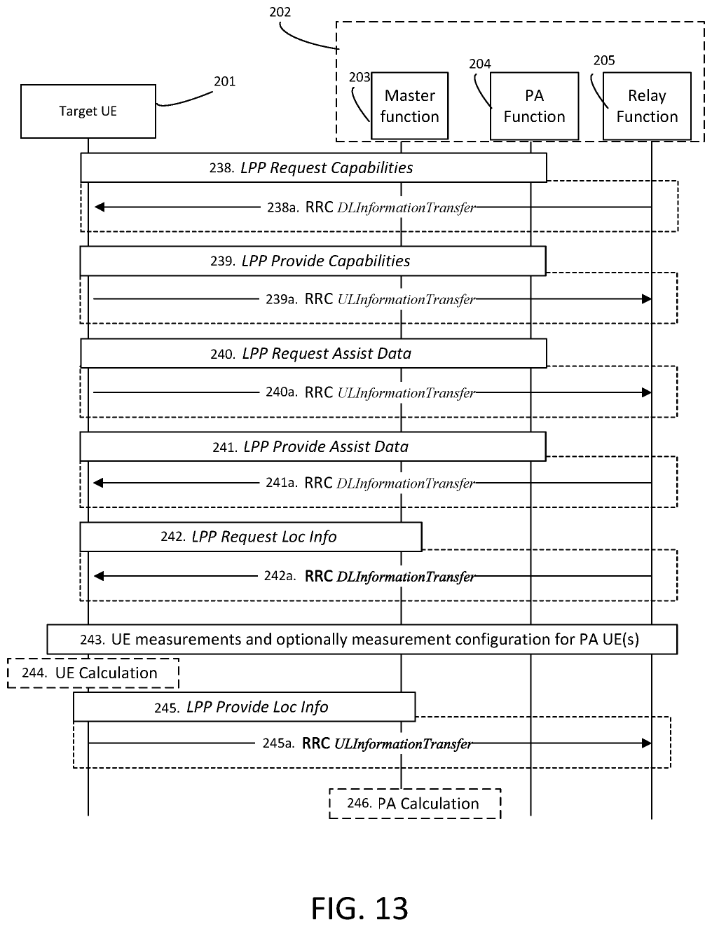

FIG. 13 illustrates an exemplary method flow for NR SL Positioning specific procedures without Uu Interaction. These SL positioning tasks include LPP related procedures, without Uu Interaction.

Step 238-step 246 may be in addition to one or more steps of step 221-step 237. At step 238-step 246 there may be LCS specific messages and procedures (e.g., LPP) which may be dependent upon the positioning mode and some possible pre-configuration. In this scenario, the PA UE 202 (master entity 203) may provide the SL positioning operations.

Step 238 may be associated with LPP request capabilities. The PA UE 202 may send a NAS message (e.g., RRC DL Information Transfer) to the target UE 201. RRC DL Information Transfer (LPP PDU). The PA relay function UE may send a NAS message to the target UE 201 originating from the master entity 203 (also referred herein as master function 203). The NAS message may be encapsulated in an RRC message that is sent over the SL via the PA UE 202 (Relay function 205), and the PA UE 202 (Relay Function) may forward the message to the target UE 201.

Step 239 may be associated with LPP providing capabilities. The target UE 201 may send a NAS message (RRC UL Information Transfer) to the PA UE 202. The target UE 201 may send the NAS message to the master entity 203 via the PA UE 202 (Relay Function 205). The NAS message is encapsulated in an RRC message that is sent over the SL from the target UE 201 via the PA UE 202 (Relay function 205), and the PA UE 202 (Relay Function 205) may forward the message to the master entity 203.

At step 240, target UE 201 may send a LPP Request Assistance Data associated NAS message (RRC UL Information Transfer) to the PA UE 202. RRC UL Information Transfer may be a LPP PDU. The target UE 201 may send this NAS message to the master entity 203 via the PA UE 202 (Relay Function 205). The NAS message may be encapsulated in an RRC message that is sent over the SL from the target UE 201 via the PA UE 202 (Relay function), and the PA UE 202 (Relay Function) may forward the message to the master entity 203.

At step 241, the PA UE 202 may send a LPP Provide Assistance Data associated NAS message (RRC DL Information Transfer) to the target UE 201. RRC DL Information Transfer may be LPP PDU. The PA relay function UE 205 may send this NAS message to the target UE 201 originating from the master entity 203. The NAS message may be encapsulated in an RRC message that is sent over the SL via the PA UE 202 (Relay function), and the PA UE 202 (Relay Function 205) may forward the message to the target UE 201.

At step 242, the PA UE 202 may send LPP Request Location Information associated NAS message (RRC DL Information Transfer) to the target UE 201. There may be a timer (or time) associated with the validity for the location request. RRC DL Information Transfer may be LPP PDU. The PA relay function UE 205 may send this NAS message to the target UE 201 originating from the master entity 203. The NAS message may be encapsulated in an RRC message that may be sent over the SL via the PA UE 202 (Relay function 205), and the PA UE 202 (Relay Function 205) may forward the message to the target UE 201.

Step 243 may be associated with UE measurements and optionally measurement (re) configuration of PA UE(s) 202. At step 243, the target UE 201 may also send an offset for timing measurements that include an adjustment for internal transmit or receive delays and not only absolute values.

Step 244 may be associated with UE positioning calculation. At step 244, the target UE 201 may perform positioning determination for UE-based mode of operation per configuration. Note that absolute and relative position determination is possible.

Step 245 may be associated with LPP provided location information. At step 245, the target UE 201 may send this NAS message (RRC UL Information Transfer) to the PA UE 202. RRC UL Information Transfer. LPP PDU. The target UE 201 may send this NAS message to the master entity 203 via the PA UE 202 (Relay Function 205). The NAS message may be encapsulated in an RRC message that is sent over the SL from the target UE 201 via the PA UE 202 (Relay function 205), and the PA UE 202 (Relay Function 205) forwards the message to the master entity.

Step 246 may be associated with PA UE positioning calculation. At step 246, the PA UE 202 may calculate the target UE 201 position for UE-assisted SL Positioning operations whereby the master entity is performing the positioning calculation function. Note that absolute and relative position determination is possible.

Furthermore, on discovery messages, announcements, solicitation and response, or PA UE 202 selection one or more of the following (pre) configuration IEs (e.g., parameters) may be provided. The (pre) configuration IEs may be specific to UE or group of UEs based on e.g., zone ID, beam ID, application ID, or destination layer-2 group ID. The (pre) configuration IEs may be associated with a NG-RAN serving cell/beam/area or network, e.g., TAC, RNA, PLMN, or S-NSSAI. The (pre) configuration IEs may be associated with (de) activation of a preconfigured SL-PRS resource set or subset. The (pre) configuration IEs may be counter limit (e.g., number of target UE 201 requests allowed). The (pre) configuration IEs may be validity or time limit for positioning service authorization, or associated prohibit timer. The (pre) configuration IEs may be service type, e.g., public safety, commercial, V2X, IoT, etc. The (pre) configuration IEs may be emergency services. The (pre) configuration IEs may be QoS attributes, which may include positioning accuracy, positioning latency, inter-cell interference, measurements, or associated thresholds or levels.

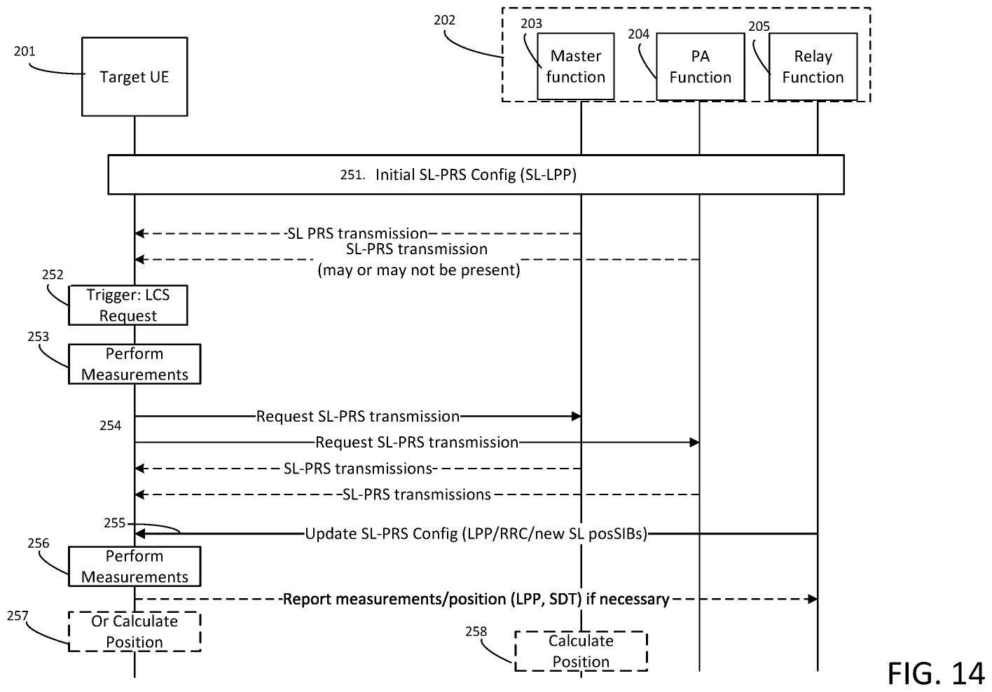

Other examples may address “on-demand” aspects of SL-PRS, related to Rel-17 DL-PRS “on-demand” enhancements. SL-PRS may not always be present or sufficient (e.g., PRS type, bandwidth, or periodicity) to meet QoS (e.g., KPI) requirements. Therefore, the target UE 201 may request SL-PRS transmissions from PA UEs 202. For an out of coverage scenario, the procedures depicted in FIG. 14 may show the process for which a target UE 201 requests an update of the SL-PRS. In the example, at step 251, an initial SL-PRS configuration is present for the target UE 201 and the PA UEs 202. As shown in the FIG. 14, some examples may have a master entity 203 that may also configure one or more additional PA UEs 202 or SL-PRS. Subsequently, at step 252, an LCS request may be triggered. At step 253, the target UE 201 may perform measurements or has an indication of the existing SL-PRS configuration for a PA UE 202. Based on step 253, at step 254, the target UE 201 may request an update of the SL-PRS transmissions of one or more PA UE 202. At step 255, if the request is accepted, the PA UEs 202 may update the target UE 201 with the new SL-PRS configuration (via broadcast, dedicated SL signaling, etc.). At step 256, the target UE 201 may perform measurements on the SL-PRS and calculate its own position (at step 257) or send (at step 258) the measurements to the master entity 203 for position determination.

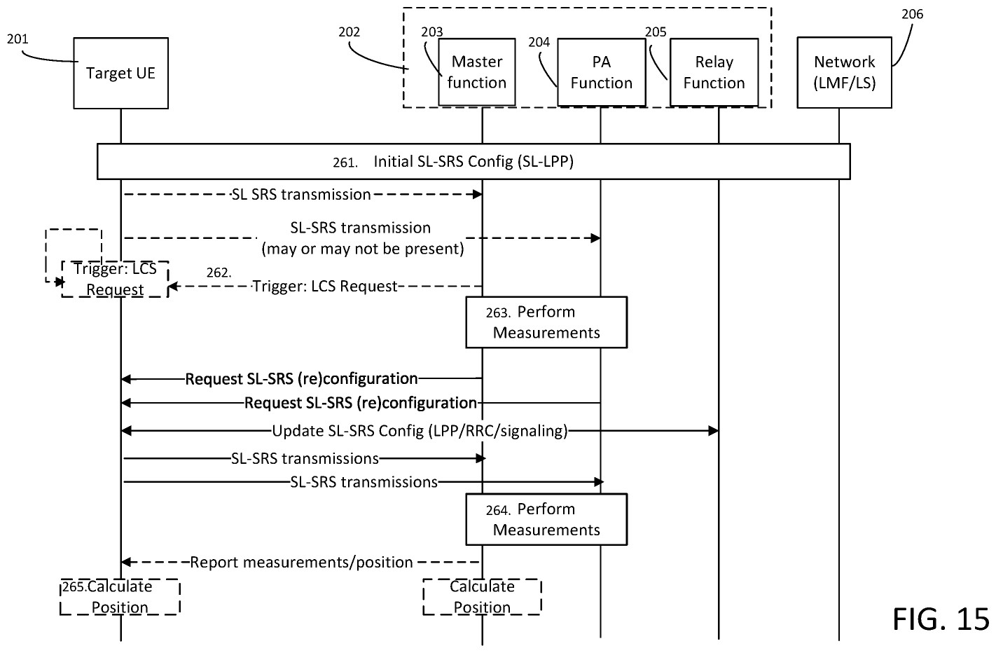

In further exemplary methods, the target UE 201 may leverage SL-SRS (Sounding Reference Signals) in the SL received at the PA UE 202 as well. As shown in FIG. 15, target UE 201 and one or more PA UEs 202 may be (pre) configured by the network or autonomously from the network for SL-SRS positioning techniques (see step 261). In these scenarios, the PA UE 202 may be (pre) configured to receive SL-SRS from the target UE 201 and the target UE 201 is (pre) configured to transmit the SL-SRS. After capabilities exchange, authorization as previously described, at step 262, an LCS trigger may initiate SL-SRS transmissions by the target UE 201. In the case where SL-SRS is already transmitted by the UE, an LCS trigger may initiate assistance data sent from a target UE 201 to PA UE(s) 202 to aid in reception of SL-SRS. In some scenarios, the PA UE 202 performs measurements (at step 263), and calculates the (absolute or relative) position of the target UE 201. Alternatively, the PA UE 202 may send, at step 264, one or more measurements to the target UE 201, whereby the target UE 201 may calculate its own position (at step 265). The scenarios described are without Uu involvement, however, it may be possible to extend this concept to in-coverage and partial coverage scenarios (with Uu involvement).

For configuration of target UE 201 and PA UE 202, to support both absolute and relative positioning that leverages SL-PRS (or combination of SL-PRS and DL-PRS) it is proposed that both SL and Uu positioning may be used together. Discovery, selection, and assistance of SL UEs may be accomplished with Uu involvement. The target UE 201 may be aided by the network (gNB, LMF) including tunneling of LCS messages to the Network for SL configuration and appropriate SL-PRS resource allocation.

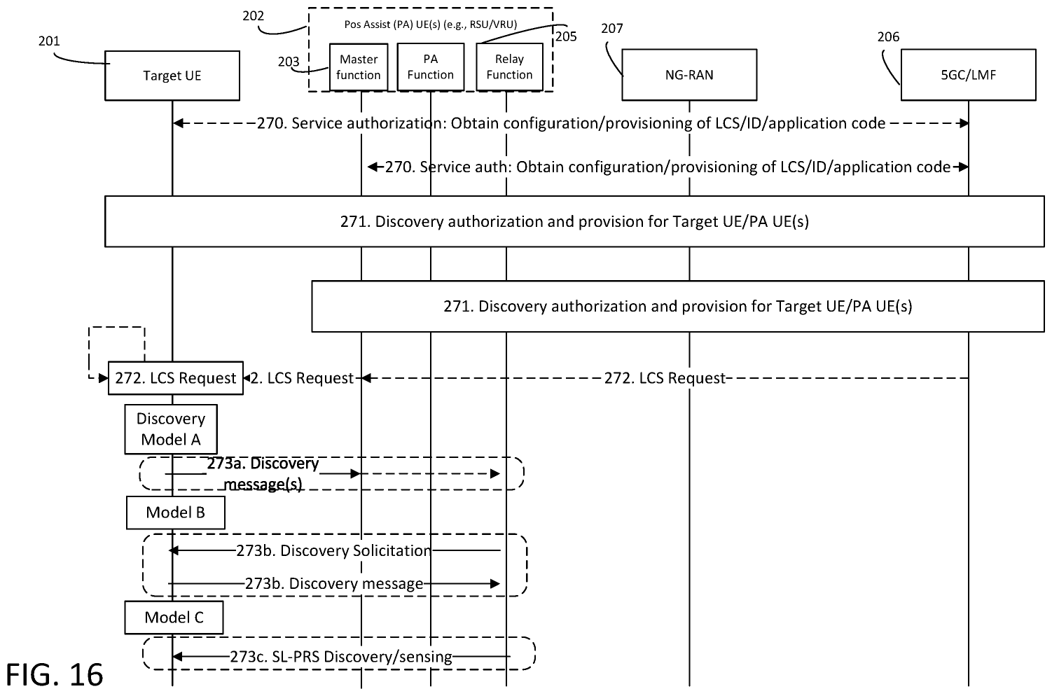

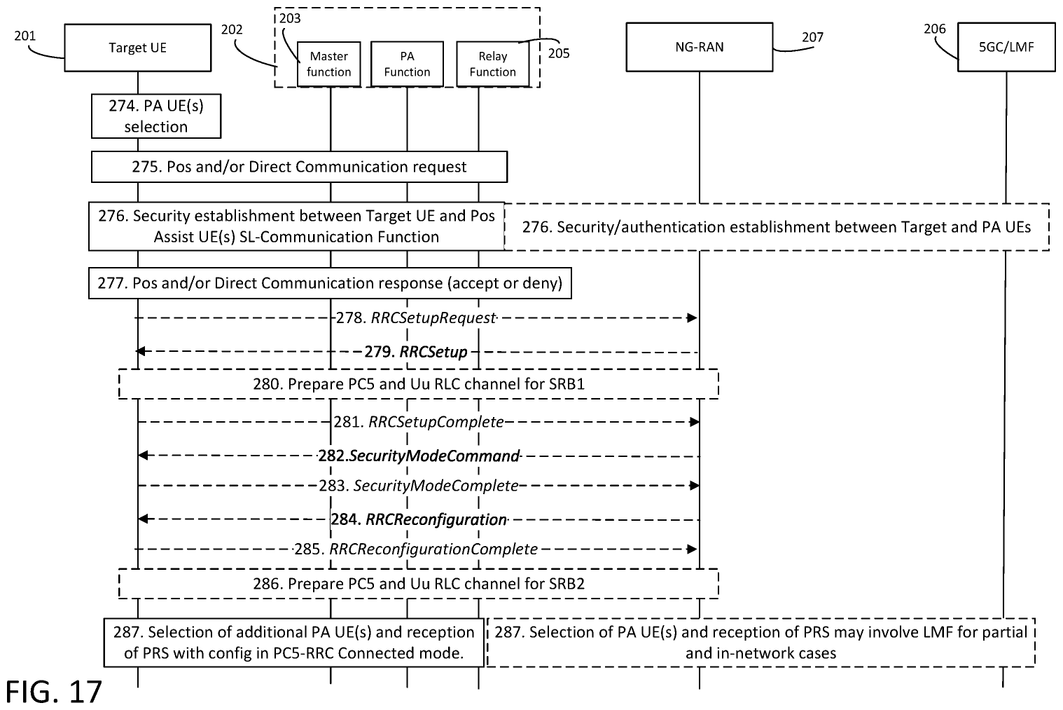

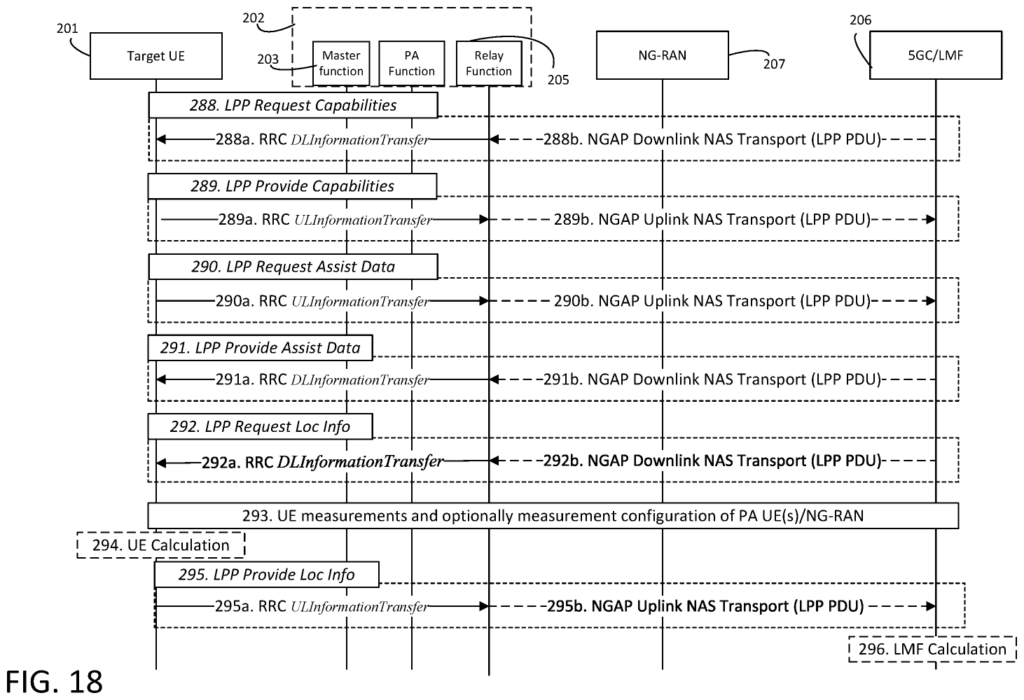

It is envisioned that the PA UE 202 described may include a plurality of logical functions. Herein on the SL PA Function 204 (also a master entity) and the Relay (UE-N/W relay) Function 205. Note that in this case, the master entity 203 may take some role or a shared role of an LMF, but in the primarily, the controlling entity may be the N/W (e.g., LMF) and may be dependent upon the network coverage scenario (e.g., in, partial, or out) and other factors. It may also be envisioned that the logical PA UE 202 entities may be a single physical entity or separate entities, or deployed as combinations thereof. To further illustrate the procedures associated with the SL positioning operations with network involvement over Uu interface, the following detailed steps may apply as shown in in FIG. 16, FIG. 17, or FIG. 18 to demonstrate the procedures for PA UE function 205 (including a master entity 203) and a Relay function 20 with Uu involvement.

FIG. 16 illustrates an exemplary method flow for (pre) provisioning of SL positioning configuration information, which may include discovery authorization, service authorization for a target UE 201, master (controlling) function 203, or relay function 205. Various SL Discovery models are also addressed.

Step 270 is associated with NR SL positioning service authorization or SL Direct Communication service authorization and (pre) configuration being performed by the target UE 201 (remote) or one or more PA UE 202 (master entity, relay UE functions). The target UE 201 or PA UEs 202 may obtain positioning initial configuration information via broadcast system information, (pre) provisioning, or dedicated signaling. For some scenarios, the SL positioning (pre) configuration may be accompanied by a validity time or validity timer. Additionally, the SL positioning (pre) configuration may be associated with a validity area, either geographic area or area associated with network coverage.

The configuration information may include provisioning of positioning service, positioning service type, positioning QoS requirements, PA UE selection criteria and priority (e.g., separate signal (PRS) threshold for SL Positioning signal and threshold for SL Direct Communication), UE group identifiers (e.g., Layer-2 Group ID), initial SL-PRS parameters or resources (e.g., PRS type, PRS muting patterns, initial B/W, periodicities, and associated measurement configuration), discovery mechanism configurations, or the like. As part of the initial service authorization and (pre) configuration, some PA UEs 202 may be configured or designated as a master entity 203 in which the PA UE 202 has authorization to instigate LCS request or perform target UE 201 positioning calculation or other positioning operations for one or more target UEs 201 and a plurality of PA UEs 202. SL Relay UE function may also obtain SL direct communication service authorization and (pre) configuration via provisioning, dedicated signaling, or broadcast from the network.

With reference to step 271, for the target UE 201 (remote) or one or more PA UEs 202, the SL positioning discovery authorization and provisioning may be initiated by the network or the UE(s). This may include UE capabilities (e.g., type) exchange (e.g., only certain device types/class such as non-RedCap UEs are authorized) or other information necessary to facilitate positioning procedures for the target UEs 201 or PA UEs 202. Note, this step 271 or other steps may occur prior to or after Positioning triggers or LCS requests.

At step 272, there may be a LCS request sent or received. With reference to step 272, for in-coverage scenarios. For a first in-coverage scenario, an entity in the 5GC (e.g., LMF, Location Server) may request some location service (e.g., positioning) for a target UE 201. In a second in-coverage scenario, the serving AMF for a target UE 201 may determine the need for a location service, e.g., to locate the UE for an emergency call. In a third in-coverage scenario, the target UE 201 may request some location service (e.g., positioning or delivery of assistance data/configuration) to the serving AMF at the NAS level. In a fourth in-coverage scenario, the PA UE 202 (master entity 203) may instigate the LCS Request to the target UE 201, if it is configured and designated as such in step 270. In these cases, the master entity 203 may also broadcast or multicast its own position information via e.g., SL MIB/SIB (posSIB).

For out-of-coverage (see previous discussion) and partial coverage scenarios, the target UE 201 instigates SL positioning and PA UE discovery procedures. Alternatively, a PA UE 202 (master entity 203) may instigate the LCS Request to the target UE 201, if it is configured and designated as such in step 270. In these cases, the master entity 203 may also broadcast or multicast its own position information via, for example, SL MIB/SIB (posSIB).

In some scenarios, the target UE 201 or PA UE 202 may be equipped with an LCS client, configured for higher layer/application layer triggers to instigate (e.g., trigger) the LCS request. The LCS client or application may trigger the SL-PRS LCS request to determine position, periodic position, or due to other positioning methods that are not available (e.g., GNSS not available or degradation).

Step 273 may be associated with discovery messages. At step 273a, there may be Model A type direct discovery that may use PA UE discovery protocol messages, e.g., announcements. In the SL positioning context, the target UE 201 or PA UE 202 (master entity or PA UE 202) may use pre-configured or provisioned configuration information for example, the SL-PRS positioning techniques, scenarios supported, selection criteria, or security. Other information used for discovery may include positioning mode (e.g., UE-based or UE-assisted) or positioning type (absolute or relative/ranging) supported or requested. Additionally, the PA UE 202 (relay function 205) may receive a separate discovery message for the SL Direct Communications discovery.

At step 273b, there may be Model B type direct discovery that may use two PA UE discovery protocol messages (e.g., solicitation and response). In the SL positioning context, the target UE 201 or PA UEs 202 use pre-configured or provisioned configuration information, for example, the SL-PRS positioning technique(s) and SL-PRS signal(s) supported, scenarios supported, selection criteria and security to aid in PA UE discovery. Other information used for discovery may include positioning mode (e.g., UE-based or UE-assisted) or positioning type (e.g., absolute or relative/ranging) supported or requested. In the SL positioning context, the PA UE 202 (e.g., relay function 205) may receive a separate discovery message for the SL Direct Communications discovery.

At step 273c, there may be SL-PRS Discovery/sensing. Discovery or PA UE “sensing” may involve the PA UE 202 transmitting broadcast posSIBs and System Information that may be leveraged by the target UE 201. Moreover, the PA UE 202 may transmit SL-SSB that may be inclusive of identification, discovery data that may also be used as part of the SL-PRS. The target UE 201 or PA UE 202 may leverage (pre) configuration to assist in discovery/sensing. In some cases, the target UE 201 may only need to receive SL-SSB from the PA UE 202 and perform measurements based on synchronization signals. Alternatively, the SL-SSB from the PA UE 202 may also enable acquisition of PBSCH to receive SL positioning configuration information or SL DMRS, which may also be leveraged by the target UE 201 for positioning measurements.

FIG. 17 illustrates an exemplary method flow for NR SL Positioning Configuration and Discovery with Uu Involvement. This may include PA Selection (master entity 203, PA UE 202) and PC5 connection establishment (Relay UE/function) with Uu Interaction.

At step 274, the target UE 201 may select one or more of the authorized PA UE 202 that met the configured criteria to initiate positioning procedures, which may include measurements performed on SL-PRS(s) or measurements used for SL Direct Communication. The SL Relay Function 205 as disclosed in the previous procedures may or may not be present at the PA UEs 202. However, it may be envisioned that the selection of PA UEs 202 or reception of SL-PRS may involve the N/W, LMF, or Location server for in-coverage scenarios for SL positioning procedures and SL Direct Communication. Potentially, for partial coverage scenarios, the PA UE 202 may re-transmit broadcast posSIB or system information.

The target UE 201 selection of an authorized PA UE 202 may have separate selection criterion for SL positioning versus SL direct communication. The selection of a PA UE 202 on the basis of signal strength (RSRP) may not always be necessary for SL positioning.

At step 275, SL positioning or SL direct communication request may be sent from the target UE 201 to the PA UE(s) 202 with target UE 201 identifying information (e.g., layer-2 group ID). SL positioning request may include a request for SL-PRS transmission, request for SL-PRS configuration to assist in reception of PRS signals, request for capabilities, or the like. SL direct communications request may include request for unicast, broadcast, or multicast. A request may include a SL Positioning request and Direct Communications request. No request may be necessary if PA UE SL-PRS is detected with pre-configuration and sufficient QoS criteria is met, which may be determined by the target UE 201.

At step 276, security establishment between target UE 201 and PA UE(s) Relay Function 205. The discovery procedures may enable the positioning authorization and SL direct communication security establishment between the target UE 201 and the PA UE(s) 202. The NG-RAN and the LMF/Location Server may also be involved with authorization and security establishment.

Step 277 may be associated with SL Positioning response or SL Direct Communication response. The SL response message(s) may be sent from the PA UE(s) 202. The response message may include specific aspects of the request and approve, deny, or partially approve. In some methods, the SL Positioning and SL Direct Communications responses may have a relationship or dependencies on one another. For example, depending on configuration and UE capabilities/requirements, the response message may categorically approve or deny the request.

Steps 278-286 may be required if the SL request also includes a SL Direct Communication request. A direct communication request may be required if the target UE 201 requests SL-PRS reconfiguration or requires additional information (e.g., capabilities, resources, config) from the PA UE 202.

At step 278, if SL Direct Communication establishment is requested, the target UE 201 may send the first RRC message (e.g., RR (SetupRequest) for its connection establishment with NG-RAN via the PA relay function, using a default Layer-2 configuration on SL (PC5) [TS 38.836].

At step 279, the RRCSetup delivery to the target UE 201 may use the default configuration on SL (PC5). If the target UE 201 had not started in RRC_CONNECTED, it may do its own connection establishment upon reception of a message on the default L2 configuration on PC5.

At step 280, there may be a preparation of PC5 or Uu RLC channel for SRB1. The NG-RAN 207 (e.g., gNB or other base station) and PA UE relay function 205 may perform relaying channel setup procedure over Uu. The PA UE 202 or target UEs 201 may receive configuration from NG-RAN 207, and the PA (relay function 205) or target UE 201 may establish an RLC channel for relaying of SRB1 towards the Remote UE (e.g., target UE 201) over PC5. This step 280 may prepare the relaying channel for SRB1.

At step 281, a target UE SRB1 message (e.g., an RRCSetupComplete message) may be sent to the NG-RAN 207 via the PA (Relay function 205) using SRB1 relaying channel over PC5. Then the target UE 201 may be RRC connected over Uu.

At step 282, target UE 201 and NG-RAN 207 may establish security and the security messages (e.g., SecurityModeCommand) may be forwarded through the PA UE relay function 205.

At step 283, target UE 201 may send security mode complete message (e.g., SecurityModeComplete.) to the NG-RAN 207 via the PA UE relay function 205.

At step 284, the NG-RAN 207 may set up additional RLC channels between the NG-RAN 207 and PA UE relay function 205 for traffic relaying. According to the configuration from NG-RAN 207, the PA UE 202 or target UE 201 may set up additional RLC channels between the target UE 201 and PA UE relay function 205 for traffic relaying. The NG-RAN 207 may send an RRC Reconfiguration to the target UE 201 via the PA UE relay function 205, to set up the relaying SRB2/DRBs similar to procedures outlined in TR38.836.

At step 285, target UE 201 may send a message indicating completion (e.g., an RRCReconfigurationComplete) to the NG-RAN 207 via the PA UE relay function 205 as a response.

At step 286, there may be preparation of PC5 or Uu RLC channel for SRB2 via PA UE relay function 205. The NG-RAN 207 and PA UE relay function 205 may perform relaying channel setup procedure over Uu. The PA UEs 202 or target UEs 201 receive configuration from NG-RAN 207, and the PA relay function 205 or target UE 201 establish an RLC channel for relaying of SRB2 towards the target UE 201 over PC5. This step prepares the relaying channel for SRB2 to enable DL or UL information transfer.

At step 287, Selection of additional PA UE(s) 202 and reception of PRS with associated configuration in PC5-RRC Connected mode. Optionally, the selection of PA UE(s) 202 and reception of PRS may involve the Network, (NG-RAN), AMF, or LMF for partial and in-network cases.

The following procedures as depicted in FIG. 18 explores the subsequent procedural flow for SL positioning centric tasks. These SL positioning tasks include LPP related procedures, with Uu Interaction.

Note Steps 288-296 are LCS specific messages and procedures (e.g., LPP) and dependent upon the positioning mode and some possible pre-configuration. In this scenario, the master entity 203 is providing the SL positioning operations.

Step 288 is associated with LPP request capabilities. The PA UE 202 (master entity 203) via PA UE relay function 205 may send this NAS message (e.g., RRC DL Information Transfer) to the target UE 201. The LMF 206 may send this NAS message via the NG-RAN 207 via the master entity 203 or relay PA UE 202. The NAS message may be encapsulated in an RRC message that is sent over the SL via the PA UE relay function 205, and may forward the message to the target UE 201. NGAP DL NAS Transport: LPP PDU from the NG-RAN 207 to the LMF 206.

Step 289 is associated with LPP provide capabilities. The target UE 201 may send this NAS message (RRC UL Information Transfer) via PA UE relay function 205 to the PA UE 202 (master entity 205).

RRC UL Information Transfer-LPP PDU. The target UE 201 may send this NAS message to the LMF 206 via the PA UE 202 (Relay Function 205). The NAS message may be encapsulated in an RRC message that is sent over the SL from the target UE 201 via the PA UE 202 (UE-N/W Relay function 205), and the PA UE 202 (Relay Function 205) may forward the message to the LMF 206. NGAP UL NAS Transport-LPP PDU.

Step 290 is associated with LPP requesting assistance data. The target UE 201 may send this NAS message (RRC UL Information Transfer) via PA UE relay function 205 to the master entity 203, requesting assistance data for PA UE(s) 202. RRC UL Information Transfer-LPP PDU: the target UE 201 may send this NAS message to the LMF 206 via the PA UE 202 (Relay Function 205). The NAS message may be encapsulated in an RRC message that is sent over the SL from the target UE 201 via the PA UE 202 (UE-N/W Relay function 205), and the PA UE 202 (Relay Function 205) may forward the message to the LMF 206. NGAP UL NAS Transport-LPP PDU.

Step 291 may be associated with LPP providing assistance data. The PA UE 202 (master entity 203) via PA relay function may send this NAS message (RRC DL Information Transfer) to the target UE 201. RRC DL Information Transfer-LPP PDU: The LMF 206 may send this NAS message to the target UE 201 via the PA UE 202 (Relay Function 205). The NAS message is encapsulated in an RRC message that may send over the SL via the PA UE 202 (Relay function 205), and the PA UE 202 (Relay Function 205) may forward the message to the target UE 201. NGAP DL NAS Transport-LPP PDU.

Step 292 is associated with LPP requesting location information. The PA UE 202 (master entity 203) via PA UE relay function 205 may send this NAS message (RRC DL Information Transfer) to the target UE 201.

RRC DL Information Transfer-LPP PDU: The LMF 206 may send this NAS message to the target UE 201 via the PA UE 202 (Relay Function 205). The NAS message is encapsulated in an RRC message that is sent over the SL via the PA UE 202 (Relay function 205), and the PA UE 202 (Relay Function 205) forwards the message to the target UE 201. NGAP DL NAS Transport-LPP PDU.

Step 293 is associated with UE measurements and optionally measurement configuration of PA UE(s) 202 or NG-RAN 207. The target UE 201 may send an offset for timing measurements that include an adjustment for internal transmit and receive delays and not only absolute values.

Step 294 is associated with UE positioning calculation. The target UE 201 may perform positioning determination for UE-based mode of operation.

Step 295 is associated with LPP providing location information. The target UE 201 may send this NAS message (RRC UL Information Transfer) to the PA UE master entity 203 via PA UE relay function 205.

RRC UL Information Transfer-LPP PDU: The target UE 201 may send this NAS message to the LMF 206 via the PA UE 202 (Relay Function 205). The NAS message is encapsulated in an RRC message that is sent over the SL from the target UE 201 via the PA UE 202 (UE-N/W Relay function 205), and the PA UE 202 (Relay Function 205) forwards the message to the LMF 206. NGAP UL NAS Transport-LPP PDU.

Step 296 is associated with LMF 206 (e.g., location server) positioning calculation. Optionally, for UE-assisted SL Positioning operations whereby the network is performing the positioning calculation function of the target UE 201. In further embodiments, it may be envisioned that the master entity 203 may perform the positioning calculation function of the target UE 201.

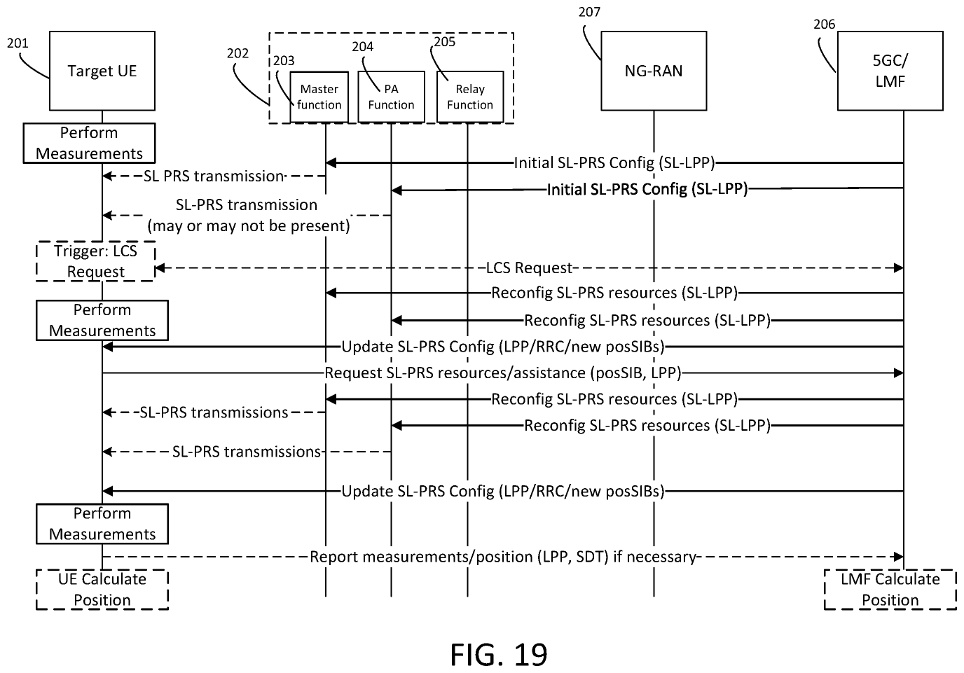

FIG. 19 illustrates an exemplary method flow for SL In-coverage and partial coverage scenarios for SL-PRS transmission requests. Similar to the previously described case where target UE 201 may request a PA UE 202 for SL-PRS, the target UE 201 may also request SL-PRS transmission reconfigurations for PA UEs 202 via a serving LMF 206 for in/partial coverage scenarios. The procedures depicted in FIG. 19 show the process for which a target UE 201 may request an update of the SL-PRS in these cases. In the example, an initial SL-PRS (pre) configuration is present for the target UE 201 or the PA UEs 202; periodically measurements may occur at the target UE 201. Subsequently, an LCS request may be triggered, and the target UE 201 may perform measurements or has an indication of the existing SL-PRS configuration for a PA UE 202. Based on this, the target UE 201 may request an update of the SL-PRS transmissions of one or more PA UEs 202. If the request is accepted, the PA UEs 202 may update the target UE 201 with the new SL-PRS configuration (via broadcast, dedicated SL signaling, etc.). Finally, the target UE 201 may perform measurements on the SL-PRS. The target UE may calculate its own position or send the measurements to the master entity for position determination. As previously described, similar procedures may be envisioned for target UE 201 or PA UE 202 configuration of SL-SRS.

In some examples, existing LCS protocols may be required to address SL only and SL+Uu positioning scenarios. Using TS 37.355 as a baseline, information elements for the LPP positioning operations previously defined may be updated as follows to account for SL and for PA UE(s) 202 that may serve some functions of a LMF 206 for configuration of target UEs 201. The following LPP message examples may be leveraged in some capacity for all potential coverage scenarios for target UE 201, e.g., in coverage, out of coverage, or partial coverage scenarios.

The RequestCapabilities message body (see Table 6) in a LPP message may be used by the location server or positioning assist UE to request the target device capability information for LPP and the supported individual positioning methods.

TABLE 6
-- ASN1START
RequestCapabilities ::= SEQUENCE {

| criticalExtensions | | CHOICE { |
|---|---|---|
| | c1 | CHOICE { |
| | requestCapabilities-r9 | RequestCapabilities-r9-IEs, |
| | spare3 NULL, spare2 NULL, spare1 NULL | |
| | }, | |
| | criticalExtensionsFuture | SEQUENCE { } |

}
}
RequestCapabilities-r9-IEs ::= SEQUENCE {

| | |
|---|---|
| commonIEsRequestCapabilities | CommonIEsRequestCapabilities |

OPTIONAL, -- Need ON

| | |
|---|---|
| a-gnss-RequestCapabilities | A-GNSS-RequestCapabilities |

OPTIONAL, -- Need ON

| | |
|---|---|
| otdoa-RequestCapabilities | OTDOA-RequestCapabilities |

OPTIONAL, -- Need ON

| | |
|---|---|
| ecid-RequestCapabilities | ECID-RequestCapabilities |

OPTIONAL, -- Need ON

| | |
|---|---|
| epdu-RequestCapabilities | EPDU-Sequence |

```
  OPTIONAL, -- Need ON
  ...,
```

| | | |
|---|---|---|
| [[ | sensor-RequestCapabilities-r13 | Sensor-RequestCapabilities-r13 |

OPTIONAL, -- Need ON

| | |
|---|---|
| tbs-RequestCapabilities-r13 | TBS-RequestCapabilities-r13 |

OPTIONAL, -- Need ON

| | |
|---|---|
| wlan-RequestCapabilities-r13 | WLAN-RequestCapabilities-r13 |

OPTIONAL, -- Need ON

| | |
|---|---|
| bt-RequestCapabilities-r13 | BT-RequestCapabilities-r13 |

```
  OPTIONAL -- Need ON
  ]],
```

| | | |
|---|---|---|
| [[ | nr-ECID-RequestCapabilities-r16 | NR-ECID-RequestCapabilities-r16 |

OPTIONAL, -- Need ON

nr-Multi-RTT-RequestCapabilities-r16

NR-Multi-RTT-RequestCapabilities-r16

OPTIONAL, -- Need ON

nr-DL-AoD-RequestCapabilities-r16

NR-DL-AoD-RequestCapabilities-r16

OPTIONAL, -- Need ON

nr-DL-TDOA-RequestCapabilities-r16

NR-DL-TDOA-RequestCapabilities-r16

OPTIONAL, -- Need ON

| | |
|---|---|
| nr-UL-RequestCapabilities-r16 | NR-UL-RequestCapabilities-r16 |

OPTIONAL, -- Need ON

| | |
|---|---|
| nr-SL-RequestCapabilities-r18 | NR-SL-RequestCapabilities-r18 |

```
  OPTIONAL -- Need ON
  ]]
}
-- ASN1STOP
```

The ProvideCapabilities message body (see Table 7) in a LPP message may indicate the LPP capabilities of the target device to the location server or positioning assist UE.

TABLE 7
-- ASN1START
ProvideCapabilities ::= SEQUENCE {

| criticalExtensions | | CHOICE { |
|---|---|---|
| | c1 | CHOICE { |
| | provideCapabilities-r9 | ProvideCapabilities-r9-IEs, |
| | spare3 NULL, spare2 NULL, spare1 NULL | |
| | }, | |
| | criticalExtensionsFuture | SEQUENCE { } |

}
}
ProvideCapabilities-r9-IEs ::= SEQUENCE {

| | |
|---|---|
| commonIEsProvideCapabilities | CommonIEsProvideCapabilities |

OPTIONAL,

| | |
|---|---|
| a-gnss-ProvideCapabilities | A-GNSS-ProvideCapabilities |

OPTIONAL,

| | |
|---|---|
| otdoa-ProvideCapabilities | OTDOA-ProvideCapabilities |

OPTIONAL,

| | |
|---|---|
| ecid-ProvideCapabilities | ECID-ProvideCapabilities |

OPTIONAL,

| | |
|---|---|
| epdu-ProvideCapabilities | EPDU-Sequence |

```
  OPTIONAL,
  ...,
```

| | | |
|---|---|---|
| [[ | sensor-ProvideCapabilities-r13 | Sensor-ProvideCapabilities-r13 |

OPTIONAL,

| | |
|---|---|
| tbs-ProvideCapabilities-r13 | TBS-ProvideCapabilities-r13 |

OPTIONAL,

| | |
|---|---|
| wlan-ProvideCapabilities-r13 | WLAN-ProvideCapabilities-r13 |

OPTIONAL,

| | |
|---|---|
| bt-ProvideCapabilities-r13 | BT-ProvideCapabilities-r13 |

```
  OPTIONAL
  ]],
```

| | | |
|---|---|---|
| [[ | nr-ECID-ProvideCapabilities-r16 | NR-ECID-ProvideCapabilities-r16 |

OPTIONAL,

nr-Multi-RTT-ProvideCapabilities-r16

NR-Multi-RTT-ProvideCapabilities-r16

OPTIONAL,

nr-DL-AoD-ProvideCapabilities-r16

NR-DL-AoD-ProvideCapabilities-r16

OPTIONAL,

nr-DL-TDOA-ProvideCapabilities-r16

NR-DL-TDOA-ProvideCapabilities-r16

OPTIONAL,

| | |
|---|---|
| nr-UL-ProvideCapabilities-r16 | NR-UL-ProvideCapabilities-r16 |

OPTIONAL,

| | |
|---|---|
| nr-SL-ProvideCapabilities-r18 | NR-SL-ProvideCapabilities-r18 |

```
  OPTIONAL
  ]]
}
-- ASN1STOP
```

The IE NR-SL-ProvideCapabilities-r18 defines the SL measurement capability (see Table 8 and Table 9). The target UE 201 may include this IE only if the UE supports SL Positioning for SL-TDOA, SL-RTT, or SL-AoD, etc. Otherwise, the UE does not include this IE.

TABLE 8
-- ASN1START
NR-SL-ProvideCapabilities-r18 ::= SEQUENCE {

| | |
|---|---|
| nr-SL-Mode-r18 | PositioningModes, |
| nr-SL-PRS-Capability-r18 | NR-SL-PRS-ResourcesCapability-r18, |
| nr-SL-AoD-MeasurementCapability-r18 | NR-SL-AoD- |

MeasurementCapability-r18,

| | |
|---|---|
| nr-SL-PRS-ProcessingCapability-r18 | NR-SL-PRS-ProcessingCapability-r18, |
| periodicalReporting-r18 | SL-PositioningMethods-r18, |
| maxSL-PRS-RSRP-MeasurementFR1-r18 | INTEGER (1..8), |
| maxSL-PRS-RSRP-MeasurementFR2-r18 | INTEGER (1..8), |
| maxSL-PRS-RSRP-MeasurementITS-r18 | INTEGER (1..8), |
| simul-NR-SL-AoD-SL-TDOA-r18 | ENUMERATED { supported} |

OPTIONAL,

| | |
|---|---|
| simul-NR-SL-AoD-Multi-RTT-r18 | ENUMERATED { supported} |

OPTIONAL,

| | |
|---|---|
| simul-NR-SL-GNSS | ENUMERATED { supported} |

OPTIONAL,

| | |
|---|---|
| nr-SL-GNSS | ENUMERATED { supported} |

```
  OPTIONAL,
  ...
}
-- ASN1STOP
```

TABLE 9
NR-SL-ProvideCapabilities field descriptions

PositioningModes
This field specifies the positioning mode(s) supported for SL, e.g., UE-Based, UE-
Assisted.
NR-SL-PRS-ResourcesCapability
This field specifies the resource and SL-PRS type capabilities for each SL positioning
scenario and method.
NR-SL-PRS-ProcessingCapability
This field specifies the processing capabilities for each SL positioning scenario and
method. This may include support and processing of absolute or relative position.
periodicalReporting
This field, if present, indicates that the target device supports periodicalReporting of SL-
RSTD measurements. If this field is absent, the location server may assume that the
target device does not support periodicalReporting
maxSL-PRS-RSRP-MeasurementFR1
Indicates the maximum number of SL-PRS RSRP measurements on different PRS
resources from the same PA UE supported by the UE on FR1.
maxSL-PRS-RSRP-MeasurementFR2
Indicates the maximum number of SL-PRS RSRP measurements on different PRS
resources from the same PA UE supported by the UE on FR2.
maxSL-PRS-RSRP-MeasurementITS
Indicates the maximum number of SL-PRS RSRP measurements on different PRS
resources from the same PA UE supported by the UE on ITS bands.
simul-NR-SL-AoD-SL-TDOA
Indicates whether the UE supports simultaneous processing for SL-AoD and SL-TDOA
measurements. The UE can include this field only if the UE supports SL-TDOA and SL-
AoD. Otherwise, the UE does not include this field;
simul-NR-SL-AoD-Multi-RTT
Indicates whether the UE supports simultaneous processing for SL-AoD and Multi-RTT
measurements. The UE can include this field only if the UE supports Multi-RTT, srs-
PosResources TS38.331 [35] and SL-AoD. Otherwise, the UE does not include this
field;
simul-NR-SL-GNSS
Indicates whether the UE supports simultaneous processing for SL PRS and GNSS.
nr-SL-GNSS
This field may also be used to indicate whether or not GNSS is available, degraded, or
supported by the target UE.

The RequestAssistanceData message body in a LPP message may be used by the target device to request assistance data from the location server or positioning assist UE. See Table 10.

TABLE 10
-- ASN1START
RequestAssistanceData ::= SEQUENCE {

| | |
|---|---|
| criticalExtensions | CHOICE { |
| c1 | CHOICE { |
| requestAssistanceData-r9 | RequestAssistanceData-r9-IEs, |

```
      spare3 NULL, spare2 NULL, spare1 NULL
    },
```

| | |
|---|---|
| criticalExtensionsFuture | SEQUENCE { } |

}
}
RequestAssistanceData-r9-IEs ::= SEQUENCE {

| | |
|---|---|
| commonIEsRequestAssistanceData | CommonIEsRequestAssistanceData |

OPTIONAL,

| | |
|---|---|
| a-gnss-RequestAssistanceData | A-GNSS-RequestAssistanceData |

OPTIONAL,

| | |
|---|---|
| otdoa-RequestAssistanceData | OTDOA-RequestAssistanceData |

OPTIONAL,

| | |
|---|---|
| epdu-RequestAssistanceData | EPDU-Sequence |

```
  OPTIONAL,
  ...,
  [[ sensor-RequestAssistanceData-r14
```

Sensor-RequestAssistanceData-r14

```
  OPTIONAL,
    tbs-RequestAssistanceData-r14 TBS-RequestAssistanceData-r14
  OPTIONAL,
```

| | |
|---|---|
| wlan-RequestAssistanceData-r14 | WLAN-RequestAssistanceData-r14 |

```
  OPTIONAL
  ]],
```

| | |
|---|---|
| [[ nr-Multi-RTT-RequestAssistanceData-r16 | NR-Multi-RTT- |

RequestAssistanceData-r16 OPTIONAL,

| | |
|---|---|
| nr-DL-AoD-RequestAssistanceData-r16 | NR-DL-AoD- |
| RequestAssistanceData-r16 | OPTIONAL, |
| nr-DL-TDOA-RequestAssistanceData-r16 | NR-DL-TDOA- |

RequestAssistanceData-r16 OPTIONAL,

| | |
|---|---|
| nr-SL-RequestAssistanceData-r18 | NR-SL-RequestAssistanceData-r18 |

```
  OPTIONAL
  ]]
}
-- ASN1STOP
```

The Provide Assistance Data message body in a LPP message may be used by the location server or positioning assist UE to provide assistance data to the target device in response to a request from the target device or in an unsolicited manner. See Table 11 and Table 12.

TABLE 11
-- ASN1START
ProvideAssistanceData ::= SEQUENCE {

| | |
|---|---|
| criticalExtensions | CHOICE { |
| c1 | CHOICE { |
| provideAssistanceData-r9 | ProvideAssistanceData-r9-IEs, |

```
      spare3 NULL, spare2 NULL, spare1 NULL
    },
```

| | |
|---|---|
| criticalExtensionsFuture | SEQUENCE { } |

}
}
ProvideAssistanceData-r9-IEs ::= SEQUENCE {

| | |
|---|---|
| commonIEsProvideAssistanceData | CommonIEsProvideAssistanceData |

OPTIONAL, -- Need ON

| | |
|---|---|
| a-gnss-ProvideAssistanceData | A-GNSS-ProvideAssistanceData |

OPTIONAL, -- Need ON

| | |
|---|---|
| otdoa-ProvideAssistanceData | OTDOA-ProvideAssistanceData |

OPTIONAL, -- Need ON

| | |
|---|---|
| epdu-Provide-Assistance-Data | EPDU-Sequence |

```
  OPTIONAL, -- Need ON
  ...,
  [[
```

| | |
|---|---|
| sensor-ProvideAssistanceData-r14 | Sensor-ProvideAssistanceData-r14 |

OPTIONAL, -- Need ON

| | |
|---|---|
| tbs-ProvideAssistanceData-r14 | TBS-ProvideAssistanceData-r14 |

OPTIONAL, -- Need ON

| | |
|---|---|
| wlan-ProvideAssistanceData-r14 | WLAN-ProvideAssistanceData-r14 |

```
  OPTIONAL -- Need ON
  ]],
  [[ nr-Multi-RTT-ProvideAssistanceData-r16
```

NR-Multi-RTT-ProvideAssistanceData-r16

```
  OPTIONAL, -- Need ON
    nr-DL-AoD-ProvideAssistanceData-r16
```

NR-DL-AoD-ProvideAssistanceData-r16

```
  OPTIONAL, -- Need ON
    nr-DL-TDOA-ProvideAssistanceData-r16
```

NR-DL-TDOA-ProvideAssistanceData-r16

OPTIONAL, -- Need ON

| | |
|---|---|
| sl-ProvideAssistanceData-r18 | NR-SL-ProvideAssistanceData-r18 |

```
  OPTIONAL -- Need ON
  ]]
}
-- ASN1STOP
```

TABLE 12
ProvideAssistanceData field descriptions

commonIEsProvideAssistanceData
This IE is provided for future extensibility and should not be included in this version of the
protocol.

Further assistance data specific for SL-PRS, TS 37.355 section 6.4.3 for DL-PRS is used as a baseline to enhance SL-PRS discovery, selection and hear-ability for the target UE 201. This would be configured for a PA UE 202 or a set of PA UEs 202, and analogous to a TRP(s) transmitting DL-PRS. NR-SL-PRS-AssistanceData is the response message to NR-SL-PRS-RequestAssistanceData. The NR-SL-PRS-RequestAssistanceData may include specific IEs specific to, e.g., absolute positioning, relative positioning, UE-based, assisted, scenario, etc.

The IE NR-SL-PRS-AssistanceData may be sent by the master (controlling) entity 203 (e.g., location server 206 or PA UE 202) to provide SL-PRS assistance data, which may include the geographical coordinates of the PA UE 202, SL-PRS resource information, etc. See Table 13 and Table 14.

TABLE 13
-- ASN1START
NR-SL-PRS-AssistanceData-r18 ::= SEQUENCE {

| | |
|---|---|
| nr-SL-PRS-ReferenceInfo-r18 | SL-PRS-ID-Info-r18, |

nr-SL-PRS-AssistanceDataList-r18 SEQUENCE (SIZE (1..nrMaxFreqLayers-r18))
OF

NR-SL-PRS-

AssistanceDataPerFreq-r18,

| | |
|---|---|
| nr-SSB-Config-r18 | SEQUENCE (SIZE (1..nrMaxPAUEs-r18)) OF |
| | NR-SSB-Config-r18 |

```
  OPTIONAL, -- Need ON
  ...
}
NR-SL-PRS-AssistanceDataPerFreq-r18 ::= SEQUENCE {
  nr-SL-PRS-PositioningFrequencyLayer-r18
```

NR-SL-PRS-PositioningFrequencyLayer-r18,

nr-SL-PRS-AssistanceDataPerFreq-r18 SEQUENCE (SIZE
(1..nrMaxPAUEsPerFreq-r18)) OF

NR-SL-PRS-

AssistanceDataPerPAUE-r18,
...
}
NR-SL-PRS-AssistanceDataPerPAUE-r18 ::= SEQUENCE {

| sl-PRS-ID-r18 | INTEGER (0..255), | |
|---|---|---|
| nr-SL-PRS-location-r18 | NR-SL-PRS-location-r18 | OPTIONAL, |

| | |
|---|---|
| nr-SL-PRS-SFN0-Offset-r18 | NR-SL-PRS-SFN0-Offset-r18, |
| nr-SL-PRS-ExpectedRSTD-r18 | INTEGER (−3841..3841), |

nr-SL-PRS-ExpectedRSTD-Uncertainty-r18

| | |
|---|---|
| | INTEGER (0..246), |
| nr-SL-PRS-Info-r18 | NR-SL-PRS-Info-r18, |

...,

| | |
|---|---|
| nr-SL-PRS-ConfigRqst-r17 | NR-SL-PRS-ConfigRqst-r17 |

}
NR-SL-PRS-ConfigRqst-r17 ::= SEQUENCE {

| | | |
|---|---|---|
| sl-PRS-ConfigRqstAllowed | BOOLEAN | OPTIONAL, |
| sl-PRS-measPriorityOrPrioritySet | INTEGER (0..255) | OPTIONAL, |
| sl-PRS-ValidityTime | INTEGER (0..2176) | OPTIONAL, |

-- Alternatively UTC start/stop time

| | | |
|---|---|---|
| sl-PRS-prohibitTimer | INTEGER (0..2176) | OPTIONAL |
| sl-PRS-KPI-required | SL-PRS-KPI-required | OPTIONAL, |
| sl-PRS-servicetype | INTEGER (0..15) | OPTIONAL, |

...
}
SL-PRS-KPI-required-r17 ::= SEQUENCE {

| | |
|---|---|
| sl-PRS-accuracy | SL-PRS-accuracy |

OPTIONAL, -- threshold

| | | |
|---|---|---|
| sl-PRS-latency | SL-PRS-latency | OPTIONAL, |

-- threshold

| | | |
|---|---|---|
| sl-PRS-IC-interference | SL-PRS-IC-interference | OPTIONAL, |

-- threshold
...
}
NR-SL-PRS-PositioningFrequencyLayer-r18 ::= SEQUENCE {

| | |
|---|---|
| sl-PRS-SubcarrierSpacing-r18 | ENUMERATED {kHz15, kHz30, kHz60, kHz120, |

...},

| | |
|---|---|
| sl-PRS-ResourceBandwidth-r18 | INTEGER (1..63), |
| sl-PRS-StartPRB-r18 | INTEGER (0..2176), |
| sl-PRS-PointA-r18 | ARFCN-ValueNR-r15, |
| sl-PRS-CombSizeN-r18 | ENUMERATED {n2, n4, n6, n12, ...}, |
| sl-PRS-CyclicPrefix-r18 | ENUMERATED {normal, extended, ...}, |

...
}
NR-SL-PRS-SFN0-Offset-r18 ::= SEQUENCE {

| | |
|---|---|
| sfn-Offset-r18 | INTEGER (0..1023), |
| integerSubframeOffset-r18 | INTEGER (0..9), |

...}
-- ASN1STOP

TABLE 14
NR-SL-PRS-AssistanceData field descriptions

nr-SL-PRS-ReferenceInfo
This field specifies the IDs of the assistance data reference PA UE.
nr-SL-PRS-AssistanceDataList
This field specifies the SL-PRS resources for each frequency layer.
nr-SSB-Config
This field specifies the SSB configuration of the PA UEs.
nr-SL-PRS-PositioningFrequencyLayer
This field specifies the Positioning Frequency Layer for the nr-SL-PRS-
AssistanceDataPerFreq field.
nr-SL-PRS-AssistanceDataPerFreq
This field specifies the SL-PRS Resources for the PA UEs within the Positioning
Frequency Layer.
sl-PRS-ID
This field is used along with a SL-PRS Resource Set ID and a SL-PRS Resource ID to
uniquely identify a SL-PRS Resource, and is associated with a single PA UE.
nr-SL-PRS-location
This field is used to aid absolute positioning with the geographic coordinates of the PA
UE. Location may also include a velocity vector for the PA UE at a given time.
nr-ARFCN
This field specifies the NR-ARFCN of the PA UE.
nr-SL-PRS-SFN0-Offset
This field specifies the time offset of the SFN#0 slot#0 for the given PA UE with respect
to SFN#0 slot#0 of the assistance data reference PA UE and comprises the following
subfields:

| | |
|---|---|
| - | sfn-Offset specifies the SFN offset at the PA UE antenna location between the |
| | assistance data reference PA UE and this neighbour PA UE. |
| | The offset corresponds to the number of full radio frames counted from the |
| | beginning of a radio frame #0 of the assistance data reference PA UE to the |
| | beginning of the closest subsequent radio frame #0 of this neighbour PA UE. |
| - | integerSubframeOffset specifies the frame boundary offset at the PA UE antenna |
| | location between the assistance data reference PA UE and this neighbour PA UE |
| | counted in full subframes. |
| | The offset is counted from the beginning of a subframe #0 of the assistance data |
| | reference PA UE to the beginning of the closest subsequent subframe #0 of this |
| | neighbour PA UE, rounded down to multiples of subframes. |

nr-SL-PRS-ExpectedRSTD
This field indicates the RSTD value that the target device is expected to measure between
this PA UE and the assistance data reference PA UE. The nr-SL-PRS-ExpectedRSTD field
takes into account the expected propagation time difference as well as transmit time
difference of PRS positioning occasions between the two PA UEs. The resolution is 4×Tₛ,
with Tₛ=1/(15000*2048) seconds.
nr-SL-PRS-ExpectedRSTD-Uncertainty
This field indicates the uncertainty in nr-SL-PRS-ExpectedRSTD value. The uncertainty is
related to the location server's a-priori estimate of the target device location. The nr-SL-
PRS-ExpectedRSTD and nr-SL-PRS-ExpectedRSTD-Uncertainty together define the
search window for the target device.
The resolution R is

| | |
|---|---|
| - | Tₛ if all PRS resources are in frequency range 2, |
| - | 4×Tₛ otherwise, |

with Tₛ=1/(15000*2048) seconds.
The target device may assume that the beginning of the subframe for the PRS of this PA
UE is received within the search window of size

| | |
|---|---|
| - | [-nr-SL-PRS-ExpectedRSTD-Uncertainty×R ; nr-SL-PRS-ExpectedRSTD- |
| | Uncertainty×R] centered at T_{REF}+1 millisecond×N+nr-SL-PRS- |
| | ExpectedRSTD×4×Tₛ, |

where T_{REF} is the reception time of the beginning of the subframe for the PRS of the
assistance data reference PA UE at the target device antenna connector, and N can be
calculated based on

| | |
|---|---|
| - | nr-SL-PRS-SFN0-Offset |
| - | sl-PRS-Periodicity-and-ResourceSetSlotOffset |
| - | sl-PRS-ResourceSlotOffset. |

nr-SL-PRS-Info
This field specifies the PRS configuration of the PA UE.
sl-PRS-SubcarrierSpacing
This field specifies the subcarrier spacing of the SL-PRS Resource. 15, 30, 60 kHz for
FR1; 60, 120 kHz for FR2.
sl-PRS-ResourceBandwidth
This field specifies the number of PRBs allocated for the SL-PRS Resource (allocated
SL-PRS bandwidth) in multiples of 4 PRBs. SL-PRS Resources of the SL-PRS Resource
Set have the same bandwidth. SL-PRS Resource Sets belonging to the same Positioning
Frequency Layer have the same value of SL-PRS Bandwidth and Start PRB.
Integer value 1 corresponds to 24 PRBs, value 2 corresponds to 28 PRBs, value 3
corresponds to 32 PRBs and so on.
sl-PRS-StartPRB
This field specifies the start PRB index defined as offset with respect to reference SL-
PRS Point A for the Positioning Frequency Layer.
sl-PRS-PointA
This field specifies the absolute frequency of the reference resource block for the SL-
PRS. Its lowest subcarrier is also known as SL-PRS Point A. A single SL-PRS Point A
for SL-PRS Resource allocation is provided per Positioning Frequency Layer. SL-PRS
Resources belonging to the same SL-PRS Resource Set have the same SL-PRS Point A.
sl-PRS-CombSizeN
This field specifies the Resource Element spacing in each symbol of the SL-PRS
Resource. SL-PRS Resource Sets belonging to the same Positioning Frequency Layer
have the same value of comb size N.
nr-SL-PRS-ConfigRqst
This field specifies the PRS Configuration Request fields associated with the SL-PRS
resources of the PA UE.
sl-PRS-ConfigRqstAllowed
This field specifies whether or not the SL-PRS Resource associated with the SL-PRS
resource identifier is allowed requests for reconfiguration.
sl-PRS-measPriorityOrPrioritySet
This field specifies measurement priority of the SL-PRS Resource or Resource Set.
sl-PRS-ValidityTimer
This field specifies the Validity time (or timer) of the configuration request allowed IE
associated with the SL-PRS Resource.
sl-PRS-prohibitTimer
This field specifies a timer associated with subsequent SL-PRS configuration requests to
limit the frequency of requests associated with the SL-PRS Resource.
sl-PRS-KPI-required
This field specifies the positioning KPIs associated with the request for SL-PRS
reconfiguration of the SL-PRS Resource.
sl-PRS-servicetype
This field specifies the system type associated with the reconfiguration request of the SL-
PRS Resource. For example, a Value of 0 is associated with an emergency location
request.
sl-PRS-accuracy
This field specifies the accuracy requirements associated with the reconfiguration request
of the SL-PRS Resource.
sl-PRS-latency
This field specifies the latency requirements associated with the reconfiguration request
of the SL-PRS Resource.
sl-PRS-IC-interference
This field specifies the inter-cell interference requirements associated with the
reconfiguration request of the SL-PRS Resource.

Alternatively, these IEs may be broadcast from the PA UEs 202 or NG-RAN 207 within posSIBs. Furthermore, the target UE 201 requests of assistance data for SL-PRS (re) configuration, may be included in the procedure flows as previously discussed without Uu involvement. Note that in the examples, some of the ProvideAssistanceInformation is shown as part of the TDOA method, but similar IEs may be envisioned for other positioning methods that may leverage SL-PRS(s), such as RTT or AoA/AOD techniques.

The RequestLocationInformation message body in a LPP message may be used by the location server or positioning assist UE to request positioning measurements or a position estimate from the target device. See Table 15 and Table 16.

TABLE 15
-- ASN1START
RequestLocationInformation ::= SEQUENCE {

| | |
|---|---|
| criticalExtensions | CHOICE { |
| c1 | CHOICE { |

```
      requestLocationInformation-r9 RequestLocationInformation-r9-IEs,
      spare3 NULL, spare2 NULL, spare1 NULL
    },
```

| | |
|---|---|
| criticalExtensionsFuture | SEQUENCE |

```
  }
}
RequestLocationInformation-r9-IEs ::= SEQUENCE {
  commonIEsRequestLocationInformation
```

CommonIEsRequestLocationInformation

OPTIONAL, -- Need ON

| | |
|---|---|
| a-gnss-RequestLocationInformation | A-GNSS-RequestLocationInformation |

OPTIONAL, -- Need ON

| | |
|---|---|
| otdoa-RequestLocationInformation | OTDOA-RequestLocationInformation |

OPTIONAL, -- Need ON

| | |
|---|---|
| ecid-RequestLocationInformation | ECID-RequestLocationInformation |

OPTIONAL, -- Need ON

| | |
|---|---|
| epdu-RequestLocationInformation | EPDU-Sequence |

```
  OPTIONAL, -- Need ON
  ...,
  [[
  sensor-RequestLocationInformation-r13
```

Sensor-RequestLocationInformation-r13

OPTIONAL, -- Need ON

| | |
|---|---|
| tbs-RequestLocationInformation-r13 | TBS-RequestLocationInformation-r13 |

OPTIONAL, -- Need ON

| | |
|---|---|
| wlan-RequestLocationInformation-r13 | WLAN-RequestLocationInformation-r13 |

```
  OPTIONAL, -- Need ON
  bt-RequestLocationInformation-r13 BT-RequestLocationInformation-r13
  OPTIONAL -- Need ON
  ]],
  [[ nr-ECID-RequestLocationInformation-r16
```

NR-ECID-RequestLocationInformation-r16

```
  OPTIONAL, -- Need ON
    nr-Multi-RTT-RequestLocationInformation-r16
```

NR-Multi-RTT-RequestLocationInformation-

```
r16
  OPTIONAL, -- Need ON
    nr-DL-AoD-RequestLocationInformation-r16
```

NR-DL-AoD-RequestLocationInformation-r16

```
  OPTIONAL, -- Need ON
    nr-DL-TDOA-RequestLocationInformation-r16
```

NR-DL-TDOA-RequestLocationInformation-

r16
OPTIONAL, -- Need ON

NR-SL-RequestLocationInformation-r18

```
  OPTIONAL -- Need ON
  ]]
}
-- ASN1STOP
```

TABLE 16
RequestLocationInformation field descriptions

commonIEsRequestLocationInformation
This field specifies the location information type requested by the location server and
optionally other configuration information associated with the requested location
information. This field may be included in this version of the protocol.

The ProvidelocationInformation message body in a LPP message may be used by the target device to provide positioning measurements or position estimates to the location server or positioning assist UE. See Table 17.

TABLE 17
-- ASN1START
ProvideLocationInformation ::= SEQUENCE {

| | |
|---|---|
| criticalExtensions | CHOICE { |
| c1 | CHOICE { |

```
      provideLocationInformation-r9 ProvideLocationInformation-r9-IEs,
      spare3 NULL, spare2 NULL, spare1 NULL
    },
```

| | |
|---|---|
| criticalExtensionsFuture | SEQUENCE |

```
  }
}
ProvideLocationInformation-r9-IEs ::= SEQUENCE {
  commonIEsProvideLocationInformation
```

CommonIEsProvideLocationInformation

```
  OPTIONAL,
  a-gnss-ProvideLocationInformation A-GNSS-ProvideLocationInformation
  OPTIONAL,
```

| | |
|---|---|
| otdoa-ProvideLocationInformation | OTDOA-ProvideLocationInformation |

OPTIONAL,

| | |
|---|---|
| ecid-ProvideLocationInformation | ECID-ProvideLocationInformation |

OPTIONAL,

| | |
|---|---|
| epdu-ProvideLocationInformation | EPDU-Sequence |

```
  OPTIONAL,
  ...,
  [[
  sensor-ProvideLocationInformation-r13
```

Sensor-ProvideLocationInformation-r13

OPTIONAL,

| | |
|---|---|
| tbs-ProvideLocationInformation-r13 | TBS-ProvideLocationInformation-r13 |

OPTIONAL,

| | |
|---|---|
| wlan-ProvideLocationInformation-r13 | WLAN-ProvideLocationInformation-r13 |

```
  OPTIONAL,
  bt-ProvideLocationInformation-r13 BT-ProvideLocationInformation-r13
  OPTIONAL
  ]],
  [[ nr-ECID-ProvideLocationInformation-r16
```

NR-ECID-ProvideLocationInformation-r16

```
  OPTIONAL,
    nr-Multi-RTT-ProvideLocationInformation-r16
```

NR-Multi-RTT-ProvideLocationInformation-r16

```
  OPTIONAL,
    nr-DL-AoD-ProvideLocationInformation-r16
```

NR-DL-AoD-ProvideLocationInformation-r16

```
  OPTIONAL,
    nr-DL-TDOA-ProvideLocationInformation-r16
```

NR-DL-TDOA-ProvideLocationInformation-r16

```
  OPTIONAL,
    nr-SL-ProvideLocationInformation-r18
```

NR-SL-ProvideLocationInformation-r18

```
  OPTIONAL
  ]]
}
-- ASN1STOP
```

Further examples also may require the UE to assist the network in the position determination function. In these In- and partial-coverage scenarios (or out-of-coverage and a PA UE 202 is performing final positioning determination), SL measurements will need to be sent to the network over the Uu (for in-coverage) or over the SL (for partial coverage). The following examples show possible measurements reports.

The IE NR-SL-TDOA-SignalMeasurementInformation may be used by the target device to provide NR SL-TDOA measurements to the location server or to a master entity 203. See Table 18 and Table 19.

TABLE 18
-- ASN1START
NR-SL-TDOA-SignalMeasurementInformation-r18 ::= SEQUENCE {

| | |
|---|---|
| sl-PRS-ReferenceInfo-r18 | SL-PRS-ID-Info-r18, |
| nr-SL-TDOA-MeasList-r18 | NR-SL-TDOA-MeasList-r18, |

...
}
NR-SL-TDOA-MeasList-r18 ::= SEQUENCE (SIZE(1..nrMaxPAUEs-r18)) OF NR-
SL-TDOA-MeasElement-r18
NR-SL-TDOA-MeasElement-r18 ::= SEQUENCE

| | |
|---|---|
| sl-PRS-ID-r18 | INTEGER (0..255), |
| nr-ARFCN-r18 | ARFCN-ValueNR-r15 |

OPTIONAL,

| | |
|---|---|
| nr-SL-PRS-ResourceID-r18 | NR-SL-PRS-ResourceID-r18 |

OPTIONAL,

| | |
|---|---|
| nr-SL-PRS-ResourceSetID-r18 | NR-SL-PRS-ResourceSetID-r18 |

OPTIONAL,

| | |
|---|---|
| nr-TimeStamp-r18 | NR-TimeStamp-r18, |
| nr-RSTD-r18 | CHOICE { |
| k0-r18 | INTEGER (0..1970049), |
| k1-r18 | INTEGER (0..985025), |
| k2-r18 | INTEGER (0..492513), |
| k3-r18 | INTEGER (0..246257), |
| k4-r18 | INTEGER (0..123129), |
| k5-r18 | INTEGER (0..61565), |

```
      ...
  },
```

| | |
|---|---|
| nr-AdditionalPathList-r18 | NR-AdditionalPathList-r18 |

OPTIONAL,

| | |
|---|---|
| nr-TimingQuality-r18 | NR-TimingQuality-r18, |
| nr-SL-PRS-RSRP-Result-r18 | INTEGER (0..126) |

```
  OPTIONAL,
  nr-SL-TDOA-AdditionalMeasurements-r18
```

NR-SL-TDOA-AdditionalMeasurements-r18

```
    OPTIONAL,
  ...
}
NR-SL-TDOA-AdditionalMeasurements-r18 ::= SEQUENCE (SIZE (1..3)) OF
```

NR-SL-TDOA-

AdditionalMeasurementElement-r18
NR-SL-TDOA-AdditionalMeasurementElement-r18 ::= SEQUENCE {

| | |
|---|---|
| nr-SL-PRS-ResourceID-r18 | NR-SL-PRS-ResourceID-r18 |

OPTIONAL,

| | |
|---|---|
| nr-SL-PRS-ResourceSetID-r18 | NR-SL-PRS-ResourceSetID-r18 |

OPTIONAL,

| | |
|---|---|
| nr-TimeStamp-r18 | NR-TimeStamp-r18, |
| nr-RSTD-ResultDiff-r18 | CHOICE { |
| k0-r18 | INTEGER (0..8191), |
| k1-r18 | INTEGER (0..4095), |
| k2-r18 | INTEGER (0..2047), |
| k3-r18 | INTEGER (0..1023), |
| k4-r18 | INTEGER (0..511), |
| k5-r18 | INTEGER (0..255), |

```
      ...
  },
```

| | |
|---|---|
| nr-TimingQuality-r18 | NR-TimingQuality-r18, |
| nr-SL-PRS-RSRP-ResultDiff-r18 | INTEGER (0..61) |

OPTIONAL,

| | |
|---|---|
| nr-AdditionalPathList-r18 | NR-AdditionalPathList-r18 |

OPTIONAL,
...
}
-- ASN1STOP

TABLE 19
NR-SL-TDOA-SignalMeasurementInformation field descriptions

SL-PRS-ID
This field is used along with a SL-PRS Resource Set ID and a SL-PRS Resources ID to
uniquely identify a SL-PRS Resource. This ID can be associated with multiple SL-PRS
Resource Sets associated with a single PA UE.
Each PA UE should only be associated with one such ID. This also may determine the
type of PRS used in the measurements, or alternatively an explicit PRS IE may determine
the PRS used (DMRS, SL_CSI-RS, SL-SSB, etc.).
nr-ARFCN
This field specifies the NR-ARFCN of the SL PA UE.
nr-TimeStamp
This field specifies the time instance at which the TOA and SL PRS-RSRP (if included)
measurement is performed. Note, the TOA measurement refers to the TOA of this SL PA,
as applicable, used to determine the nr-RSTD or nr-RSTD-ResultDiff.
nr-RSTD
This field specifies the relative timing difference between this a PA UE and the SL-PRS
reference PA UE.
nr-AdditionalPathList
This field specifies one or more additional detected path timing values for the PA UE,
TRP or resource, relative to the path timing used for determining the nr-RSTD value. If
this field was requested but is not included, it means the UE did not detect any additional
path timing values.
nr-TimingQuality
This field specifies the target device's best estimate of the quality of the TOA
measurement. Note, the TOA measurement refers to the TOA of this PA UE, as
applicable, used to determine the nr-RSTD or nr-RSTD-ResultDiff.
nr-SL-PRS-RSRP-Result
This field specifies the NR SL-PRS reference signal received power (SL PRS-RSRP)
measurement.
SL-PRS-ID
This field is used along with a SL-PRS Resource Set ID and a SL-PRS Resources ID to
uniquely identify a SL-PRS Resource. This ID can be associated with multiple SL-PRS
Resource Sets associated with a single PA UE.
Each PA UE should only be associated with one such ID. This also may determine the
type of PRS used in the measurements, or alternatively an explicit PRS IE may determine
the PRS used (DMRS, SL_CSI-RS, SL-SSB, etc.).
nr-ARFCN
This field specifies the NR-ARFCN of the SL PA UE.
nr-TimeStamp
This field specifies the time instance at which the TOA and SL PRS-RSRP (if included)
measurement is performed. Note, the TOA measurement refers to the TOA of this SL PA,
as applicable, used to determine the nr-RSTD or nr-RSTD-ResultDiff.
nr-RSTD
This field specifies the relative timing difference between this a PA UE and the SL-PRS
reference PA UE.
nr-AdditionalPathList
This field specifies one or more additional detected path timing values for the PA UE,
TRP or resource, relative to the path timing used for determining the nr-RSTD value. If
this field was requested but is not included, it means the UE did not detect any additional
path timing values.
nr-TimingQuality
This field specifies the target device's best estimate of the quality of the TOA
measurement. Note, the TOA measurement refers to the TOA of this PA UE, as
applicable, used to determine the nr-RSTD or nr-RSTD-ResultDiff.
nr-RSTD-ResultDiff
This field provides the additional SL RSTD measurement result relative to nr-RSTD. The
RSTD value of this measurement is obtained by adding the value of this field to the value
of the nr-RSTD field.
SL-PRS-ID
This field is used along with a SL-PRS Resource Set ID and a SL-PRS Resources ID to
uniquely identify a SL-PRS Resource. This ID can be associated with multiple SL-PRS
Resource Sets associated with a single PA UE.
Each PA UE should only be associated with one such ID. This also may determine the
type of PRS used in the measurements, or alternatively an explicit PRS IE may determine
the PRS used (DMRS, SL_CSI-RS, SL-SSB, etc.).
nr-ARFCN
This field specifies the NR-ARFCN of the SL PA UE.
nr-TimeStamp
This field specifies the time instance at which the TOA and SL PRS-RSRP (if included)
measurement is performed. Note, the TOA measurement refers to the TOA of this SL PA,
as applicable, used to determine the nr-RSTD or nr-RSTD-ResultDiff.
nr-RSTD
This field specifies the relative timing difference between this a PA UE and the SL-PRS
reference PA UE.
nr-AdditionalPathList
This field specifies one or more additional detected path timing values for the PA UE,
TRP or resource, relative to the path timing used for determining the nr-RSTD value. If
this field was requested but is not included, it means the UE did not detect any additional
path timing values.
nr-TimingQuality
This field specifies the target device's best estimate of the quality of the TOA
measurement. Note, the TOA measurement refers to the TOA of this PA UE, as
applicable, used to determine the nr-RSTD or nr-RSTD-ResultDiff.
nr-SL-PRS-RSRP-ResultDiff
This field provides the additional SL-PRS RSRP measurement result relative to nr-SL-
PRS-RSRP-Result. The SL-PRS RSRP value of this measurement is obtained by adding
the value of this field to the value of the nr-SL-PRS-RSRP-Result field.

In addition to, or in lieu of, the target UE 201 may utilize additional measurements, such as, GNSS, LiDAR or Radar, or other signals of opportunity to determine its location. These measurements may also be sent in LPP-ProvideLocationInformation messages.

An alternative to SL-LPP-based approaches for instigating positioning signals as previously discussed may be via MAC CE/SDU. Based on TS 38.321 section 6.2.4, an example value for SL-SRS and SL-PRS resource activation or deactivation is given. Note that the contents of the MAC CE may contain an identifier to allow the UE to determine which of the SL-PRS resource sets to activate (or de-activate) for partial and in-coverage scenarios. From TS 38.321: LCID: The Logical Channel ID field identifies the logical channel instance of the corresponding MAC SDU or the type of the corresponding MAC CE within the scope of one Source Layer-2 ID and Destination Layer-2 ID pair or padding as described in Tables 6.2.4-1 for SL-SCH. There is one LCID field per MAC subheader except for SL-SCH subheader. The size of the LCID field is 6 bits. These indices may also be extended to additional SL positioning procedures that are supported by SL-LPP.

TS 38.821 Table 6.2.4-1 Values of LCID for SL-SCH

| Index | LCID values |
|---|---|
| 0 | SCCH carrying PC5-S messages that are not protected |
| 1 | SCCH carrying PC5-S messages “Direct Security Mode |
| | Command” and “Direct Security Mode Complete” |
| 2 | SCCH carrying other PC5-S messages that are protected |
| 3 | SCCH carrying PC5-RRC messages |
| 4-19 | Identity of the logical channel |
| 20-59 | Reserved |
| 60 | SL SRS resource set activation/deactivation |
| 61 | SL PRS resource set activation/deactivation |
| 62 | Sidelink CSI Reporting |
| 63 | Padding |

This activation or deactivation of SL SRS/PRS resources may also be triggered via RRC signaling.

In another scenario, the master entity 203 (e.g., network such as an LMF/Location Server 206 or PA UE 202), requests specific measurements with respect to SL positioning and ranging in addition to or in lieu of Uu positioning measurements or position determination. The following SL position request, using TS 37.355 section 6.5.10.5 as a baseline for DL-PRS techniques, are proposed for SL positioning and ranging.

The IE NR-SL-TDOA-RequestLocationInformation may be used by the master (controlling) entity 203 (e.g., location server 206 or PA UE 202) to request NR SL-TDOA location measurements from a target device. See Table 20 and Table 21.

TABLE 20
-- ASN1START
::= SEQUENCE {

| | |
|---|---|
| nr-SL-PRS-RstdMeasurementInfoRequest-r18 | ENUMERATED { true } |

OPTIONAL,-- Need ON

| | |
|---|---|
| nr-RequestedMeasurements-r18 | BIT STRING { prsrsrpReq (0) } |

(SIZE(1..8)),

| | |
|---|---|
| nr-AssistanceAvailability-r18 | BOOLEAN, |
| nr-SL-TDOA-ReportConfig-r18 | NR-SL-TDOA-ReportConfig- |

r18 OPTIONAL, -- Need ON

| | |
|---|---|
| additionalPaths-r18 | ENUMERATED { requested } |

```
  OPTIONAL, -- Need ON
  ...,
```

| | |
|---|---|
| nr-reconfigAvailability-r17 | BOOLEAN |

}
NR-SL-TDOA-ReportConfig-r18 ::= SEQUENCE {

| | |
|---|---|
| maxSL-PRS-RSTD-MeasurementsPerPAUE-r18 | INTEGER (1..4) |

OPTIONAL, -- Need ON

| | |
|---|---|
| timingReportingGranularityFactor-r18 | INTEGER (0..5) |

OPTIONAL, -- Need ON

| | |
|---|---|
| validityTimingReporting-r18 | Validity TimingReporting |

```
    OPTIONAL,
  ...
}
-- ASN1STOP
```

TABLE 21
NR-SL-TDOA-RequestLocationInformation field descriptions

nr-AssistanceAvailability
This field indicates whether the target device requests additional SL-PRS assistance data
from the master entity (server or PA UE). TRUE means allowed and FALSE means not
allowed.
nr-RequestedMeasurements
This field specifies the NR SL-TDOA measurements requested. This is represented by a
bit string, with a one-value at the bit position means the particular measurement is
requested; a zero-value means not requested. Some examples may include: SSBs, CSI-
RS, PT-RS, DMRS, SRS, or the like for Uu and SL, or combination thereof.
nr-SL-PRS-RstdMeasurementInfoRequest
This field indicates whether the target device is requested to report SL-PRS Resource
ID(s) or SL-PRS Resource Set ID(s) used for determining the timing of each PA UE in
RSTD measurements.
maxSL-PRS-RSTD-MeasurementsPerPAUE
This field specifies the maximum number of. SL-PRS RSTD measurements per PA UEs.
The maximum number may be defined across all positioning frequency layers.
timingReportingGranularityFactor
This field specifies the recommended reporting granularity for the SL RSTD
measurements. Value (0..5) corresponds to (k0..k5) used for nr-RSTD and nr-RSTD-
ResultDiff in NR-SL-TDOA-MeasElement. The UE may select a different granularity
value for nr-RSTD and nr-RSTD-ResultDiff. This may be specific to a positioning type
(e.g., Absolute or Relative Positioning)
nr-reconfigAvailability
This field indicates whether the target device requests reconfiguration of PRS
transmissions for the associated PA UE.
ValidityTimingReporting
This field indicates the validity time or range of time (local UE time or UTC) that the SL
positioning reporting is valid.

In some examples, the UE (e.g., target UE 201) may request SL-PRS transmission (re) configuration based on criteria described herein. If allowed and the evaluation criteria has been met for the UE to send a request (and associated information with the request), this may be done via an existing LPP message with newly configured IEs. In one example, the LPP Request Assistance Data may include an IE for the UE to request an LMF or directly request to a PA UE 202 to (re) configure SL-PRS transmissions as shown here for TDOA techniques, but may be similarly updated for AoD, RTT, or the like using TS 37.355 section 6.5.10.2 as a baseline.

The IE NR-SL-TDOA-RequestAssistanceData may be used by the target device to request assistance data from a location server. See Table 22 and Table 23.

TABLE 22

| -- ASN1START | |
|---|---|
| NR-SL-TDOA-RequestAssistanceData-r18 ::= SEQUENCE | |
| nr-PhysCellID-r18 | NR-PhysCellID-r18 |
| OPTIONAL, | |
| nr-AdType-r18 | BIT STRING { sl-prs (0), |
| | posCalc (1) } (SIZE (1..8)), |
| ..., | |
| nr-PRS-config-request | BOOLEAN |
| OPTIONAL, | |
| sl-PRS-KPI-required | SL-PRS-KPI-required |

OPTIONAL
}
-- ASN1STOP

TABLE 23
NR-SL-TDOA-RequestAssistanceData field descriptions

nr-PhysCellID
This field specifies the NR physical cell identity of the current primary cell of the target device.
nr-AdType
This field indicates the requested assistance data. sl-prs means requested assistance data is nr-SL-
PRS-AssistanceData, posCalc means requested assistance data is nr-
PositionCalculationAssistanceData for UE based positioning.
nr-PRS-config-request
This field indicates whether or not a target device is requesting a modification in the current SL-
PRS transmissions associated with the PA UE identity.
sl-PRS-KPI-required
This field specifies the positioning KPIs associated with the request for PRS configuration of the
SL-PRS Resource associated with the PA UE identity.

In other examples, the UE may require some measurements to determine or calculate the need for a request for modification by the network of the PRS transmissions for serving or neighboring cells. As part of the LPP Provide Location Information proposed IEs, the UE may also include general or specific requests for modifications of PRS transmissions as shown, in which TS 37.355 section 6.5.10.3 may be a baseline.

The IE NR-SL-TDOA-ProvideLocationInformation may be used by the target device to provide NR SL-TDOA location measurements to the location server (LMF) 206 or a PA UE 202. It may also be used to provide NR SL-TDOA positioning specific error reasons. See Table 24 and Table 25.

TABLE 24
-- ASN1START
NR-SL-TDOA-ProvideLocationInformation-r18 ::= SEQUENCE {
nr-SL-TDOA-SignalMeasurementInformation-r18

NR-SL-TDOA-

SignalMeasurementInformation-r18
OPTIONAL, -- Cond UEA

| | |
|---|---|
| nr-sl-tdoa-LocationInformationABS-r18 | NR-SL-TDOA- |

LocationInformationABS-r18
OPTIONAL, -- Cond UEB

| | |
|---|---|
| nr-sl-tdoa-LocationInformationREL-r18 | NR-SL-TDOA- |

LocationInformationREL-r18
OPTIONAL, -- Cond UEB

| | |
|---|---|
| nr-SL-TDOA-Error-r18 | NR-SL-TDOA-Error-r18 |

```
  OPTIONAL,
  ...,
```

| | |
|---|---|
| nr-PRS-config-request | BOOLEAN |

OPTIONAL,

| | |
|---|---|
| nr-sl-PRS-KPI-required | NR-SL-PRS-KPI-required |

OPTIONAL
}
-- ASN1STOP

TABLE 25
NR-SL-TDOA-ProvideLocationInformation field descriptions

NR-SL-TDOA-SignalMeasurementInformation
This field indicates the SL TDOA signal measurement information, required for UE-Assisted
positioning mode.
NR-SL-TDOA-LocationInformationABS
This field indicates the SL TDOA location information, required for UE-based absolute
(geographic coordinates) location information reporting.
NR-SL-TDOA-LocationInformationREL
This field indicates the SL TDOA location information, required for UE-based relative location
information reporting.
nr-PRS-config-request
This field indicates whether or not a target device is requesting a modification in the current PRS
transmissions associated with the current PRS measurements. Alternatively, if this IE is
associated with the sub-IEs in nr-SL-TDOA-SignalMeasurementInformation, the request may be
specific to a particular PRS Resource ID, PRS Resource Set, etc.
nr-sl-PRS-KPI-required
This field specifies the positioning KPIs associated with the request for SL-PRS configuration of
the SL-PRS Resource associated with the PA UE identity.

In response to the aforementioned Provide Location Information and associated SL-PRS transmission request, the PA UE 202 may respond with an LPP Provide Assistance Data to inform the UE of the change in PRS transmissions of one or more PRS resources and direct the UE to obtain new measurements. Alternately, denial of PRS request message with other fallback positioning methods or resources may be sent by the network. The network may toggle the sl-PRS-ConfigRqstAllowed for denial of SL-PRS (re) configuration request.

As mentioned, SL UEs, for example, a UE in a vehicle or an RSU may be equipped with a distributed antenna system (DAS). For example, multiple antennas or antenna array/panels at different locations may help to improve positioning sensitivity and geometrical/angular calculation enhancements. Some of the typical Uu-based positioning techniques, such as TDOA, may require multiple positioning “reference nodes” (e.g., gNBs, TRPs) that are necessary for accurate multi-lateration. This requirement may be mitigated or eliminated with DAS support on the PA UE 202 or target UE 201. Timing or angular deltas may enable accurate positioning with only one positioning “reference” node or PA UE 202.

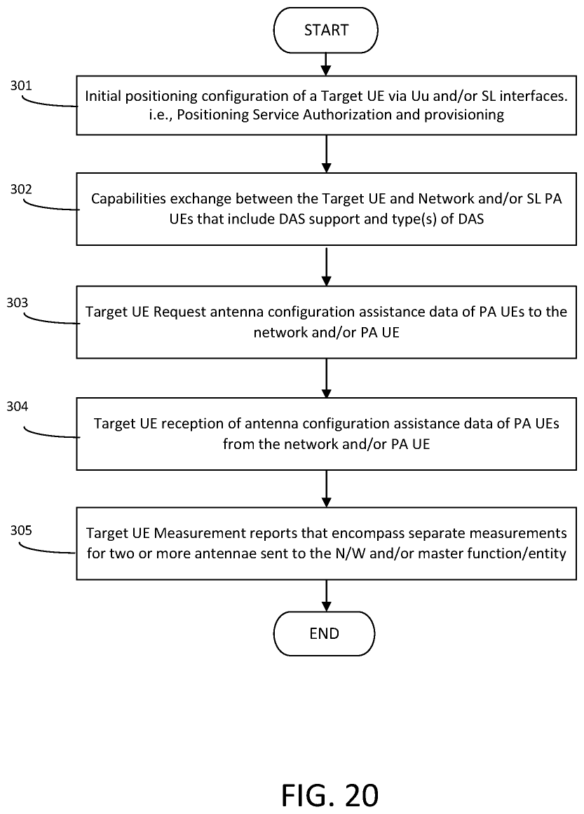

Examples herein describe a method and system to configure and enable DAS measurements at a target UE 201 comprising location protocol messages that may support the procedures as shown in FIG. 20.

In one example, the PA UEs 202 or network (e.g., NG-RAN 207 or LMF 206) dependent upon the interface(s) used for positioning procedures, may require initial configuration and capabilities exchange to determine whether or not DAS is supported. Additionally, measurement configurations, calibrations, and measurement reports may need to account for DAS. In further examples, the measurements from a plurality of antennas may be concatenated at the target UE 201, e.g., for a single reference point location of the target UE 201. If measurements are combined at the target UE 201, these also may need to be identified as such in the measurement reports as further described herein.

Firstly, for capabilities exchange, the target UE 201 may provide the network location entities (e.g., LMF 206, etc.) or PA UEs 202 with DAS support and configuration. In addition to the capabilities described previously, the location protocols may support some or more of the following or alternatively, the target UE 201 may provide or be identified as a class/type of UE that is equipped with DAS. Note that these capabilities may be signaled over the SL or the Uu interface, as it may also be beneficial to have DAS capabilities over both interfaces.

FIG. 20 illustrates an exemplary method flow for LCS Procedures to support DAS. At step 301, there may be initial positioning configuration of a target UE 201 via Uu or SL interfaces, for example positioning service authorization and provisioning.

At step 302, there may be capabilities exchange between the target UE 201 and network or SL PA UEs 202 that include DAS support and type(s) of DAS.

At step 303, target UE 201 may request antenna configuration assistance data of PA UEs 202 to the network or PA UE 202.

At step 304, target UE 201 may receive antenna configuration assistance data of PA UEs from the network or PA UE.

At step 305, target UE measurement reports that encompass separate measurements for two or more antennae may be sent to the network or master entity 203.

The IE NR-SL-ProvideCapabilities-r18 may define the SL measurement capability. The target UE 201 or PA UE 202 may include this IE only if the UE supports SL Positioning for SL-TDOA, SL-RTT, for SL-AoD, etc. Otherwise, the UE may not include this IE. See Table 26 and Table 27.

TABLE 26
-- ASN1START
NR-SL-ProvideCapabilities-r18 ::= SEQUENCE {

| | |
|---|---|
| nr-SL-Mode-r18 | PositioningModes, |
| nr-SL-PRS-Capability-r18 | NR-SL-PRS-ResourcesCapability-r18, |
| nr-SL-AoD-MeasurementCapability-r18 | NR-SL-AoD- |

MeasurementCapability-r18,

| | |
|---|---|
| nr-SL-PRS-ProcessingCapability-r18 | NR-SL-PRS-ProcessingCapability-r18, |
| periodicalReporting-r18 | SL-PositioningMethods-r18, |
| maxSL-PRS-RSRP-MeasurementFR1-r18 | INTEGER (1..8), |
| maxSL-PRS-RSRP-MeasurementFR2-r18 | INTEGER (1..8), |
| maxSL-PRS-RSRP-MeasurementITS-r18 | INTEGER (1..8), |
| simul-NR-SL-AoD-SL-TDOA-r18 | ENUMERATED { supported } |

OPTIONAL,

| | |
|---|---|
| simul-NR-SL-AoD-Multi-RTT-r18 | ENUMERATED { supported} |

OPTIONAL,

| | |
|---|---|
| nr-SL-DAS-configuration | NR-SL-DAS-configuration-r18, |
| relative-location-r18 | ENUMERATED { supported} OPTIONAL, |
| absolute-location-r18 | ENUMERATED { supported} OPTIONAL |

...
}
-- ASN1STOP

TABLE 27
NR-SL-ProvideCapabilities field descriptions

nr-SL-DAS-configuration
This field specifies the SL DAS configuration for the target UE. This may include support
for n number of antennae, antennae placement, antenna array/panels, antennae relative
distance(s), and DAS measurement/processing capabilities.
relative-location
This field specifies whether the target UE or PA UE supports relative positioning.
absolute-location
This field specifies whether the target UE or PA UE supports absolute positioning.

In a further example, the positioning protocols may support methods to identify positioning measurements or report positioning measurements relative to DAS implementations. For these implementations, various antenna layouts or patterns (e.g., linear array, circular array, or 2D rectangular array) may be supported and measurement reports may be transmitted from the target UE 201 to PA UE 202 or the network (e.g., LMF 206). Alternatively, the PA UE 202 or the network may perform the SRS measurements. Depending on whether the DAS is equipped by the PA UE 202 or target UE 201, the antenna layouts or patterns may be indicated from the target UE 201 to PA UE 202 or the network or vice versa. As such, an example of the measurement reports may be exemplified as follows. See Table 28 and Table 29.

TABLE 28
NR-SL-MeasList-r18 ::= SEQUENCE (SIZE(1..nrAntenna-r18)) OF NR-SL-
MeasElement-r18
NR-SL-MeasElement-r18 ::= SEQUENCE {

| | |
|---|---|
| sl-PRS-ID-r18 | INTEGER (0..255), |
| nr-sl-PRS-Type-r18 | NR-SL-PRS-Type-r18 |

OPTIONAL,

| | |
|---|---|
| nr-SL-PRS-ResourceID-r18 | NR-SL-PRS-ResourceID-r18 |

OPTIONAL,

| | |
|---|---|
| nr-SL-PRS-ResourceSetID-r18 | NR-SL-PRS-ResourceSetID-r18 |

OPTIONAL,

| | |
|---|---|
| nr-TimeStamp-r18 | NR-TimeStamp-r18, |
| nr-RSTD-r18 | CHOICE { |
| k0-r18 | INTEGER (0..1970049), |
| k1-r18 | INTEGER (0..985025), |
| k2-r18 | INTEGER (0..492513), |
| k3-r18 | INTEGER (0..246257), |
| k4-r18 | INTEGER (0..123129), |
| k5-r18 | INTEGER (0..61565), |

```
      ...
  },
```

| | |
|---|---|
| nr-AdditionalPathList-r18 | NR-AdditionalPathList-r18 |

OPTIONAL,

| | |
|---|---|
| nr-TimingQuality-r18 | NR-TimingQuality-r18, |
| nr-SL-PRS-RSRP-Result-r18 | INTEGER (0..126) |

```
  OPTIONAL,
  nr-SL-ReferenceTime-r18
```

| | |
|---|---|
| | NR-SL-ReferenceTime-r18 OPTIONAL, |
| nr-SL-PRS-RSRP-ResultDiff-r18 | INTEGER (0..61) |

OPTIONAL,

| | |
|---|---|
| nr-AdditionalPathList-r18 | NR-AdditionalPathList-r18 |

OPTIONAL,

| | |
|---|---|
| nr-SL-PRS-RxBeamIndex-r18 | INTEGER (1..8) |

OPTIONAL,

| | |
|---|---|
| nr-SL-QCL-TypeDSourceIndex | INTEGER (1..8) |

OPTIONAL,

| | |
|---|---|
| sl-DASpanel-Index | INTEGER (1..8) |

```
  OPTIONAL,
  ...
}
```

TABLE 29
NR-SL-SignalMeasurementInformation field descriptions

sl-PRS-ID
This field is used along with a SL-PRS Resource Set ID and a SL-PRS Resources ID to
uniquely identify a SL-PRS Resource. This ID can be associated with multiple SL-PRS
Resource Sets associated with a single PA UE, single panel ID/index, or TRP.
Each PRS resource should only be associated with one such ID.
nr-sl-PRS-type
This field specifies the type of PRS, e.g., Sidelink Synch Signals, PRS, DMRS, CSI-RS,
used in the measurements.
nr-TimeStamp
This field specifies the time instance at which the TOA and SL PRS-RSRP (if included)
measurement is performed. Note, the TOA measurement refers to the TOA of this PA
UE, neighbour TRP or the reference TRP, as applicable, used to determine the nr-RSTD
or nr-RSTD-ResultDiff.
nr-RSTD
This field specifies the relative timing difference between this neighbour TRP/PA UE
and the PRS reference TRP/UE
nr-AdditionalPathList
This field specifies one or more additional detected path timing values for the PA UE,
TRP or resource, relative to the path timing used for determining the nr-RSTD value. If
this field was requested but is not included, it means the UE did not detect any additional
path timing values.
nr-TimingQuality
This field specifies the target device's best estimate of the quality of the TOA
measurement. Note, the TOA measurement refers to the TOA of this PA UE, neighbour
TRP or the reference TRP, as applicable, used to determine the nr-RSTD or nr-RSTD-
ResultDiff.
nr-SL-PRS-RSRP-Result
This field specifies the NR SL-PRS reference signal received power (SL PRS-RSRP)
measurement.
sl-PRS-ID
This field is used along with a SL-PRS Resource Set ID and a SL-PRS Resources ID to
uniquely identify a SL-PRS Resource. This ID can be associated with multiple SL-PRS
Resource Sets associated with a single PA UE, single panel ID/index, or TRP.
Each PRS resource should only be associated with one such ID.
nr-sl-PRS-type
This field specifies the type of PRS, e.g., Sidelink Synch Signals, PRS, DMRS, CSI-RS,
used in the measurements.
nr-TimeStamp
This field specifies the time instance at which the TOA and SL PRS-RSRP (if included)
measurement is performed. Note, the TOA measurement refers to the TOA of this PA
UE, neighbour TRP or the reference TRP, as applicable, used to determine the nr-RSTD
or nr-RSTD-ResultDiff.
nr-RSTD
This field specifies the relative timing difference between this neighbour TRP/PA UE
and the PRS reference TRP/UE
nr-AdditionalPathList
This field specifies one or more additional detected path timing values for the PA UE,
TRP or resource, relative to the path timing used for determining the nr-RSTD value. If
this field was requested but is not included, it means the UE did not detect any additional
path timing values.
nr-TimingQuality
This field specifies the target device's best estimate of the quality of the TOA
measurement. Note, the TOA measurement refers to the TOA of this PA UE, neighbour
TRP or the reference TRP, as applicable, used to determine the nr-RSTD or nr-RSTD-
ResultDiff.
nr-RSTD-ResultDiff
This field provides the additional SL RSTD measurement result relative to nr-RSTD. The
RSTD value of this measurement is obtained by adding the value of this field to the
value of the nr-RSTD field.
sl-PRS-ID
This field is used along with a SL-PRS Resource Set ID and a SL-PRS Resources ID to
uniquely identify a SL-PRS Resource. This ID can be associated with multiple SL-PRS
Resource Sets associated with a single PA UE, single panel ID/index, or TRP.
Each PRS resource should only be associated with one such ID.
nr-sl-PRS-type
This field specifies the type of PRS, e.g., Sidelink Synch Signals, PRS, DMRS, CSI-RS,
used in the measurements.
nr-TimeStamp
This field specifies the time instance at which the TOA and SL PRS-RSRP (if included)
measurement is performed. Note, the TOA measurement refers to the TOA of this PA
UE, neighbour TRP or the reference TRP, as applicable, used to determine the nr-RSTD
or nr-RSTD-ResultDiff.
nr-RSTD
This field specifies the relative timing difference between this neighbour TRP/PA UE
and the PRS reference TRP/UE
nr-AdditionalPathList
This field specifies one or more additional detected path timing values for the PA UE,
TRP or resource, relative to the path timing used for determining the nr-RSTD value. If
this field was requested but is not included, it means the UE did not detect any additional
path timing values.
nr-TimingQuality
This field specifies the target device's best estimate of the quality of the TOA
measurement. Note, the TOA measurement refers to the TOA of this PA UE, neighbour
TRP or the reference TRP, as applicable, used to determine the nr-RSTD or nr-RSTD-
ResultDiff.
nr-SL-PRS-RSRP-ResultDiff
This field provides the additional SL-PRS RSRP measurement result relative to nr-SL-
PRS-RSRP-Result. The SL-PRS RSRP value of this measurement is obtained by adding
the value of this field to the value of the nr-SL-PRS-RSRP-Result field.
sl-PRS-ID
This field is used along with a SL-PRS Resource Set ID and a SL-PRS Resources ID to
uniquely identify a SL-PRS Resource. This ID can be associated with multiple SL-PRS
Resource Sets associated with a single PA UE, single panel ID/index, or TRP.
Each PRS resource should only be associated with one such ID.
nr-sl-PRS-type
This field specifies the type of PRS, e.g., Sidelink Synch Signals, PRS, DMRS, CSI-RS,
used in the measurements.
nr-TimeStamp
This field specifies the time instance at which the TOA and SL PRS-RSRP (if included)
measurement is performed. Note, the TOA measurement refers to the TOA of this PA
UE, neighbour TRP or the reference TRP, as applicable, used to determine the nr-RSTD
or nr-RSTD-ResultDiff.
nr-RSTD
This field specifies the relative timing difference between this neighbour TRP/PA UE
and the PRS reference TRP/UE
nr-AdditionalPathList
This field specifies one or more additional detected path timing values for the PA UE,
TRP or resource, relative to the path timing used for determining the nr-RSTD value. If
this field was requested but is not included, it means the UE did not detect any additional
path timing values.
nr-TimingQuality
This field specifies the target device's best estimate of the quality of the TOA
measurement. Note, the TOA measurement refers to the TOA of this PA UE, neighbour
TRP or the reference TRP, as applicable, used to determine the nr-RSTD or nr-RSTD-
ResultDiff.
nr-SL-ReferenceTime
This field specifies the time for which the location estimate is valid.
nr-SL-PRS-RxBeamIndex
This field provides an index of the target UE receive beam used for SL-PRS
measurements
sl-PRS-ID
This field is used along with a SL-PRS Resource Set ID and a SL-PRS Resources ID to
uniquely identify a SL-PRS Resource. This ID can be associated with multiple SL-PRS
Resource Sets associated with a single PA UE, single panel ID/index, or TRP.
Each PRS resource should only be associated with one such ID.
nr-sl-PRS-type
This field specifies the type of PRS, e.g., Sidelink Synch Signals, PRS, DMRS, CSI-RS,
used in the measurements.
nr-TimeStamp
This field specifies the time instance at which the TOA and SL PRS-RSRP (if included)
measurement is performed. Note, the TOA measurement refers to the TOA of this PA
UE, neighbour TRP or the reference TRP, as applicable, used to determine the nr-RSTD
or nr-RSTD-ResultDiff.
nr-RSTD
This field specifies the relative timing difference between this neighbour TRP/PA UE
and the PRS reference TRP/UE
nr-AdditionalPathList
This field specifies one or more additional detected path timing values for the PA UE,
TRP or resource, relative to the path timing used for determining the nr-RSTD value. If
this field was requested but is not included, it means the UE did not detect any additional
path timing values.
nr-TimingQuality
This field specifies the target device's best estimate of the quality of the TOA
measurement. Note, the TOA measurement refers to the TOA of this PA UE, neighbour
TRP or the reference TRP, as applicable, used to determine the nr-RSTD or nr-RSTD-
ResultDiff.
nr-SL-QCL-TypeDSourceIndex
This field indicates the index of the target UE receive QCL type D SL-PRS source used
for SL-PRS measurements.
sl-PRS-ID
This field is used along with a SL-PRS Resource Set ID and a SL-PRS Resources ID to
uniquely identify a SL-PRS Resource. This ID can be associated with multiple SL-PRS
Resource Sets associated with a single PA UE, single panel ID/index, or TRP.
Each PRS resource should only be associated with one such ID.
nr-sl-PRS-type
This field specifies the type of PRS, e.g., Sidelink Synch Signals, PRS, DMRS, CSI-RS,
used in the measurements.
nr-TimeStamp
This field specifies the time instance at which the TOA and SL PRS-RSRP (if included)
measurement is performed. Note, the TOA measurement refers to the TOA of this PA
UE, neighbour TRP or the reference TRP, as applicable, used to determine the nr-RSTD
or nr-RSTD-ResultDiff.
nr-RSTD
This field specifies the relative timing difference between this neighbour TRP/PA UE
and the PRS reference TRP/UE
nr-AdditionalPathList
This field specifies one or more additional detected path timing values for the PA UE,
TRP or resource, relative to the path timing used for determining the nr-RSTD value. If
this field was requested but is not included, it means the UE did not detect any additional
path timing values.
nr-TimingQuality
This field specifies the target device's best estimate of the quality of the TOA
measurement. Note, the TOA measurement refers to the TOA of this PA UE, neighbour
TRP or the reference TRP, as applicable, used to determine the nr-RSTD or nr-RSTD-
ResultDiff.
sl-DASpanel-Index
This field may be used along with a SL-PRS Resource Set ID and a SL-PRS Resources
ID to uniquely identify an antenna panel. In alternative embodiments, a panel ID is
associated with an index in a list of UE capabilities, e.g., a list of the maximum number
of antenna ports in SRS/PRS resource sets.

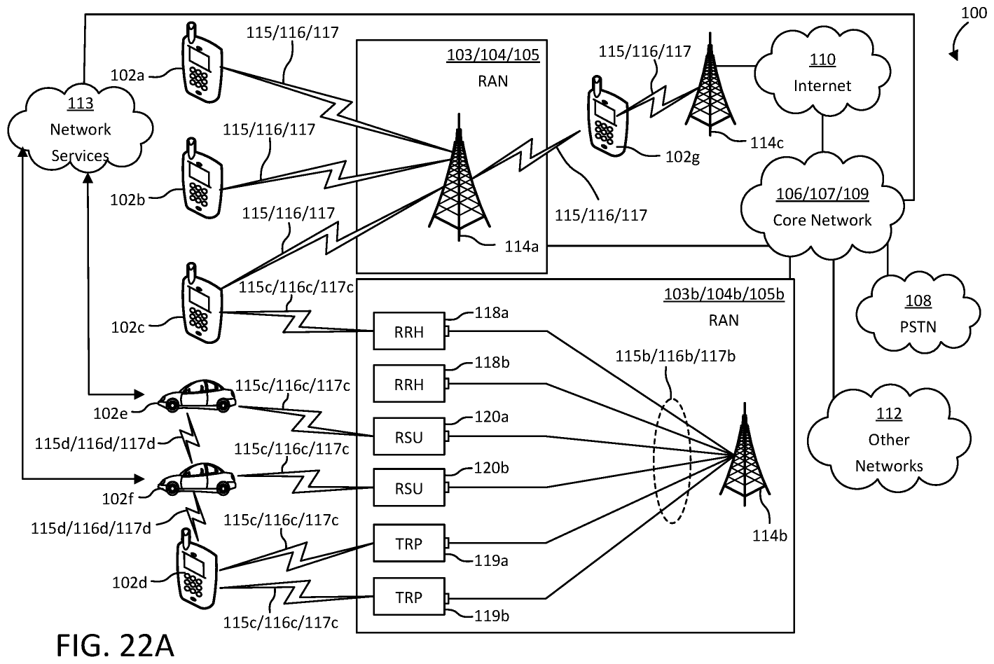

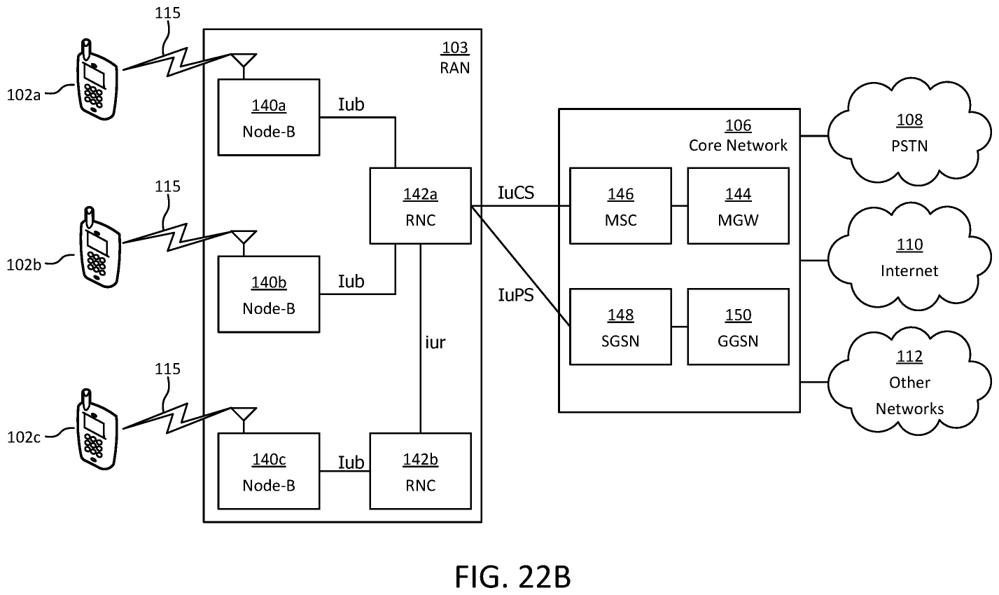

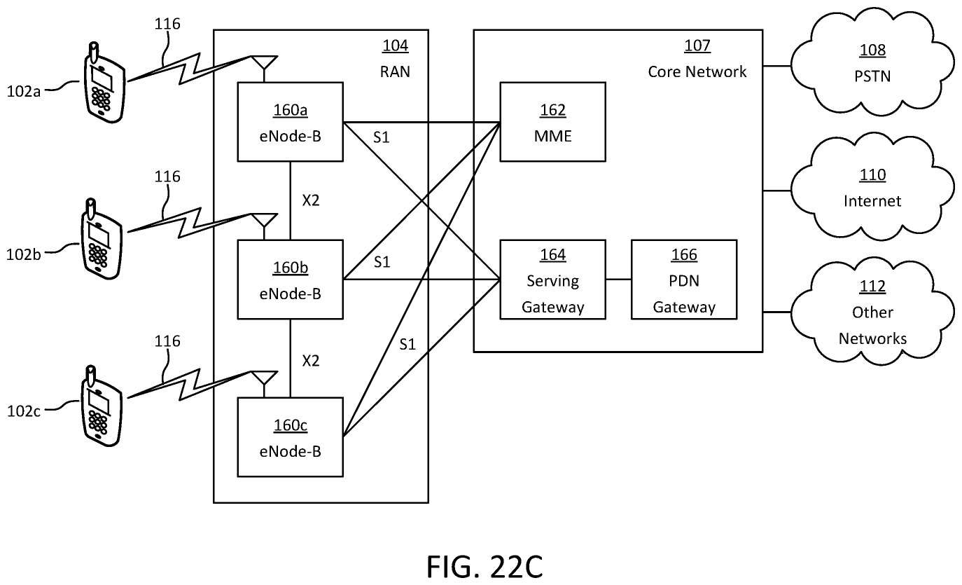

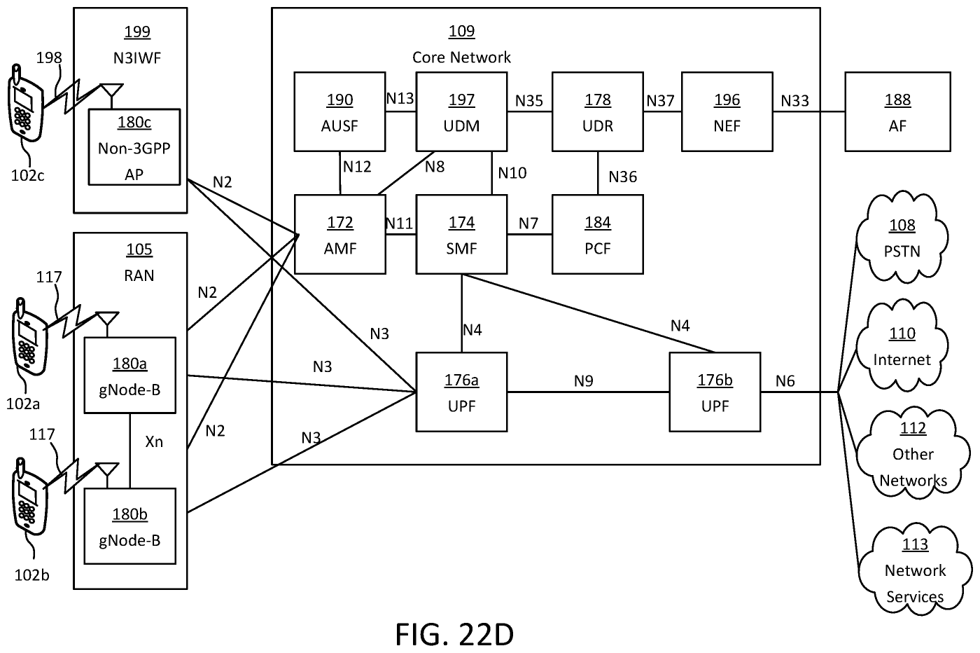

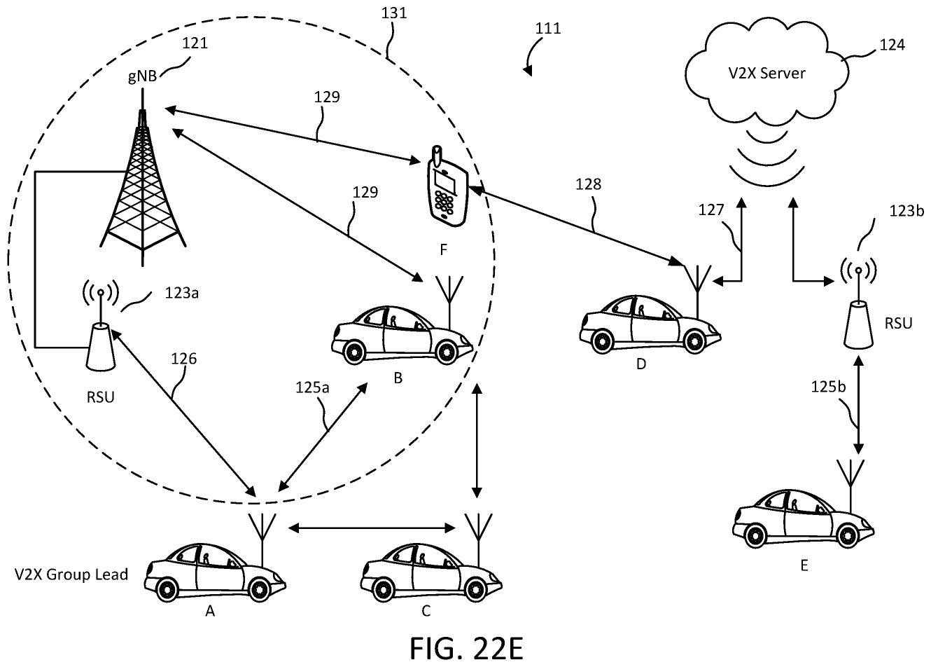

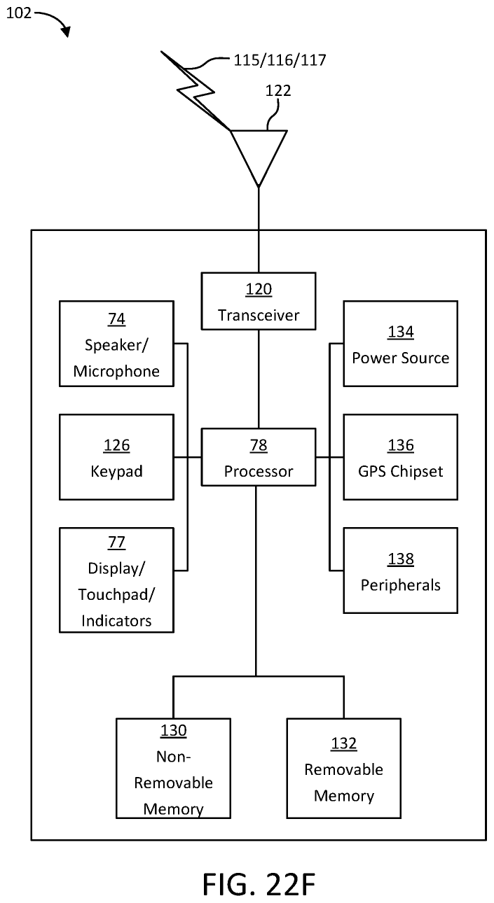

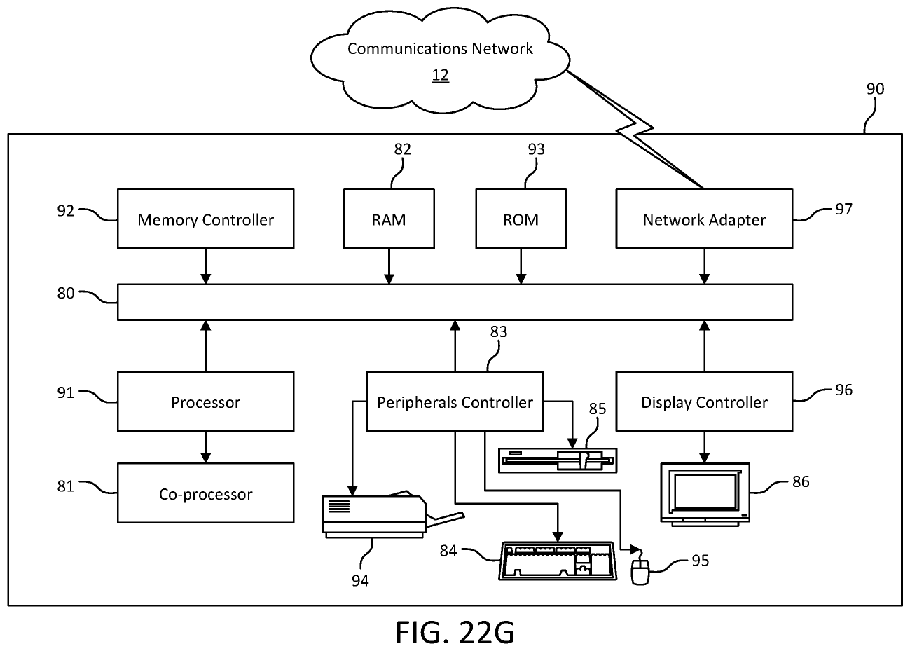

It is understood that the entities performing the steps illustrated herein, such as FIG. 10 through FIG. 20 may be logical entities. The steps may be stored in a memory of, and executing on a processor of, a device, server, or computer system such as those illustrated in FIG. 22F or FIG. 22G. Skipping steps, combining steps, or adding steps between exemplary methods disclosed herein (e.g., FIG. 10 through FIG. 20) is contemplated.

Table 30 provides abbreviations and definitions, while Table 31 provides other terms and definitions.

TABLE 30
Abbreviations and Definitions

| Abbreviations | Definitions |
|---|---|
| 3GPP | 3rd Generation Partnership Project |
| AMF | Access and Mobility Management Function |
| AD | Assistance Data |
| AoA | Angle of Arrival |
| AoD | Angle of Departure |
| BW | Bandwidth |
| CE | Controlling entity |
| CP | Control Plane |
| CSI-RS | Channel State Information Reference Signal |
| DL | Downlink |
| DMRS | Demodulation Reference Signal |
| GMLC | Gateway Mobile Location Center |
| GNSS | Global Navigation Satellite System |
| GPS | Global Positioning System |
| IE | Information Element |
| KPI | Key Performance Indicator |
| LCID | Logical Channel IDentifier |
| LCS | LoCation Services |
| LMF | Location Management Function (may be used |
| | interchangeably with Network or Location Server) |
| LOS | Line Of Sight |
| LPP | LTE Positioning Protocol (or another positioning |
| | protocol) |
| LTE | Long Term Evolution |
| MAC | Medium Access Control |
| MAC-CE | Medium Access Control-Control Element |
| MIB | Master Information Block |
| NAS | Non-Access Stratum |
| NG-RAN | Next Generation-Radio Access Network |
| NLOS | Non-Line of Sight |
| NR | New Radio |
| NRPPa | New Radio Positioning Protocol A |
| N/W | Network |
| PA UE | Positioning Assist UE |
| PDU | Protocol Data Unit |
| P2P | Point-to-Point |
| posSIB | Positioning SIB |
| PT-RS | Phase Tracking-Reference Signal |
| PRS | Positioning Reference Signal |
| RAN | Radio Access Network |
| RAT | Radio Access Technology |
| RedCap | Reduced Capabilities |
| RLC | Radio Link Control |
| RNA | RAN Notification Area |
| RRC | Radio Resource Control |
| RSRP | Reference Signal Received Power |
| RSRQ | Reference Signal Received Quality |
| RSTD | Reference Signal Time Difference |
| RSU | Road Side Unit |
| RTT | Round Trip Time |
| SDT | Small Data Transmission |
| SDU | Service Data Unit |
| SI | System Information |
| SIB | System Information Block |
| SL | SideLink |
| S-NSSAI | Single - Network Slice Selection Assistance |
| | Information |
| SUPL | Secure User Plane Location |
| SRS | Sounding Reference Signal |
| TA | Tracking Area |
| TDOA | Time Difference of Arrival |
| TRP | Transmission Reception Point (may be used |
| | interchangeably with gNB) |
| UE | User Equipment |
| UE-A | User Equipment-Assisted |
| UE-B | User Equipment-Based |
| UL | Uplink |
| UP | User Plane |
| Uu Interface | Radio interface between the mobile and the radio |
| | access network |

TABLE 31
Terms and Definitions

| Terms | Definitions |
|---|---|
| Distributed | A UE or entity that is equipped with multiple |
| Antenna | antennas or antenna panels/array co-located at the |
| System | entity to improve positioning sensitivity and |
| | geometrical/angular calculation enhancements. |
| Master | This entity may perform similar roles to that of an |
| (controlling | LMF (e.g., location server) and may be used to e.g., |
| entity | instigate LCS request, calculate target UE position, |
| | disseminate positioning assistance data to the target |
| | UE, PA UE(s), or the like. This entity may |
| | configure SL PRS into the target UE, PA UE(s) or |
| | the like, and may transmit SL PRS to the target UE, |
| | PA UE(s) or the like. The controlling entity may |
| | also perform functions similar to that of a base |
| | station such as measurement configuration and |
| | management functions, radio resource management |
| | functions including resource allocation such as PRS |
| | resources, and scheduling, In the context of this |
| | paper the controlling entity may be an infrastructure |
| | node or a non-infrastructure node. When it is an |
| | infrastructure node, the controlling entity functions |
| | may be distributed between a base station and an |
| | LMF/location server. When the controlling entity is |
| | not an infrastructure node, the controlling entity |
| | functions may be implemented by a UE, an RSU, |
| | etc. |
| PA UE (PA | The Positioning Assist (PA) UE/entity is an entity |
| entity) | that assists a target UE by performing various SL |
| | positioning function(s), e.g., configures SL PRS to |
| | the target UE, transmits SL-PRS to the target UE, |
| | measures SL-SRS transmitted from the target UE, |
| | and calculates target UE position. A PA UE may be |
| | inclusive of a Master (controlling) function or a |
| | Relay function. |
| PRS | A reference signal received by a target UE over Uu |
| (Positioning | or SL interfaces that is leveraged by way of |
| Reference | decoding, measurements and calculations for |
| Signal) | locating a target UE to obtain absolute or relative |
| | position. Examples include a PRS signal used |
| | exclusively for positioning, synchronization signals |
| | (e.g., SSB), other reference signals as described |
| | herein, or combinations thereof. |
| Relay | In the context of SL positioning, refers to a UE-to- |
| UE/function | Network relay or UE-to-UE relay that essentially |
| | extends network coverage by relaying positioning |
| | reference signals, connectivity, or transmitting |
| | associated configurations between the controlling |
| | entity and target UEs or between the controlling |
| | entity and the PA UE. |
| Target UE | The target UE is a device for which the |
| | position/location is to be determined. |
| UE-Assisted | Positioning determination that involves the target |
| positioning | UE scanning for accessible sources of positioning, |
| | measures positioning signals/sources, and transmits |
| | measurement report(s) to the PA UE or the |
| | controlling entity for position calculation. |
| UE-Based | Positioning determination that involves the target |
| positioning | UE being responsible for making the positioning |
| | calculation. Additionally, the target UE may |
| | perform scanning for accessible sources of |
| | positioning, measurement of positioning |
| | signals/sources, and may use such measurements to |
| | calculates its own position, or report such |
| | measurement to the controlling entity, such that the |
| | controlling entity can assist the target UE calculate |
| | its own position. |

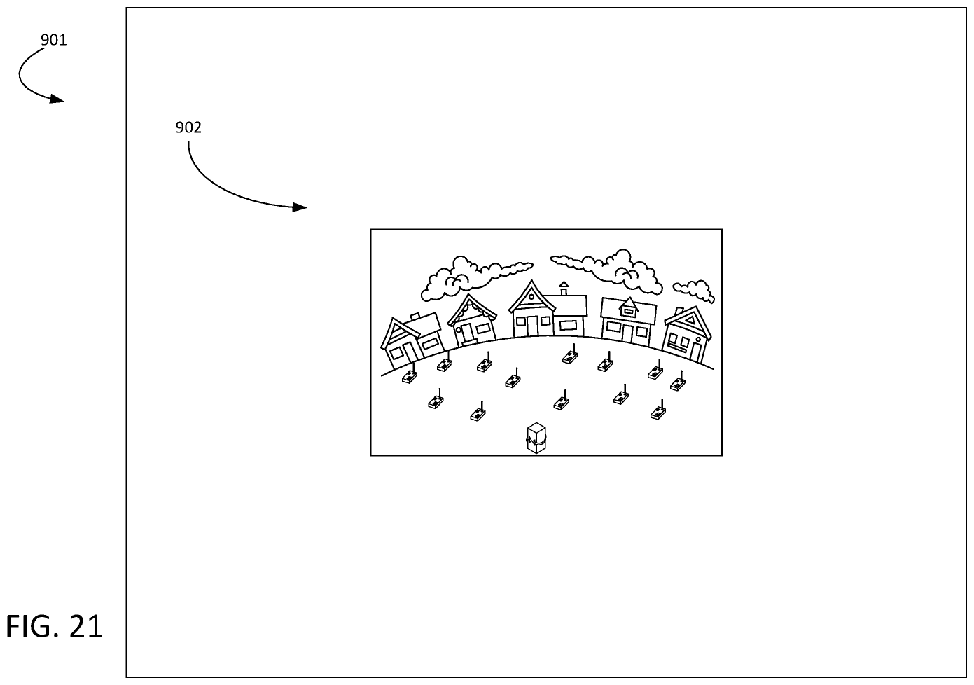

FIG. 21 illustrates an exemplary display (e.g., graphical user interface) that may be generated based on the methods, systems, and devices of NR SL Positioning, as discussed herein. Display interface 901 (e.g., touch screen display) may provide text in block 902 associated with of NR SL Positioning, such as NR SL Positioning related parameters, method flow, and associated current conditions. Progress of any of the steps (e.g., sent messages or success of steps) discussed herein may be displayed in block 902. In addition, graphical output 902 may be displayed on display interface 901. Graphical output 902 may be the topology of the devices implementing the methods, systems, and devices of NR SL Positioning, a graphical output of the progress of any method or systems discussed herein, or the like.

The 3rd Generation Partnership Project (3GPP) develops technical standards for cellular telecommunications network technologies, including radio access, the core transport network, and service capabilities-including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to include a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mm Wave spectrum that will provide the opportunity for ultra-mobile broadband access for, e.g., indoor applications and hotspots. In particular, the ultra-mobile broadband is expected to share a common design framework with the flexible radio access below 7 GHZ, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), Non-Terrestrial Networks (NTN), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

FIG. 22A illustrates an example communications system 100 in which the methods and apparatus of NR SL Positioning, such as the systems and methods illustrated in FIG. 10 through FIG. 21 described and claimed herein may be used. The communications system 100 may include wireless transmit/receive units (WTRUs) 102a, 102b, 102c, 102d, 102e, 102f, or 102g (which generally or collectively may be referred to as WTRU 102 or WTRUs 102). The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, or edge computing, etc.

It will be appreciated that the concepts disclosed herein may be used with any number of WTRUs, base stations, networks, or network elements. Each of the WTRUs 102a, 102b, 102c, 102d, 102e, 102f, or 102g may be any type of apparatus or device configured to operate or communicate in a wireless environment. Although each WTRU 102a, 102b, 102c, 102d, 102e, 102f, or 102g may be depicted in FIG. 22A, FIG. 22B, FIG. 22C, FIG. 22D, FIG. 22E, or FIG. 22F as a hand-held wireless communications apparatus, it is understood that with the wide variety of use cases contemplated for 5G wireless communications, each WTRU may comprise or be embodied in any type of apparatus or device configured to transmit or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus, truck, train, or airplane, or the like.

The communications system 100 may also include a base station 114a and a base station 114b. In the example of FIG. 22A, each base stations 114a and 114b is depicted as a single element. In practice, the base stations 114a and 114b may include any number of interconnected base stations or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, or the other networks 112. Similarly, base station 114b may be any type of device configured to wiredly or wirelessly interface with at least one of the Remote Radio Heads (RRHs) 118a, 118b, Transmission and Reception Points (TRPs) 119a, 119b, or Roadside Units (RSUs) 120a and 120b to facilitate access to one or more communication networks, such as the core network 106/107/109, the Internet 110, other networks 112, or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, or other networks 112.

TRPs 119a, 119b may be any type of device configured to wirelessly interface with at least one of the WTRU 102d, to facilitate access to one or more communication networks, such as the core network 106/107/109, the Internet 110, Network Services 113, or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, or the like.

The base station 114a may be part of the RAN 103/104/105, which may also include other base stations or network elements (not shown), such as a Base Station Controller (BSC), a Radio Network Controller (RNC), relay nodes, etc. Similarly, the base station 114b may be part of the RAN 103b/104b/105b, which may also include other base stations or network elements (not shown), such as a BSC, a RNC, relay nodes, etc. The base station 114a may be configured to transmit or receive wireless signals within a particular geographic region, which may be referred to as a cell (not shown). Similarly, the base station 114b may be configured to transmit or receive wired or wireless signals within a particular geographic region, which may be referred to as a cell (not shown) for methods, systems, and devices of NR SL Positioning, as disclosed herein. Similarly, the base station 114b may be configured to transmit or receive wired or wireless signals within a particular geographic region, which may be referred to as a cell (not shown). The cell may further be divided into cell sectors. For example, the cell associated with the base station 114a may be divided into three sectors. Thus, in an example, the base station 114a may include three transceivers, e.g., one for each sector of the cell. In an example, the base station 114a may employ multiple-input multiple output (MIMO) technology and, therefore, may utilize multiple transceivers for each sector of the cell.

The base stations 114a may communicate with one or more of the WTRUs 102a, 102b, 102c, or 102g over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, or RSUs 120a, 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, or 102f may communicate with one another over an air interface 115d/116d/117d, such as Sidelink communication, which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

The communications system 100 may be a multiple access system and may employ one or more channel access schemes, such as CDMA, TDMA, FDMA, OFDMA, SC-FDMA, or the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) or Evolved HSPA (HSPA+). HSPA may include High-Speed Downlink Packet Access (HSDPA) or High-Speed Uplink Packet Access (HSUPA).

In an example, the base station 114a and the WTRUs 102a, 102b, 102c, or RRHs 118a, 118b, TRPs 119a, 119b, or RSUs 120a, 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) or LTE-Advanced (LTE-A). In the future, the air interface 115/116/117 or 115c/116c/117c may implement 3GPP NR technology. The LTE and LTE-A technology may include LTE D2D and V2X technologies and interfaces (such as Sidelink communications, etc.). Similarly, the 3GPP NR technology may include NR V2X technologies and interface (such as Sidelink communications, etc.).

The base station 114a in the RAN 103/104/105 and the WTRUs 102a, 102b, 102c, and 102g or RRHs 118a, 118b, TRPs 119a, 119b or RSUs 120a, 120b in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), or the like.

The base station 114c in FIG. 22A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, or the like, for implementing the methods, systems, and devices of NR SL Positioning, as disclosed herein. In an example, the base station 114c and the WTRUs 102, e.g., WTRU 102e, may implement a radio technology such as IEEE 802.11 to establish a wireless local area network (WLAN). Similarly, the base station 114c and the WTRUs 102d, may implement a radio technology such as IEEE 802.15 to establish a wireless personal area network (WPAN). In yet another example, the base station 114c and the WTRUs 102, e.g., WTRU 102e, may utilize a cellular-based RAT (e.g., WCDMA, CDMA2000, GSM, LTE, LTE-A, NR, etc.) to establish a picocell or femtocell. As shown in FIG. 22A, the base station 114c may have a direct connection to the Internet 110. Thus, the base station 114c may not be required to access the Internet 110 via the core network 106/107/109.

The RAN 103/104/105 or RAN 103b/104b/105b may be in communication with the core network 106/107/109, which may be any type of network configured to provide voice, data, messaging, authorization and authentication, applications, or voice over internet protocol (VOIP) services to one or more of the WTRUs 102a, 102b, 102c, 102d. For example, the core network 106/107/109 may provide call control, billing services, mobile location-based services, pre-paid calling, Internet connectivity, packet data network connectivity, Ethernet connectivity, video distribution, etc., or perform high-level security functions, such as user authentication.

Although not shown in FIG. 22A, it will be appreciated that the RAN 103/104/105 or RAN 103b/104b/105b or the core network 106/107/109 may be in direct or indirect communication with other RANs that employ the same RAT as the RAN 103/104/105 or RAN 103b/104b/105b or a different RAT. For example, in addition to being connected to the RAN 103/104/105 or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102a, 102b, 102c, 102d, 102e to access the PSTN 108, the Internet 110, or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned or operated by other service providers. For example, the networks 112 may include any type of packet data network (e.g., an IEEE 802.3 Ethernet network) or another core network connected to one or more RANs, which may employ the same RAT as the RAN 103/104/105 or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links for implementing methods, systems, and devices of NR SL Positioning, as disclosed herein. For example, the WTRU 102g shown in FIG. 22A may be configured to communicate with the base station 114a, which may employ a cellular-based radio technology, and with the base station 114c, which may employ an IEEE 802 radio technology.

Although not shown in FIG. 22A, it will be appreciated that a User Equipment may make a wired connection to a gateway. The gateway maybe a Residential Gateway (RG). The RG may provide connectivity to a Core Network 106/107/109. It will be appreciated that much of the subject matter included herein may equally apply to UEs that are WTRUs and UEs that use a wired connection to connect with a network. For example, the subject matter that applies to the wireless interfaces 115, 116, 117 and 115c/116c/117c may equally apply to a wired connection.

FIG. 22B is a system diagram of an example RAN 103 and core network 106 that may implement methods, systems, and devices of NR SL Positioning, as disclosed herein. As noted above, the RAN 103 may employ a UTRA radio technology to communicate with the WTRUs 102a, 102b, and 102c over the air interface 115. The RAN 103 may also be in communication with the core network 106. As shown in FIG. 22B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 22B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, or the like.

The core network 106 shown in FIG. 22B may include a media gateway (MGW) 144, a Mobile Switching Center (MSC) 146, a Serving GPRS Support Node (SGSN) 148, or a Gateway GPRS Support Node (GGSN) 150. While each of the foregoing elements are depicted as part of the core network 106, it will be appreciated that any one of these elements may be owned or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned or operated by other service providers.

FIG. 22C is a system diagram of an example RAN 104 and core network 107 that may implement methods, systems, and devices of NR SL Positioning, as disclosed herein. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink or downlink, or the like. As shown in FIG. 22C, the eNode-Bs 160a, 160b, and 160c may communicate with one another over an X2 interface.

The core network 107 shown in FIG. 22C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned or operated by an entity other than the core network operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, or the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the SI interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, or the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned or operated by other service providers.

FIG. 22D is a system diagram of an example RAN 105 and core network 109 that may implement methods, systems, and devices of NR SL Positioning, as disclosed herein. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink or downlink, or the like. As shown in FIG. 22D, the gNode-Bs 180a and 180b may communicate with one another over an Xn interface, for example.

The core network 109 shown in FIG. 22D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless or network communications or a computer system, such as system 90 illustrated in FIG. 22G.

In the example of FIG. 22D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned or operated by an entity other than the core network operator. It will also be appreciated that a 5G core network may not include all of these elements, may include additional elements, and may include multiple instances of each of these elements. FIG. 22D shows that network functions directly connect with one another, however, it should be appreciated that they may communicate via routing agents such as a diameter routing agent or message buses.

In the example of FIG. 22D, connectivity between network functions is achieved via a set of interfaces, or reference points. It will be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 22D.

The SMF 174 may be connected to the AMF 172 via an N11 interface.

Similarly the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 22D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect with network functions, so that network function can add to, read from, and modify the data that is in the repository. For example, the UDR 178 may connect with the PCF 184 via an N36 interface. Similarly, the UDR 178 may connect with the NEF 196 via an N37 interface, and the UDR 178 may connect with the UDM 197 via an N35 interface.

The UDM 197 may serve as an interface between the UDR 178 and other network functions. The UDM 197 may authorize network functions to access of the UDR 178. For example, the UDM 197 may connect with the AMF 172 via an N8 interface, the UDM 197 may connect with the SMF 174 via an N10 interface. Similarly, the UDM 197 may connect with the AUSF 190 via an N13 interface. The UDR 178 and UDM 197 may be tightly integrated.

The AUSF 190 performs authentication related operations and connect with the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect with an AF 188 via an N33 interface and it may connect with other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that may be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 22D, in a network slicing scenario, a WTRU 102a, 102b, or 102c may connect with an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned or operated by other service providers.

The core network entities described herein and illustrated in FIG. 22A, FIG. 22C, FIG. 22D, or FIG. 22E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIG. 22A, FIG. 22B, FIG. 22C, FIG. 22D, or FIG. 22E are provided by way of example only, and it is understood that the subject matter disclosed and claimed herein may be embodied or implemented in any similar communication system, whether presently defined or defined in the future.

FIG. 22E illustrates an example communications system 111 in which the systems, methods, apparatus that implement NR SL Positioning, described herein, may be used. Communications system 111 may include Wireless Transmit/Receive Units (WTRUS) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, or other network elements. One or several or all WTRUs A, B, C, D, E, and F may be out of range of the access network coverage 131. WTRUs A, B, and C form a V2X group, among which WTRU A is the group lead and WTRUs B and Care group members.

WTRUS A, B, C, D, E, and F may communicate with each other over a Uu interface 129 via the gNB 121 if they are within the access network coverage 131. In the example of FIG. 22E, WTRUs B and F are shown within access network coverage 131. WTRUS A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 22E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 22F is a block diagram of an example apparatus or device WTRU 102 that may be configured for wireless communications and operations in accordance with the systems, methods, and apparatus that implement NR SL Positioning, described herein, such as a WTRU 102 of FIG. 22A, FIG. 22B, FIG. 22C, FIG. 22D, or FIG. 22E, or FIG. 10-FIG. 21. As shown in FIG. 22F, the example WTRU 102 may include a processor 78, a transceiver 120, a transmit/receive element 122, a speaker/microphone 74, a keypad 126, a display/touchpad/indicators 77, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 22F and may be an exemplary implementation that performs the disclosed systems and methods for NR SL Positioning described herein.

The processor 78 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, or the like. The processor 78 may perform signal coding, data processing, power control, input/output processing, or any other functionality that enables the WTRU 102 to operate in a wireless environment. The processor 78 may be coupled to the transceiver 120, which may be coupled to the transmit/receive element 122. While FIG. 22F depicts the processor 78 and the transceiver 120 as separate components, it will be appreciated that the processor 78 and the transceiver 120 may be integrated together in an electronic package or chip.

The transmit/receive element 122 of a UE may be configured to transmit signals to, or receive signals from, a base station (e.g., the base station 114a of FIG. 22A) over the air interface 115/116/117 or another UE over the air interface 115d/116d/117d. For example, the transmit/receive element 122 may be an antenna configured to transmit or receive RF signals. The transmit/receive element 122 may be an emitter/detector configured to transmit or receive IR, UV, Radar, LIDAR, or visible light signals, for example. The transmit/receive element 122 may be configured to transmit and receive both RF and light signals. It will be appreciated that the transmit/receive element 122 may be configured to transmit or receive any combination of wireless or wired signals.

In addition, although the transmit/receive element 122 is depicted in FIG. 22F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

The processor 78 of the WTRU 102 may be coupled to, and may receive user input data from, the speaker/microphone 74, the keypad 126, or the display/touchpad/indicators 77 (e.g., a liquid crystal display (LCD) display unit or organic light-emitting diode (OLED) display unit. The processor 78 may also output user data to the speaker/microphone 74, the keypad 126, or the display/touchpad/indicators 77. In addition, the processor 78 may access information from, and store data in, any type of suitable memory, such as the non-removable memory 130 or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, or the like. The processor 78 may access information from, and store data in, memory that is not physically located on the WTRU 102, such as on a server that is hosted in the cloud or in an edge computing platform or in a home computer (not shown). The processor 78 may be configured to control lighting patterns, images, or colors on the display or indicators 77 in response to whether the setup of the NR SL Positioning in some of the examples described herein are successful or unsuccessful, or otherwise indicate a status of NR SL Positioning and associated components. The control lighting patterns, images, or colors on the display or indicators 77 may be reflective of the status of any of the method flows or components in the FIG.'s illustrated or discussed herein (e.g., FIG. 10-FIG. 21, etc.). Disclosed herein are messages and procedures of NR SL Positioning. The messages and procedures may be extended to provide interface/API for users to request resources via an input source (e.g., speaker/microphone 74, keypad 126, or display/touchpad/indicators 77) and request, configure, or query NR SL Positioning related information, among other things that may be displayed on display 77.

The processor 78 may receive power from the power source 134 and may be configured to distribute or control the power to the other components in the WTRU 102. The power source 134 may be any suitable device for powering the WTRU 102. For example, the power source 134 may include one or more dry cell batteries, solar cells, fuel cells, or the like.

The processor 78 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) or determine its location based on the timing of the signals being received from two or more nearby base stations. It will be appreciated that the WTRU 102 may acquire location information by way of any suitable location-determination method.

The processor 78 may further be coupled to other peripherals 138, which may include one or more software or hardware modules that provide additional features, functionality, or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, or the like.

The WTRU 102 may be included in other apparatus or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect with other components, modules, or systems of such apparatus or devices via one or more interconnect interfaces, such as an interconnect interface that may comprise one of the peripherals 138.

FIG. 22G is a block diagram of an exemplary computing system 90 in which one or more apparatus of the communications networks illustrated in FIG. 22A, FIG. 22C, FIG. 22D and FIG. 22E as well as mobility signaling load reduction, such as the systems and methods illustrated in FIG. 18 through FIG. 26 described and claimed herein may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, or the like. The processor 91 may perform signal coding, data processing, power control, input/output processing, or any other functionality that enables the computing system 90 to operate in a communications network. Coprocessor 81 is an optional processor, distinct from main processor 91, that may perform additional functions or assist processor 91. Processor 91 or coprocessor 81 may receive, generate, and process data related to the methods and apparatus disclosed herein for NR SL Positioning, such as receiving or sending messages.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically may include data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 may be read or changed by processor 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may include peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 may include electronic components required to generate a video signal that is sent to display 86.

Further, computing system 90 may include communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIG. 22A, FIG. 22B, FIG. 22C, FIG. 22D, or FIG. 22E, to enable the computing system 90 to communicate with other nodes or functional entities of those networks. The communication circuitry, alone or in combination with the processor 91, may be used to perform the transmitting and receiving steps of certain apparatus, nodes, or functional entities described herein.

It is understood that any or all of the apparatus, systems, methods and processes described herein may be embodied in the form of computer executable instructions (e.g., program code) stored on a computer-readable storage medium which instructions, when executed by a processor, such as processors 78 or 91, cause the processor to perform or implement the systems, methods and processes described herein. Specifically, any of the steps, operations, or functions described herein may be implemented in the form of such computer executable instructions, executing on the processor of an apparatus or computing system configured for wireless or wired network communications. Computer readable storage media may include volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

In describing preferred methods, systems, or apparatus of the subject matter of the present disclosure—NR SL Positioning—as illustrated in the Figures, specific terminology is employed for the sake of clarity. The claimed subject matter, however, is not intended to be limited to the specific terminology so selected.

The various techniques described herein may be implemented in connection with hardware, firmware, software or, where appropriate, combinations thereof. Such hardware, firmware, and software may reside in apparatus located at various nodes of a communication network. The apparatus may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein. For example, NG-RAN or PA UE is interpreted as NG-RAN, PA UE, or PA UE and NG-RAN.

This written description may use examples for the disclosed subject matter, including the best mode, and also to enable any person skilled in the art to practice the disclosed subject matter, including making and using any devices or systems and performing any incorporated methods. The disclosed subject matter may include other examples that occur to those skilled in the art (e.g., skipping steps, combining steps, or adding steps between exemplary methods disclosed herein).

Methods, systems, and apparatus, among other things, as described herein may provide for discovering or communicating SL positioning. A method, system, computer readable storage medium, or apparatus may be configured to authorize and provision positioning service; authorize and provision SL target and PA UE discovery; trigger for location services request; discover and select PA UE; establish SL direct communications/PC5; and perform LCS procedures. The LCS procedures may include SL-PRS configuration or measurements. All combinations in this paragraph and the below paragraphs (including the removal or addition of steps) are contemplated in a manner that is consistent with the other portions of the detailed description.

Disclosed herein are the following methods and systems. Methods or system for target UE discovery, selection, and assistance of SL UEs and SL ranging/positioning configuration without Uu involvement. Methods or system for target UE discovery, selection, and assistance of SL UEs aided by the network (gNB, LMF, Uu involvement) to determine SL configuration and appropriate SL-PRS/SRS resource allocation. Methods or system for target UE discovery, selection, and assistance of SL UEs with and without instigating SL Direct Communications (PC5-RRC link) to the base station (e.g., gNB) Methods or system for Uu and SL procedure enhancements to support ranging and positioning for UEs and positioning assist entities equipped with a Distributed Antenna System (DAS).

Methods, systems, and apparatus, among other things, as described herein may provide for receiving sidelink (SL) positioning configuration information, wherein the SL positioning configuration information comprises an indication of whether the UE may use relative positioning or absolute positioning; and based on the SL positioning configuration information, performing a positioning task that comprises sending an indication of a use of relative positioning between the UE and a positioning assist (PA) UE or the UE and a controlling entity (CE). SL positioning configuration information may include SL positioning reference signal (PRS) type, PRS resources (SL, Uu), indication of whether the position is emergency positioning, QoS or KPI profile (e.g., threshold requirements) of the positioning, indication of authorization to perform SL in-coverage discovery or SL out-of-coverage discovery of a positioning assist (PA-UE) UE or a controlling entity (CE), one or more positioning service identifiers, one or more triggers for discovery of a PA-UE or a CE, one or more thresholds for the selection of one or more PA-UE, one or more thresholds for the selection of a CE, or positioning capability, among other things.

Methods, systems, and apparatuses, among other things, as described herein may be configured to receive, from a sidelink (SL) positioning controlling entity, sidelink positioning configuration; based on the received configuration, being triggered to perform a positioning task, and perform the positioning task, the performing of the positioning task comprises at least one of the tasks disclosed herein. A task may be associated with sending indication of a use of relative positioning between the UE and a positioning assist (PA) UE or the UE and a controlling entity (CE), positioning mode (UE-based, UE-assisted), SL positioning algorithm, positioning security parameters, or the following tasks. In addition, or alternative to, the tasks may include: discovery of CE, discovery of PA-UE, selection of CE; selection of PA-UE; reception of the position of a PA-UE, a CE or a reference UE; measurement of SL PRS, Uu PRS; calculation of the UE absolute position; calculation of the UE relative position; or report of SL PRS measurements or Uu PRS measurement to a PA UE or a CE. Other tasks may include positioning capability negotiation between the UE and the PA-UE, between the UE and the CE or between the UE and a reference UE, wherein the capability may include one or more of supported positioning type (e.g., absolute position, relative position), positioning algorithms, SL PRS types, or positioning mode (e.g., UE-based, UE-assisted). The SL positioning configuration information may include indication of whether the positioning is relative or absolute positioning, positioning mode (UE-based, UE-assisted), SL positioning algorithm, positioning security parameters, or the like. The target device may be the device for which an absolute position or a relative position is to be calculated. The device that executes the methods herein may be a positioning assist device or a positioning controlling device.

Methods, systems, and apparatuses, among other things, as described herein may provide for receiving sidelink (SL) positioning configuration information, wherein the SL positioning configuration information comprises: an indication of whether a user equipment (UE) may use relative positioning or absolute positioning, or an indication of a positioning quality of service (QOS) requirement associated with the UE; based on the SL positioning configuration information, performing a positioning task that comprises: sending an indication of use of relative positioning between the UE and a positioning assist UE, sending an indication of use of relative positioning between the UE and a controlling entity, or sending an indication that the UE meets the positioning QoS requirement, and sending a request for SL positioning to a positioning assist UE.

What is claimed is:

1.-20. (canceled)

21. A wireless transmit/receive unit (WTRU) comprising a processor configured to:
receive, from a network, sidelink (SL) positioning configuration information;
receive, from one or more positioning assisting (PA) WTRUs, respective positioning assistance information;
select at least one of the one or more PA WTRUs based on the received SL positioning configuration information and the respective positioning assistance information received from the one or more PA WTRUs;
determine a position of the WTRU based on signals received from the selected at least one of the one or more PA WTRUs;
transmit, to the network, an indication of the determined position;
determine that the WTRU is within a validity area; and
transmit a sounding reference signal (SRS) based on the determination that the WTRU is within the validity area.

22. The WTRU of claim 21, wherein the respective positioning assistance information received from the one or more PA WTRUs comprises one or more of respective capability information, a respective supported positioning QoS, an indication of whether the respective PA WTRU is in coverage, or an indication of the respective PA WTRU's location.

23. The WTRU of claim 22, wherein the SL positioning configuration information comprises criteria for selecting the one or more PA WTRUs, and wherein the processor being configured to select at least one of the one or more PA WTRUs based on the received SL positioning configuration information and the respective positioning assistance information received from the one or more PA WTRUs comprises the processor being configured to determine, for each PA WTRU of the one or more PA WTRUs, whether the criteria is met by the respective capability information and the respective supported positioning QoS.

24. The WTRU of claim 23, wherein the criteria comprises one or more of a positioning service type, a required positioning quality of service (QOS), or one or more positioning methods.

25. The WTRU of claim 24, wherein the positioning service type comprises one or more of a relative position service or an absolute position service.

26. The WTRU of claim 21, wherein the processor is further configured to discover the one or more PA WTRUs.

27. The WTRU of claim 26, wherein the processor being configured to discover the one or more PA WTRUs comprises the processor being configured to receive, from each of the one or more PA WTRUs, a respective discovery message.

28. The WTRU of claim 21, wherein the processor is configured to determine the position of the WTRU based on an SRS received from the selected at least one of the one or more PA WTRUs.

29. The WTRU of claim 21, wherein the WTRU is a target WTRU.

30. The WTRU of claim 21, wherein the validity area is associated with the SL positioning configuration information, and wherein the processor is configured to determine that the WTRU is within the validity area based on the SL positioning configuration information.

31. A method implemented in a wireless transmit/receive unit (WTRU), the method comprising:
receiving, from a network, sidelink (SL) positioning configuration information;
receiving, from one or more positioning assisting (PA) WTRUs, respective positioning assistance information;
selecting at least one of the one or more PA WTRUs based on the received SL positioning configuration information and the respective positioning assistance information received from the one or more PA WTRUS;
determining a position of the WTRU based on signals received from the selected at least one of the one or more PA WTRUS;
transmitting, to the network, an indication of the determined position;
determining that the WTRU is within a validity area; and
transmitting a sounding reference signal (SRS) based on the determination that the WTRU is within the validity area.

32. The method of claim 31, wherein the respective positioning assistance information received from the one or more PA WTRUs comprises one or more of respective capability information, a respective supported positioning QoS, an indication of whether the respective PA WTRU is in coverage, or an indication of the respective PA WTRU's location.

33. The method of claim 32, wherein the SL positioning configuration information comprises criteria for selecting the one or more PA WTRUs, and wherein selecting at least one of the one or more PA WTRUs based on the received SL positioning configuration information and the respective positioning assistance information received from the one or more PA WTRUs comprises determining, for each PA WTRU of the one or more PA WTRUs, whether the criteria is met by the respective capability information and the respective supported positioning QoS.

34. The method of claim 33, wherein the criteria comprises one or more of a positioning service type, a required positioning quality of service (QOS), or one or more positioning methods.

35. The method of claim 34, wherein the positioning service type comprises one or more of a relative position service or an absolute position service.

36. The method of claim 31, further comprising discovering the one or more PA WTRUs.

37. The method of claim 36, wherein discovering the one or more PA WTRUs comprises receiving, from each of the one or more PA WTRUs, a respective discovery message.

38. The method of claim 31, wherein the position of the WTRU is determined based on an SRS received from the selected at least one of the one or more PA WTRUs.

39. The method of claim 31, wherein the WTRU is a target WTRU.

40. The method of claim 31 wherein the validity area is associated with the SL positioning configuration information, and wherein the WTRU is determined to be within the validity area based on the SL positioning configuration information.
